(19) United States
(12) Patent Application Publication
(10) Pub. No.: US 2022/0320586 A1
(43) Pub. Date: Oct. 6, 2022

(54) IN-SITU CONTROL OF SOLID ELECTROLYTE INTERFACE FOR ENHANCED CYCLE PERFORMANCE IN LITHIUM METAL BATTERIES

(71) Applicant: Sion Power Corporation, Tucson, AZ (US)

(72) Inventors: Zhaohui Liao, Tucson, AZ (US); Chariclea Scordilis-Kelley, Tucson, AZ (US); Akmeemana Anoma Mudalige, Tucson, AZ (US); Tracy Earl Kelley, Tucson, AZ (US); Yuriy V. Mikhaylik, Tucson, AZ (US); Enic Azalia, Tucson, AZ (US); Juan Gabriel Venegas, Tucson, AZ (US)

(73) Assignee: Sion Power Corporation, Tucson, AZ (US)

(21) Appl. No.: 17/703,415

(22) Filed: Mar. 24, 2022

Related U.S. Application Data
(60) Provisional application No. 63/166,564, filed on Mar. 26, 2021.

(51) Int. Cl. H01M 10/0569; H01M 10/0525; H01M 4/40

(52) U.S. Cl. CPC H01M 10/0569; H01M 10/0525; H01M 4/405; H01M 2300/0034; H01M 2300/004

(57) ABSTRACT

Some aspects of the invention are related to lithium batteries, and more specifically, to in-situ control of solid electrolyte interface for enhanced cycle performance in lithium metal batteries. In some embodiments, the electrochemical cell comprises a solid electrolyte interphase (SEI) layer that is rich in inorganic materials (e.g., LiF, Li₂O, Li₂CO₃) and has various advantageous properties (e.g., improved anode stability, etc.). Some embodiments are directed to methods of electrical energy storage and use of an electrochemical cell. In some cases, the methods comprise applying anisotropic force and/or formation voltage to a cell and forming an inorganic rich SEI layer in-situ.

### RELATED APPLICATIONS

This application claims priority to U.S. Provisional Application No. 63/166,564, filed Mar. 26, 2021, which is incorporated herein by reference in its entirety.

### FIELD

The present invention relates generally to lithium batteries, and more specifically, to in-situ control of solid electrolyte interface for enhanced cycle performance in lithium metal batteries.

### BACKGROUND

There has been considerable interest in recent years in developing high energy density rechargeable batteries with lithium-containing anodes. In such cells, current electrolytes, particularly those used for low temperature applications, are typically based on solutions of lithium salts and carbonate electrolytes. In particular, lithium metal-based anode is highly reactive towards typical electrolytes and as a result, degrades rapidly in the presence of these electrolytes upon charge and discharge of the cell. As a result, lithium metal-based rechargeable batteries with such electrolytes generally exhibit limited cycle lifetimes. Accordingly, articles and methods for increasing the cycle lifetime and/or other improvements would be beneficial.

### SUMMARY

The present invention relates generally to lithium batteries, and more specifically, to in-situ control of solid electrolyte interface for enhanced performance in lithium metal batteries. The subject matter disclosed herein involves, in some cases, interrelated products, alternative solutions to a particular problem, and/or a plurality of different uses of one or more systems and/or articles.

In some aspects, an electrochemical cell is provided.

In some embodiments, the electrochemical cell comprises an anode comprising lithium metal, lithium alloy or combination thereof as an anode active material; an electrolyte comprising a fluorinated organic solvent; a cathode; and a solid electrolyte interphase layer disposed between the anode and the electrolyte, wherein the solid electrolyte interphase layer comprises an inorganic material comprising LiF and Li₂CO₃, and wherein a first ratio of fluorine atoms to oxygen atoms adjacent the electrolyte is higher than a second ratio of fluorine atoms to oxygen atoms adjacent the anode in the solid electrolyte interphase layer.

In some embodiments, the electrochemical cell comprises an anode comprising lithium metal, lithium alloy or a combination thereof as an anode active material; an electrolyte comprising a fluorinated organic solvent; a cathode; and a solid electrolyte interphase layer disposed between the anode and the electrolyte, wherein the solid electrolyte interphase layer comprises LiF and has: (1) a hardness of greater than or equal to 0.001 GPa and less than or equal to 5 GPa; and/or (2) a porosity of greater than equal to 1% and less than or equal to 90%; and wherein the electrochemical cell exhibits a decrease in discharge capacity of less than or equal to 10% after 100 cycles of charge and discharge with respect to a discharge capacity at the 5th charge-discharge cycle after formation.

In some embodiments, the electrochemical cell comprises an anode comprising lithium metal, lithium alloy or a combination thereof as an anode active material; an electrolyte comprising a fluorinated organic solvent; a cathode; and a solid electrolyte interphase layer disposed between the anode and the electrolyte, wherein the solid electrolyte interphase layer comprises LiF and has: (1) a hardness of greater than or equal to 0.001 GPa and less than or equal to 5 GPa; and/or (2) a porosity of greater than equal to 1% and less than or equal to 90%; and wherein the electrochemical cell exhibits an increase in discharge resistance of less than or equal to 10% after 100 cycles of charge and discharge with respect to a discharge resistance at the 5th charge-discharge cycle after formation.

In some aspects, methods of electrical energy storage and use are provided.

In some embodiments, a method comprises in an electrochemical cell comprising an anode comprising lithium metal, lithium alloy or combination thereof as an anode active material, the anode having a surface; a cathode; and an electrolyte comprising a fluorinated organic solvent disposed between the anode and the cathode, performing the steps of: applying an anisotropic force to the surface of the anode; applying a formation voltage during at least one period of time during charge and/or discharge of the cell, wherein the formation voltage is greater than 4.35 V; and forming a solid electrolyte interphase layer adjacent the surface of the anode, wherein the solid electrolyte interphase layer comprises an inorganic material comprising LiF and Li₂CO₃.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a cross-sectional schematic illustration of an electrochemical cell comprising a solid electrolyte interphase (SEI) layer, in accordance with various embodiments;

FIG. 2 is a cross-sectional schematic illustration of a solid electrolyte interphase layer comprising LiF, according to some embodiments;

FIG. 3A is a cross-sectional schematic illustration of a solid electrolyte interphase (SEI) layer comprising a substantially inhomogeneous distribution of inorganic materials (e.g., LiF and/or Li₂CO₃), in accordance with various embodiments;

FIG. 3B is a cross-sectional schematic illustration of a solid electrolyte interphase (SEI) layer comprising a substantially homogeneous distribution of inorganic materials (e.g., LiF and/or Li₂CO₃), in accordance with various embodiments;

FIG. 4 is a graph illustrating the cell cycle life of electrochemical cells comprising LiF rich SEI layer and cycled with pressure application versus cells cycled without pressure application, in accordance with some embodiments;

FIG. 5 is a graph illustrating the cell cycle life of electrochemical cells comprising LiF rich SEI layer and cycled with pressure application versus cells cycled without pressure application, in accordance with some embodiments;

FIG. 6 is a graph illustrating the cell cycle life of electrochemical cells comprising LiF rich SEI layer and cycled with pressure application versus cells cycled without pressure application, in accordance with some embodiments;

FIG. 7 is a graph illustrating the cell cycle life of electrochemical cells comprising LiF rich SEI layer and cycled with pressure application versus cells cycled without pressure application, in accordance with some embodiments;

FIG. 8A is a graph illustrating the cell cycle life of electrochemical cells comprising LiF rich SEI layer and cycled with pressure application versus cells cycled without pressure application, in accordance with some embodiments;

FIG. 8B is a graph illustrating a 5 minute discharge resistance of electrochemical cells from FIG. 8A, in accordance with some embodiments;

FIG. 9 is a graph illustrating the cell cycle life of electrochemical cells with LiF rich-containing SEI layer versus without a LiF-containing SEI layer, in accordance with some embodiments;

FIG. 10 is a graph illustrating the cell cycle life of electrochemical cells without pressure application and a LiF rich SEI layer versus without pressure application and without a LiF rich SEI layer, in accordance with some embodiments;

FIG. 11 is a graph illustrating the cell cycle life of electrochemical cells with pressure application and a LiF rich SEI layer versus with pressure application and without LiF rich SEI layer, in accordance with some embodiments;

FIG. 12A is a graph illustrating the cell cycle life of electrochemical cells comprising inorganic rich SEI layer formed at different formation voltages, in accordance with some embodiments;

FIG. 12B is a graph illustrating the 5 minute discharge resistance of the electrochemical cells in FIG. 12A, in accordance with some embodiments;

FIG. 13 is a graph illustrating the cell cycle life of electrochemical cells cycled at variable formation voltages in the presence of LiBOB, in accordance with some embodiments;

FIG. 14 is a graph illustrating the cell cycle life of electrochemical cells containing a relatively high fluoroethylene carbonate (FEC) content and cycled at various formation voltages, in accordance with some embodiments;

FIG. 15 is a graph illustrating the cell cycle life of electrochemical cells containing a high fluoroethylene carbonate (FEC) content and LiBOB and cycled at various formation voltages, in accordance with some embodiments;

FIG. 16 is a graph illustrating the cell cycle life of electrochemical cells containing an acetate-based solvent cycled at various formation voltages at room temperature, in accordance with some embodiments;

FIG. 17 is a graph illustrating the cell cycle life of electrochemical cells containing an acetate-based solvent cycled at various formation voltages at 0° C., in accordance with some embodiments;

FIG. 18 is a graph illustrating the cell cycle life of electrochemical cells comprising LiFSI and cycled with pressure application versus without pressure application, in accordance with some embodiments; and

FIG. 19 is a graph illustrating the cell cycle life of electrochemical cells comprising LiFSI and cycled with pressure application versus without pressure application in the presence of a higher amount of fluoroethylene carbonate (FEC), in accordance with some embodiments;

FIG. 20A is a SEM image of SEI layer formed between an anode and a separator with a scale bar of 50 um, in accordance with some embodiments;

FIG. 20B is an EDS mapping of the SEI layer from FIG. 20A, in accordance with some embodiments;

FIG. 20C is a high magnification SEM image of the SEI layer adjacent the separator from FIG. 20A with a scale bar of 500 nm, in accordance with some embodiments;

FIG. 21 is an SEM/EDS line scan image of SEI layer with a scale bar of 5 um, in accordance with some embodiments;

FIG. 22A is an X-ray photoelectron spectroscopy (XPS) graph of fluorine content (F 1 s) in the SEI layer, in accordance with some embodiments;

FIG. 22B is an XPS graph of lithium content (Li 1 s) in the SEI layer, in accordance with some embodiments;

FIG. 22C is an XPS graph of carbon content (C 1 s) in the SEI layer, in accordance with some embodiments;

FIG. 23 is an X-ray diffraction (XRD) spectrum characterizing crystallinity of the SEI layer, in accordance with some embodiments;

FIG. 24 illustrates cycle performance of electrochemical cells cycled with pressure application versus cells cycled without pressure application, in accordance with some embodiments;

FIG. 25 is a SEM/EDS line scan of an electrochemical cell without a fluorinated solvent and cycled without pressure application, in accordance with some embodiments;

FIG. 26 is a SEM/EDS line scan of an electrochemical cell without a fluorinated solvent and cycled with pressure application, in accordance with some embodiments;

FIG. 27 is a SEM/EDS line scan of an electrochemical cell comprising a fluorinated solvent and cycled without pressure application, in accordance with some embodiments;

FIG. 28 is a SEM/EDS line scan of an electrochemical cell comprising a fluorinated solvent and cycled with pressure application, in accordance with some embodiments;

FIG. 29 is a graph illustrating percentage (%) of residual Li for cells with or without a fluorinated solvent and cycled with pressure application, in accordance with some embodiments;

and

FIG. 30 is a graph illustrating discharge capacity as a function of cycle for cells with or without a fluorinated solvent and cycled with pressure application, in accordance with some embodiments.

### DETAILED DESCRIPTION

Some aspects of the invention are related to an electrochemical cell for a lithium battery. In some embodiments, the electrochemical cell comprises a stable solid electrolyte interphase (SEI) layer formed at the interface of an anode and an electrolyte, e.g., as a result of interaction (e.g., reaction) between the anode and the electrolyte. The solid electrolyte interphase layer may advantageously contain a substantial amount of certain inorganics materials, e.g., such as LiF and/or Li₂CO₃, that increases the performance of an electrochemical cell. For example, the solid electrolyte interphase layer may assist with increasing stability of the anode (or reducing anode degradation) during cycling, increasing the compatibility between typical electrolytes and lithium metal anode, and/or increasing the life cycle of the cell.

Some aspects of the invention are related to methods of forming and using an electrochemical cell comprising a stable SEI layer that is rich in certain inorganics materials. For instance, an application of an anisotropic force and/or high formation voltage to the electrochemical cell during charge and discharge may lead to the in-situ formation of a controlled SEI layer that is rich in inorganic materials and increases the overall performance the cell. For instance, the cell may exhibit improved performances, e.g., slower growth in discharge resistance, controlled SEI growth, suppressed cell polarization during charge and discharge, longer life cycles, and/or improved low temperature performances.

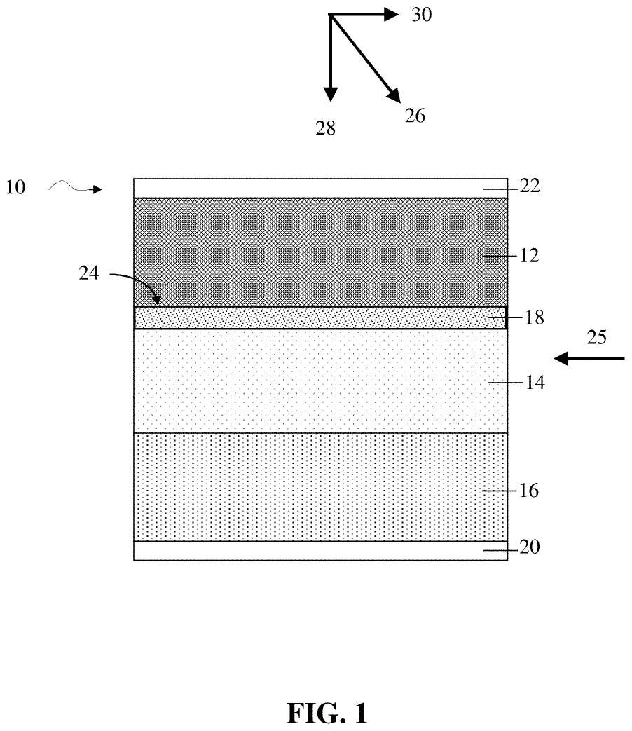

In some embodiments, an electrochemical cell is provided herein. In some such embodiments, the electrochemical cell comprises a first electrode (e.g., an anode), an electrolyte comprising a fluorinated organic solvent, a second electrode (e.g., a cathode), and a solid electrolyte interphase layer disposed between the first electrode (e.g., an anode) and the electrolyte. For example, FIG. 1 illustrates such an embodiment. As shown, an electrochemical cell 10 comprises an anode 12, an electrolyte 14, a cathode 16, and a solid electrolyte interphase layer 18 disposed between the anode 12 and the electrolyte 14. In some embodiments, the electrochemical cell comprises a porous separator material that may contain a non-solid electrolyte. For example, the electrolyte 14 may be imbibed in a porous separator. As used herein, a non-solid electrolyte may refer to materials that are unable to withstand a static shear stress, and when a shear stress is applied, the non-solid experiences a continuing and permanent distortion. Examples of non-solids include, for example, liquids, deformable gels, and the like.

In some embodiments in which a separator is present, the separator may be disposed between the first electrode (e.g., an anode) and the second electrode (e.g., a cathode) and comprises pores in which the electrolyte can reside. In some such embodiments, a solid electrolyte interphase layer is disposed between the first electrode (e.g., an anode) and a separator that comprises pores filled with the electrolyte. In some embodiments, the anode comprises lithium metal, lithium alloy, or combination thereof as an anode active material. An anode active material can refer to any electrochemically active species associated with the anode.

In some embodiments, the solid electrolyte interphase layer comprises one or more inorganic materials that can advantageously increase stability of the anode, and thereby increasing cycle life of the electrochemical cell. Non-limiting examples of such inorganic materials may include, but are not limited to, LiF, Li₂CO₃, Li₂O, etc. In some such embodiments, the formation of one or more of the inorganic materials in the solid electrolyte interphase layer may result from the degradation of electrolytes and/or interaction of electrolyte with the anode active material, as described in more detail below.

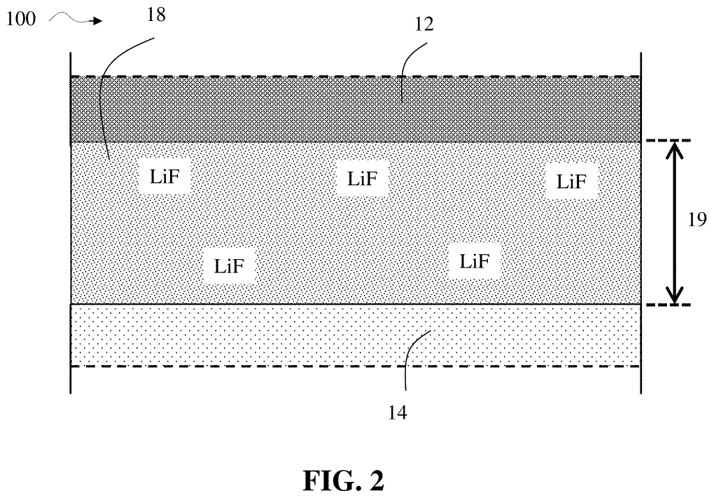

In some embodiments, a solid electrolyte interphase layer comprises LiF. FIG. 2 is a schematic cross-sectional illustration of a portion 100 of an electrochemical cell (e.g., electrochemical cell 10 in FIG. 1) comprising a solid electrolyte interphase layer comprising LiF, according to some embodiments. As shown, a solid electrolyte interphase layer 18 comprising LiF having a thickness 19 is disposed between a portion of the anode 12 and a portion of the electrolyte 14. In some embodiments, the solid electrolyte interphase layer is rich LiF, e.g., where LiF is present in a relatively high amount in the solid electrolyte interphase layer and/or present in a relatively high amount compared to other inorganic materials in the solid electrolyte interphase layer. It should be noted that although FIG. 2 shows only LiF, other inorganic materials (e.g., Li₂O) may also be present in the solid electrolyte interphase layer, as described in more detail below.

In some embodiments, the electrochemical cell may be a lithium-based electrochemical cell, such as a lithium-sulfur electrochemical cell, a lithium-ion electrochemical cell, a lithium metal lithium-ion electrochemical cell, an intercalated lithium metal oxide electrochemical cell, or an intercalated lithium metal phosphate electrochemical cell.

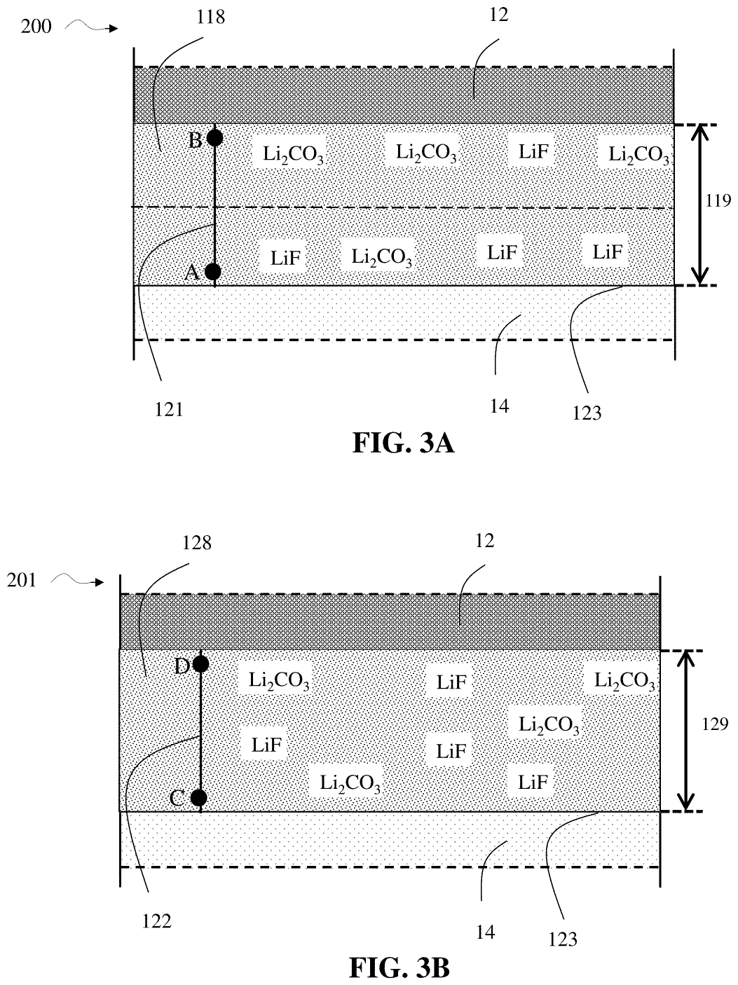

In some embodiments, a solid electrolyte interphase layer comprises an inorganic material comprising LiF and Li₂CO₃. FIG. 3A is a schematic cross-sectional illustration of a portion 200 of an electrochemical cell (e.g., electrochemical cell 10 in FIG. 1) comprising a solid electrolyte interphase layer including LiF and Li₂CO₃, according to some embodiments. As shown in FIG. 3A, a solid electrolyte interphase layer 118 comprising intermixed LiF and Li₂CO₃ is disposed between a portion of the anode 12 and a portion of the electrolyte 14. In some embodiments, the solid electrolyte interphase layer may be rich in both LiF and Li₂CO₃, e.g., where each of LiF and Li₂CO₃ is present in a relatively high amount in the solid electrolyte interphase layer and/or present in a relatively high amount compared to the presence of certain other inorganic materials in the solid electrolyte interphase layer. The inorganic materials (e.g., LiF, Li₂CO₃) may be present in any of a variety of amounts described herein. In certain cases, the solid electrolyte interphase layer may further comprise one or more inorganic materials, including, but not limited to, lithium alkoxides, lithium oxide, lithium salts, and other decomposition products of electrolyte.

In some embodiments, the solid electrolyte interphase layer comprises a substantially non-homogeneous distribution of various inorganic materials and/or atomic species. For example, in one set of embodiments, a first ratio of fluorine atoms to oxygen atoms adjacent the electrolyte (or on a side opposite an electrode, such as an anode) is higher than a second ratio of fluorine atoms to oxygen atoms adjacent the electrode (e.g., anode) in the solid electrolyte interphase layer. Again, referring to FIG. 3A, the Li₂CO₃ and LiF species in solid electrolyte interphase layer 118 are not substantially homogeneously distributed within the solid electrolyte interphase layer 118 across a thickness 119 of the solid electrolyte interphase layer 118. Rather, in FIG. 3A, a substantially higher amount of LiF species is localized at or near a surface of the solid electrolyte interphase layer adjacent the electrolyte 14. Accordingly, a first ratio of fluorine atoms to oxygen atoms adjacent the electrolyte 14 is higher than a second ratio of fluorine atoms to oxygen atoms adjacent the anode 12 in the solid electrolyte interphase layer 118 across the thickness 119 of the solid electrolyte interphase layer 12. It should be understood that in addition to LiF and Li₂CO₃, in some cases, additional inorganics materials (e.g., Li₂O, lithium alkoxides, etc.) may also be present and contribute to the ratio of fluorine atoms to oxygen atoms in the solid electrolyte interphase layer. For example, in some embodiments, the solid electrolyte interphase layer may comprise a relatively small amount of fluorine-containing inorganic material(s) that is associated with the presence of fluorine-containing salts and/or additives (e.g., LiₓPF_{y}, LiₓPO_{y}F_{z}, etc.).

In some embodiment in which the fluorine atoms and oxygen atoms are not substantially homogeneously distributed across the thickness of the solid electrolyte interphase layer, a ratio of fluorine atoms to oxygen atoms at any given point within a cross-section of thickness of the solid electrolyte interphase layer varies at least 25% (e.g., at least 30%, at least 50%, at least 70%, or at least 90%, etc.) compared to an average ratio of fluorine atoms to oxygen atoms throughout the solid electrolyte interphase layer. For example, referring again to FIG. 3A, a first ratio of fluorine atoms to oxygen atoms at an arbitrary point A (e.g., a point that is adjacent the electrolyte), or a second ratio at an arbitrary point B (e.g., a point that is adjacent the anode), of cross-section 121 of the solid electrolyte interphase layer 118 varies by at least 25% compared to an average ratio of fluorine to oxygen atoms throughout the solid electrolyte interphase layer 118. As an exemplary calculation, if a solid electrolyte interphase layer has an average ratio of fluorine atoms to oxygen atoms of 1, and any point within a cross-section across the thickness of the solid electrolyte layer (e.g., point A or B in FIG. 3B) has a ratio of less than or equal to 0.75 or greater than or equal to 1.25, then that solid electrolyte interphase layer would be considered to have a substantially inhomogeneous distribution of fluorine atom and oxygen atoms across a thickness of the solid electrolyte interphase layer based on the average ratio of fluorine atom and oxygen atoms in the solid electrolyte interphase layer.

In some embodiments, a first ratio of fluorine atoms to oxygen atoms on one side of the solid electrolyte interphase layer (e.g., adjacent the electrolyte) is higher than a second ratio of fluorine atoms to oxygen atoms on another side of the solid electrolyte interphase layer (e.g., adjacent the anode) measured across a thickness of the solid electrolyte layer. In some such embodiments, a first ratio of fluorine atoms to oxygen atoms at a point on one side of the solid electrolyte interphase layer (e.g., adjacent the electrolyte, such as point A in FIG. 3A) within a cross-section of thickness of the solid electrolyte interphase layer is substantially higher than a second ratio of fluorine atoms to oxygen atoms on another side of the solid electrolyte interphase layer (e.g., adjacent the anode, such as point B in FIG. 3A). For example, the first ratio (e.g., point A in FIG. 3A) may be at least 25%, at least 50%, at least 60%, at least 70%, at least 80%, at least 90%, at least 100%, at least 200%, or at least 300% higher than the second ratio (e.g., point B in FIG. 3A). In some embodiments, the first ratio (e.g., point A in FIG. 3A) is no more than 400%, no more than 300%, no more than 200%, no more than 100%, no more than 90%, no more than 80%, no more than 70%, no more than 60%, or no more than 50% higher than the second ratio (e.g., point B in FIG. 3A). Combinations of the above-referenced ranges are possible (e.g., at least 25% and no more than 400%). Other ranges are also possible.

In some embodiments, a first ratio of fluorine atoms to oxygen atoms on one side of the solid electrolyte interphase layer (e.g., at a point adjacent the electrolyte, such as point A in FIG. 3A) is higher than an average ratio of fluorine atoms to oxygen atoms in the solid electrolyte interphase layer, as measured across a thickness of the solid electrolyte interphase layer. For example, the first ratio (e.g., point A in FIG. 3A) may be at least 25%, at least 50%, at least 60%, at least 70%, at least 80%, at least 90%, at least 100%, at least 200%, or at least 300% higher than the average ratio. In some embodiments, the first ratio (e.g., point A in FIG. 3A) is no more than 400%, no more than 300%, no more than 200%, no more than 100%, no more than 90%, no more than 80%, no more than 70%, or no more than 60% higher than the average ratio. Combinations of the above-referenced ranges are possible (e.g., at least 25% and no more than 400%). Other ranges are also possible.

Additionally or alternatively, in some embodiments, the second ratio of fluorine atoms to oxygen atoms at a point adjacent the anode (e.g., point B in FIG. 3A) within a cross-section of thickness of the solid electrolyte interphase layer is substantially smaller than an average ratio of fluorine atoms to oxygen atoms in the solid electrolyte interphase layer. For example, the second ratio of fluorine atoms to oxygen atoms at a point adjacent the anode is at least 25%, at least 50%, at least 60%, at least 70%, at least 80%, or at least 90% smaller than an average ratio of fluorine atoms to oxygen atoms within the solid electrolyte interphase layer. In some embodiments, a second ratio of fluorine atoms to oxygen atoms at a point adjacent the anode (e.g., point B in FIG. 3A) within a cross-section of thickness of the solid electrolyte interphase layer is no more than 100%, no more than 90%, no more than 80%, no more than 70%, or no more than 60% smaller than an average ratio of fluorine atoms to oxygen atoms within the solid electrolyte interphase layer. Combinations of the above-referenced ranges are possible (e.g., at least 25% and no more than 100%). Other ranges are also possible.

The amount of fluorine atoms and oxygen atoms within the solid electrolyte interphase layer and within an arbitrary cross-section of the solid electrolyte interphase layer may be determined using a combination of scanning electron microscopy (SEM) and energy-dispersive X-ray Spectroscopy (EDX or EDS) techniques. For example, the following procedure can be performed. To determine the amount of fluorine atoms and oxygen atoms, an anode/SEI layer/separator stack or anode/SEI and SEI/separator can be retrieved from cells at various stage of cycle life. The retrieved anode/SEI layer/separator stack can be ion-milled to generate a smooth cross-section, which can be subsequently analyzed by SEM/EDS.

In some embodiments, a first ratio of fluorine atoms to oxygen atoms is associated with a location (e.g., point A in FIG. 3A) that is relatively close to a surface of the electrolyte. For example, in some embodiments, a first ratio of fluorine atoms to oxygen atoms in the solid electrolyte interphase layer is present at a location that is less than or equal to 50%, less than or equal to 40%, less than or equal to 30%, less than or equal to 20%, less than or equal to 10%, less than or equal to 5%, or less than or equal to 1% of a thickness of the solid electrolyte interphase layer (e.g., thickness 119 of SEI layer 118 in FIG. 3A) away from a surface of the electrolyte (e.g., surface 123 in FIG. 3A). In some embodiments, a first ratio of fluorine atoms to oxygen atoms in the solid electrolyte interphase layer is associated with a location that is greater than or equal to 0%, greater than or equal to 1%, greater than or equal to 5%, greater than or equal to 10%, greater than or equal to 20%, greater than or equal to 30%, greater than or equal to 40% of the thickness of the solid electrolyte interphase layer away from the surface of the electrolyte. Combination of the above-referenced ranges are possible (e.g., greater than or equal to 0% and less than or equal to 50%). Other ranges are also possible. In one set of embodiments, a first ratio of fluorine atoms to oxygen atoms is located directly adjacent (e.g., in contact with) the surface of the electrolyte.

In some embodiments, a second ratio of fluorine atoms to oxygen atoms in the solid electrolyte interphase layer is associated with a location (e.g., point B in FIG. 3A) that is relatively further away from a surface of the electrolyte (or relatively close to a surface of the anode). For example, in some embodiments, a second ratio of fluorine atoms to oxygen atoms in the solid electrolyte interphase layer is present at a location that is less than or equal to 100%, less than or equal to 90%, less than or equal to 80%, less than or equal to 70%, or less than or equal to 60% of a thickness of the solid electrolyte interphase layer (e.g., thickness 119 of SEI layer 118 in FIG. 3A) away from a surface of the electrolyte (e.g., surface 123 in FIG. 3A). In some embodiments, a second ratio of fluorine atoms to oxygen atoms in the solid electrolyte interphase layer is associated with a location that is greater than 50%, greater than or equal to 60%, greater than or equal to 70%, greater than or equal to 80%, or greater than or equal to 90% of a thickness of the solid electrolyte interphase layer away from the surface of the electrolyte. Combination of the above-referenced ranges are possible (e.g., greater than 50% and less than or equal to 100%). Other ranges are also possible.

As an exemplary calculation, if a SEI layer has a thickness of 500 nm, and if a first ratio of fluorine atoms to oxygen atoms is associated with a location (e.g., point A in FIG. 3A) in the SEI layer that is less than or equal to 10% of a thickness away from the surface of the electrolyte, and a second ratio of fluorine atoms to oxygen atoms is associated with a location (e.g., point B in FIG. 3B) in the SEI layer that is greater than 60% of a thickness away from the surface of the electrolyte, then the first ratio of fluorine atoms to oxygen atoms would have been associated with a location that is less than or equal to 50 nm away from the surface of the electrolyte, and the second ratio of fluorine atoms to oxygen atoms would have been associated with a location that is greater than or equal to 300 nm away from the surface of the electrolyte. Furthermore, if the SEI layer has an average ratio of fluorine atoms to oxygen atoms of 1, and if the first ratio of fluorine atoms to oxygen atoms is at least 50 wt % higher than the average ratio, and if the second ratio of fluorine atoms to oxygen atoms is at least 50 wt % smaller than the average ratio, then the first ratio of fluorine atoms to oxygen atoms would have been at least 1.5, and the second ratio of fluorine atoms to oxygen atoms would have been no more than 0.5.

In some embodiments in which the fluorine atoms and oxygen atoms are not substantially homogeneously distributed across the thickness of the solid electrolyte interphase layer, a ratio of fluorine atoms to oxygen atoms at any given point within a cross-section of thickness of the solid electrolyte interphase layer varies more than 50% (e.g., more than 60%, more than 70%, more than 80%, or more than 90%, etc.) at any given point within a cross-section of thickness of the solid electrolyte interphase layer from a maximum ratio of fluorine atoms to oxygen atoms within the solid electrolyte interphase layer. For example, referring again to FIG. 3A, a ratio of fluorine atoms to oxygen atoms at an arbitrary point A (e.g., a point that is adjacent the electrolyte), or a ratio at an arbitrary point B (e.g., a point that is adjacent the anode), of cross-section 121 of the solid electrolyte interphase layer 118 varies by more than 50% compared to a maximum ratio of fluorine to oxygen atoms in the solid electrolyte interphase layer 118. As an exemplary calculation, if a solid electrolyte interphase layer has a maximum ratio of fluorine atoms to oxygen atoms of 1, and any points (e.g., point A or point B in FIG. 3A) within a cross-sections (e.g., cross-section 121) across the thickness of the solid electrolyte interphase layer has a ratio of less than or equal to 0.5, then that solid electrolyte interphase layer would be considered to have a substantially inhomogeneous distribution of fluorine atom and oxygen atoms across a thickness of the solid electrolyte interphase layer based on the maximum ratio of fluorine atom and oxygen atoms in the solid electrolyte interphase layer.

In some embodiments, a first ratio of fluorine atoms to oxygen atoms at a particular point that is relatively close to a surface of the electrolyte and within a cross-section of thickness of the solid electrolyte interphase layer may vary substantially less from a maximum ratio of fluorine atoms to oxygen atoms compared to a second ratio of fluorine atoms to oxygen atoms at a point that is relatively further away from the surface of the electrolyte. For example, referring again to FIG. 3A, a first ratio of fluorine atoms to oxygen atoms at a particular point (e.g., point A) that is relatively close to a surface of the electrolyte 14 and within a cross-section of thickness 119 of the solid electrolyte interphase layer 118 may vary substantially less from a maximum ratio of fluorine atoms to oxygen atoms in the solid electrolyte interphase layer 118 compared to a second ratio of fluorine atoms to oxygen atoms at a particular point (e.g., point B) that is relatively further away from the surface of the electrolyte. For instance, in some embodiments, a first ratio of fluorine atoms to oxygen atoms at a particular point (e.g., point A) that is relatively close to a surface of the electrolyte may vary at least 10%, at least 20%, at least 30%, at least 50%, at least 70%, or at least 90% less from a maximum ratio of fluorine atoms to oxygen atoms in the solid electrolyte interphase layer compared to a second ratio of fluorine atoms to oxygen atoms at a particular point (e.g., point B) that is relatively further away from the surface of the electrolyte. In some embodiments, a first ratio of fluorine atoms to oxygen atoms at a particular point (e.g., point A) that is relatively close to a surface of the electrolyte may vary no more than 99%, no more than 90%, no more than 70%, no more than 50%, no more than 30%, or no more than 20% less from a maximum ratio of fluorine atoms to oxygen atoms in the solid electrolyte interphase layer compared to a second ratio of fluorine atoms to oxygen atoms at a particular point (e.g., point B) that is relatively further away from the surface of the electrolyte. Combination of the above-referenced ranges are possible (e.g., at least 10% and no more than 99%). Other ranges are also possible.

In some embodiments, a first ratio of fluorine atoms to oxygen atoms at a particular point (e.g., point A in FIG. 3A) that is relatively close to a surface of the electrolyte and within a cross-section of thickness of the solid electrolyte interphase layer may have a value that is greater than or equal to 50%, greater than or equal to 60%, greater than or equal to 70%, greater than or equal to 80%, greater than or equal to 90%, greater than or equal to 95%, or greater than or equal to 99% of a maximum ratio of fluorine atoms to oxygen atoms in the solid electrolyte interphase layer. In some embodiments, a first ratio of fluorine atoms to oxygen atoms at a particular point (e.g., point A in FIG. 3A) that is relatively close to a surface of the electrolyte and within a cross-section of thickness of the solid electrolyte interphase layer may have a value that is less than or equal to 100%, less than or equal to 99%, less than or equal to 95%, less than or equal to 90%, less than or equal to 80%, less than or equal to 70%, or less than or equal to 60% of a maximum ratio of fluorine atoms to oxygen atoms in the solid electrolyte interphase layer. Combination of the above-referenced values are possible (e.g., greater than or equal to 50% and less than or equal to 100%). Other values are also possible. In one set of embodiments, a first ratio of fluorine atoms to oxygen atoms located adjacent (e.g., directly adjacent) the electrolyte (e.g., point A in FIG. 3A) is a maximum ratio of fluorine atoms to oxygen atoms in the solid electrolyte interphase layer.

In some embodiments, a second ratio of fluorine atoms to oxygen atoms at a particular point (e.g., point B in FIG. 3A) that is relatively further away from a surface of the electrolyte (or relatively close to a surface of the anode) and within a cross-section of thickness of the solid electrolyte interphase layer may have a value of greater than or equal to 1%, greater than or equal to 5%, greater than or equal to 10%, greater than or equal to 20%, greater than or equal to 30%, greater than or equal to 40%, or greater than or equal to 45% of a maximum ratio of fluorine atoms to oxygen atoms in the solid electrolyte interphase layer. In some embodiments, a second ratio of fluorine atoms to oxygen atoms at a particular point (e.g., point B in FIG. 3A) that is relatively further away to a surface of the electrolyte (or relatively close to a surface of the anode) and within a cross-section of thickness of the solid electrolyte interphase layer may have a value of less than 50%, less than or equal to 45%, less than or equal to 40%, less than or equal to 30%, less than or equal to 20%, less than or equal to 10%, or less than or equal to 5% of a maximum ratio of fluorine atoms to oxygen atoms in the solid electrolyte interphase layer. Combination of the above-referenced values are possible (e.g., greater than or equal to 1% and less than 50%). Other values are also possible.

The amount and ratio (e.g., maximum ratio, average ratio, ratio at any arbitrary point) of fluorine atoms and oxygen atoms and/or LiF to Li₂CO₃ (and other oxygen containing inorganic materials, e.g., Li₂O) within a cross-section of the solid electrolyte interphase layer may be determined using a combination of scanning electron microscopy (SEM) and energy-dispersive X-ray Spectroscopy (EDX or EDS) techniques. The distance between the location comprising a particular ratio (e.g., first ratio, second ratio, etc.) of fluorine atoms to oxygen atoms and/or of LiF to Li₂CO₃ (and other oxygen containing inorganic materials, e.g., Li₂O) to a surface of the electrolyte and/or a surface of the anode can be determined, in some instance, by performing SEM/EDS on an ion-milled SEI cross-section retrieved from the electrochemical cell.

Although FIG. 3A shows an embodiment in which the fluorine atoms and oxygen atoms are not substantially homogeneously distributed across the thickness of the solid electrolyte interphase layer, embodiments in which the fluorine atoms and oxygen atoms are substantially homogeneously distributed across the thickness of the solid electrolyte interphase layer are also possible. FIG. 3B is a cross-sectional schematic of an embodiment in which the fluorine atoms and oxygen atoms are substantially homogeneously distributed across the thickness of the solid electrolyte interphase layer. In FIG. 3B, the solid electrolyte interphase layer 128 comprises Li₂CO₃ and LiF species that are substantially homogeneously distributed within the solid electrolyte interphase layer 128 across a thickness 129 of the solid electrolyte interphase layer 128. Accordingly, a ratio of fluorine atoms to oxygen atoms adjacent the electrolyte 14 does not vary substantially from a second ratio of fluorine atoms to oxygen atoms adjacent the anode 12 in the solid electrolyte interphase layer 128 across the thickness 129 of the solid electrolyte interphase layer 128. It should be understood that in addition to LiF and Li₂CO₃, in some cases, additional inorganics materials (e.g., Li₂O, etc.) may also be present and contribute to an overall ratio of fluorine atoms to oxygen atoms in the solid electrolyte interphase layer.

In some embodiment in which the fluorine atoms and oxygen atoms are substantially homogeneously distributed across the thickness of the solid electrolyte interphase layer, a ratio of fluorine atoms to oxygen atoms at any given point within a cross-section of thickness of the solid electrolyte interphase layer varies less than or equal to 25% (e.g., less than or equal to 20%, less than or equal to 15%, less than or equal to 10%, less than or equal to 5%, less than or equal to 2%, etc.) at any given point within a cross-section of thickness of the solid electrolyte interphase layer from an average ratio of fluorine atoms to oxygen atoms measured across a thickness of the solid electrolyte interphase layer. For example, referring again to FIG. 3B, a ratio of fluorine atoms to oxygen atoms at an arbitrary point C, or a ratio at an arbitrary point D, of cross-section 122 of the solid electrolyte interphase layer 128 varies by less than or equal to 25% compared to an average ratio of fluorine to oxygen atoms in the solid electrolyte layer 128. As an exemplary calculation, if a solid electrolyte interphase layer has an average ratio of fluorine atoms to oxygen atoms of 1, and any point within a cross-section across the thickness of the solid electrolyte interphase layer (e.g., point C or D in FIG. 3B) has a ratio of greater than or equal to 0.75 or less than or equal to 1.25, then that solid electrolyte interphase layer would be considered to have a substantially homogeneous distribution of fluorine atom and oxygen atoms across a thickness of the solid electrolyte interphase layer based on the average ratio of fluorine atom and oxygen atoms in the solid electrolyte interphase layer.

In some embodiments in which the fluorine atoms and oxygen atoms are substantially homogeneously distributed across the thickness of the solid electrolyte interphase layer, a ratio of fluorine atoms to oxygen atoms at any given point within a cross-section of thickness of the solid electrolyte interphase layer varies less than or equal to 50% (e.g., less than or equal to 40%, less than or equal to 30%, less than or equal to 20%, less than or equal to 10%, less than or equal to 5%, etc.) at any given point within a cross-section of thickness of the solid electrolyte interphase layer from a maximum ratio of fluorine atoms to oxygen atoms within the solid electrolyte interphase layer. For example, referring again to FIG. 3B, a ratio of fluorine atoms to oxygen atoms at an arbitrary point C, or a ratio at an arbitrary point D, of cross-section 122 of the solid electrolyte interphase layer 128 varies by less than or equal to 50% compared to a maximum ratio of fluorine to oxygen atoms in the solid electrolyte interphase layer 128. As an exemplary calculation, if a solid electrolyte interphase layer has a maximum ratio of fluorine atoms to oxygen atoms of 1, and all points (e.g., point D in FIG. 3B) within at least several cross-sections (e.g., cross-section 122) across the thickness of the solid electrolyte interphase layer has a ratio of greater than or equal to 0.5, then that solid electrolyte interphase layer would be considered to have a substantially homogeneous distribution of fluorine atom and oxygen atoms across a thickness of the solid electrolyte interphase layer based on a maximum ratio of fluorine atom and oxygen atoms in the solid electrolyte interphase layer.

In some embodiments, methods of electrical energy storage and use of an electrochemical cell are disclosed herein. In some embodiments, the methods comprise applying an anisotropic force to a cell, applying a formation voltage to the cell, and forming a SEI layer described herein within the cell, as described in more detail below.

In some embodiments, the method of electrical energy storage and use of an electrochemical cell comprises applying an anisotropic force to a surface (e.g., an active surface) of the anode. In some such embodiments, the electrochemical cell comprises an anode comprising lithium metal, lithium alloy or combination thereof as an anode active material, a cathode, and an electrolyte comprising a fluorinated organic solvent disposed between the anode and the cathode. In some embodiments, the anode has a surface, e.g., such as an active surface of an electrode at which electrochemical reactions may take place, that is adjacent the electrolyte. For instance, as shown in FIG. 1, an electrochemical cell 10 comprises an anode 12 having a surface 24, a cathode 16, and an electrolyte 14 comprising a fluorinated organic solvent disposed between the anode 12 and the cathode 16. In some such embodiments, the application of an anisotropic force to a surface (e.g., an active surface) of the anode can enhance the performance (e.g., discharge resistance, cycle life, and the like) of the electrochemical cell, as described elsewhere herein.

In some embodiments, applying an anisotropic force to a surface (e.g., an active surface) of the anode comprises applying the anisotropic force during at least one period of time during charge and discharge cycles. In some embodiments, the force may be applied continuously, over one period of time, or over multiple periods of time that may vary in duration and/or frequency. The anisotropic force may be applied, in some cases, at one or more pre-determined locations, optionally distributed over the surface of the anode. In some embodiments, the anisotropic force is applied uniformly over the surface (e.g., active surface) of the anode.

For instance, the at least one period of time may include initial formation cycles (e.g., charge and discharge cycles during which a stable solid electrolyte interphase layer is formed in the cell) and/or subsequent charge and discharge cycles. In one set of embodiments, the application of anisotropic force to a surface of the anode persists through the entire duration of cycling (e.g., all formation cycles and subsequent charge and discharge cycles).

In some embodiments, the force comprises an anisotropic force with a component normal to the surface (e.g., the active surface) of the anode. In the case of a planar surface, the force may comprise an anisotropic force with a component normal to the surface at the point at which the force is applied. For example, referring to FIG. 1, a force may be applied in the direction of arrow 26. Arrow 28 illustrates the component of the force that is normal to surface 24 of anode 12. As shown, surface 24 of anode 12 is a surface that is opposite anode current collector 22 and is configured to face cathode 16. In the case of a curved surface, for example, a concave surface or a convex surface, the force may comprise an anisotropic force with a component normal to a plane that is tangent to the curved surface at the point at which the force is applied.

In some cases, one or more forces applied to the cell have a component that is not normal to a surface (e.g., an active surface) of an anode. For example, in FIG. 1, force 26 is not normal to anode surface 24, and force 26 includes component 30, which is substantially parallel to anode surface 24. In addition, a force 25, which is substantially parallel to anode surface 24, could be applied to the cell in some cases. In one set of embodiments, the sum of the components of all applied anisotropic forces in a direction normal to the anode surface is larger than any sum of components in a direction that is non-normal to the anode surface. In some embodiments, the sum of the components of all applied anisotropic forces in a direction normal to the anode surface is at least about 5%, at least about 10%, at least about 20%, at least about 35%, at least about 50%, at least about 75%, at least about 90%, at least about 95%, at least about 99%, or at least about 99.9% larger than any sum of components in a direction that is parallel to the anode surface.

In some embodiments, an application of an anisotropic force during at least one period of time during charge and/or discharge of the cell is associated with the formation of a solid electrolyte interphase layer (e.g., comprising one or more of LiF, Li₂CO₃, Li₂O, etc.) having a particular set of advantageous properties at the anode and electrolyte interface. For example, in one set of embodiments, the application of anisotropic pressure may result in the formation of a stable and controlled solid electrolyte interphase layer (e.g., SEI layer 18 in FIG. 1) having relatively high conformality to the anode surface, e.g., such that the solid electrolyte interphase layer can efficiently protect the anode from deleterious reactions and/or degradations. Furthermore, the application of an anisotropic force during cycling may assist with regulating the growth of resistive SEI buildup during cycling, thereby reducing the rate of increase of discharge resistance, and suppressing cell polarization during cycling. As a result, the cell may exhibit enhanced cycle life.

In some embodiments, an anisotropic force with a component normal to a surface (e.g., active surface) of the anode is applied, during at least one period of time during charge and/or discharge of the electrochemical device, to an extent effective to inhibit an increase in surface area of the anode surface (e.g., active surface) relative to an increase in surface area absent the anisotropic force.

In some embodiments, the component of the anisotropic force that is normal to a surface (e.g., an active surface) of the electrode defines a pressure of at least about 1 kg/cm², at least about 2 kg/cm², at least about 4 kg/cm², at least about 6 kg/cm², at least about 7 kg/cm², at least about 8 kg/cm², at least about 10 kg/cm², at least about 12 kg/cm², at least about 14 kg/cm², at least about 16 kg/cm², at least about 18 kg/cm², at least about 20 kg/cm², at least about 22 kg/cm², at least about 24 kg/cm², at least about 26 kg/cm², at least about 28 kg/cm², at least about 30 kg/cm², at least about 32 kg/cm², at least about 34 kg/cm², at least about 36 kg/cm², at least about 38 kg/cm², at least about 40 kg/cm², at least about 42 kg/cm², at least about 44 kg/cm², at least about 46 kg/cm², or at least about 48 kg/cm². In some embodiments, the component of the anisotropic force normal to the surface may, for example, define a pressure of less than about 50 kg/cm², less than about 48 kg/cm², less than about 46 kg/cm², less than about 44 kg/cm², less than about 42 kg/cm², less than about 40 kg/cm², less than about 38 kg/cm², less than about 36 kg/cm², less than about 34 kg/cm², less than about 32 kg/cm², less than about 30 kg/cm², less than about 28 kg/cm², less than about 26 kg/cm², less than about 24 kg/cm², less than about 22 kg/cm², less than about 20 kg/cm², less than about 18 kg/cm², less about 16 kg/cm², less than about 14 kg/cm², less than about 12 kg/cm², less than about 10 kg/cm², less than about 8 kg/cm², less than or equal to 7 kg/cm², less than about 6 kg/cm², less than about 4 kg/cm², or less than about 2 kg/cm². Combinations of the above-referenced ranges are also possible (e.g., at least about 7 kg/cm² and less than about 50 kg/cm², at least about 8 kg/cm² and less than about 30 kg/cm², at least about 10 kg/cm² and less than about 25 kg/cm²). Other ranges are also possible.

While forces and pressures are generally described in units of Newtons and Newtons per unit area, respectively, forces and pressures can also be expressed in units of kilograms-force and kilograms-force per unit area (i.e., kg_{f}/cm² or kg/cm²), respectively. One or ordinary skill in the art will be familiar with kilogram-force-based units, and will understand that 1 kilogram-force is equivalent to about 9.8 Newtons.

In some embodiments, a method of electrical energy storage and use of an electrochemical cell comprises applying a formation voltage during at least one period of time during charge and/or discharge of the cell. In some such embodiments, the at least one period of time during charge and/or discharge is associated with formation cycles, i.e., the initial charge and/or discharge cycle(s) that is associated with the formation of a stable solid electrolyte interphase layer. For instance, in some embodiments, the formation cycles occur for at least (the first) 1, at least (the first) 2, at least (the first) 3, at least (the first) 4, or at least (the first) 5 cycles of charge and discharge in the cell. In some embodiments, the formation cycles occur for no more than (the first) 6, no more than (the first) 5, no than (the first) 4, no more than (the first) 3, or no more than (the first) 2 cycles of charge and discharge in the cell. Combination of the above-referenced ranges are possible (e.g., greater than 1 and less than or equal to 5 cycles, greater than or equal to 1 and less than or equal to 4, or greater than or equal to 1 and less than or equal to 3). Other ranges are also possible.

In accordance with some embodiments, the formation voltage is the voltage applied during the formation cycles. For example, in one set of embodiments, the formation voltage is applied for greater than or equal to 1, greater than or equal to 2, greater than or equal to 3, greater than or equal to 4, or greater than or equal to 5 cycles of charge and discharge of the cell. In some embodiments, the formation voltage is applied for less than 6, less than or equal to 5, less than or equal to 4, less than or equal to 3, or less than or equal to 2 cycles of charge and discharge in the cell. Combination of the above-referenced ranges are possible (e.g., greater than 1 cycle and less than or equal to 5 cycles, greater than or equal to 1 cycle and less than or equal to 4 cycles, or greater than or equal to 1 cycle and less than or equal to 3 cycles). Other ranges are also possible.

In some embodiments, formation of Li₂CO₃ in the solid electrolyte interphase layer (e.g., as shown in FIG. 3A) is associated with a relatively high formation voltage applied during at least one period of time during charge and/or discharge of the cell. In some such embodiments, a relatively high formation voltage may advantageously initiate the reaction to form Li₂CO₃ in the SEI layer and/or increase the rate of Li₂CO₃ formation, thus leading to the presence of a substantial amount of Li₂CO₃ in the solid electrolyte interphase layer. The presence of a relatively high amount of Li₂CO₃ in the solid electrolyte interphase layer may lead to enhanced performance (e.g., anode stability, cycle life, etc.) of the electrochemical cell.

In some embodiments, a relatively high formation voltage is greater than 4.35, greater than 4.4 V, greater than or equal to 4.45 V, greater than or equal to 4.5 V, greater than or equal to 4.55 V, greater than or equal to 4.6 V, greater than or equal to 4.65 V, greater than or equal to 4.7 V, greater than or equal to 4.75 V, greater than or equal to 4.8 V, greater than or equal to 4.85 V, greater than or equal to 4.9 V, or greater than or equal to 4.95 V. In some embodiments, a relatively high formation voltage is less than or equal to 5 V, less than or equal to 4.95 V, less than or equal to 4.9 V, less than or equal to 4.85 V, less than or equal to 4.8 V, less than or equal to 4.75 V, less than or equal to 4.7 V, less than or equal to 4.65 V, less than or equal to 4.6 V, less than or equal to 4.55 V, less than or equal to 4.5 V, or less than or equal to 4.45 V. Combination of the above-referenced ranges are possible (e.g., greater than 4.4 V and less than or equal to 5V, greater than 4.5 V and less than or equal to 4.9 V, or greater than or equal to 4.55 V and less than or equal to 4.75 V). Other ranges are also possible.

In some embodiments, a relatively high formation voltage may be applied for any of a variety of durations. For example, in one set of embodiments, the formation voltage can be applied for a total of greater than or equal to 1 minute, greater than or equal to 5 minutes, greater than or equal to 10 minutes, greater than or equal to 20 minutes, greater than or equal to 30 minutes, greater than or equal to 60 minutes, greater than or equal to 120 minutes, greater than or equal to 180 minutes, greater than or equal to 360 minutes, greater than or equal to 540 minutes, greater than or equal to 720 minutes, greater than or equal to 900 minutes, greater than or equal to 1080 minutes, or greater than or equal to greater than or equal to 1260 minutes. In some embodiments, the formation voltage can be applied for a total of less than or equal to 1440 minutes, less than or equal to 1260 minutes, less than or equal to 1080 minutes, less than or equal to 900 minutes, less than or equal to 720 minutes, less than or equal to 540 minutes, less than or equal to 360 minutes, less than or equal to 180 minutes, less than or equal to 120 minutes, less than or equal to 60 minutes, less than or equal to 30 minutes, less than or equal to 20 minutes less than or equal to 15 minutes, less than or equal to 10, or less than or equal to 5 minutes. Combination of the above-referenced ranges are possible (e.g., greater than or equal to 1 minute and less than or equal to 1440 minutes, greater than or equal to 5 minutes and less than or equal to 720 minutes, or greater than or equal to 10 minutes and less than or equal to 360 minutes). Other ranges are also possible.

In some embodiments, an application of an anisotropic force and high formation voltage during at least one period of time during charge and/or discharge of the cell is associated with the formation of a solid electrolyte interphase layer comprising LiF and Li₂CO₃ (e.g., as shown in FIG. 3A) having advantageous properties. These properties include, but are not limited to, high conformity to the anode, high stability, high ion conductivity, etc. The application of anisotropic force application during formation and/or subsequent discharge and/or charge cycles may further enhance the performance of an electrochemical cell (e.g., slowed rate of resistive SEI buildup and growth in discharge resistance, improved life cycle, and the like).

In some embodiments, the method of electrical energy storage and use of an electrochemical cell comprises forming a solid electrolyte interphase layer adjacent a surface (e.g., an active surface) of the anode. In some such embodiments, a solid electrolyte interphase layer comprising one or more inorganic materials (e.g., LiF, Li₂CO₃, Li₂O, etc.) is formed in situ during charge and/or discharge of the electrochemical cell. For example, referring again to FIG. 1, the electrochemical cell 100, when subjected to charge and/or discharge, results in an in-situ formation of a solid electrolyte interphase layer 18 adjacent surface 24 of anode 12. In some such embodiments, the formation of a controlled solid electrolyte interphase layer is associated, at least in part, with an application of anisotropic force and/or formation voltage during charge and/or discharge cycles.

In some embodiments, the solid electrolyte interphase layer comprises inorganic materials comprising LiF and/or Li₂CO₃ (e.g., as shown in FIGS. 2-3). Depending on the type of inorganic materials, the route by which these inorganic materials form may differ. For example, in one set of embodiments, LiF is formed in situ as a result of degradation of one or more fluorinated electrolyte solvents during charge and/or discharge (e.g., as shown in FIGS. 2-3).

In one set of embodiments, Li₂CO₃ is formed in-situ via a reaction of CO₂ with the lithium metal on the anode surface (e.g., as shown in FIG. 3). For example, CO₂ may be generated during charge and/or discharge from various components of the cell, e.g., such as from the degradation of electrolyte solvents (e.g., ester-based, carbonate-based solvents) and/or gas generation from cathodes (e.g., impurities within NCM cathodes) during cycling. As noted above and with respect to FIG. 3, the in-situ formation of a solid electrolyte interphase layer comprising a relatively high amount of Li₂CO₃ may be caused by, at least in part, a high formation voltage applied during at least one period of time during charge and/or discharge of the cell (e.g., the formation cycles). The solid electrolyte interphase layer may further comprise one or more of inorganic materials (e.g., lithium alkoxides, lithium oxide, lithium salts, and other decomposition products of electrolyte) as a result of charge and/or discharge of the cell.

Although the present disclosure generally describes in-situ formation of solid electrolyte interphase layer during charge and/or discharge, in some cases, at least a portion of the solid electrolyte interphase layer may be formed ex situ. In some such embodiments, a portion of the solid electrolyte interphase layer comprising Li₂CO₃ is formed by pre-passivation of the anode (e.g., electroactive layer of the anode) with CO₂ prior to assembly of the electrochemical cell. In some such embodiments, after assembling the pre-passivated anode into the electrochemical cell, an additional solid electrolyte interphase layer comprising LiF and/or Li₂CO₃ may be formed in situ in the manner described above.

In some embodiments, the solid electrolyte interphase layer includes inorganic materials in a relatively high amount. In some such embodiments, the solid electrolyte interphase layer comprises inorganic materials in a total amount of greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %. In some embodiments, the solid electrolyte interphase layer comprises inorganic materials in a total amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, or less than or equal to 20 wt %. Combination of the above-referenced ranges are possible (e.g., greater than or equal to 10 wt % and less than or equal to 100 wt %). Other ranges are also possible.

In some embodiments, the solid electrolyte interphase layer includes fluorine-containing inorganic materials (e.g., LiF) in a relatively high amount. In some such embodiments, the solid electrolyte interphase layer comprises fluorine-containing inorganic materials (e.g., LiF) in an amount of greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %. In some embodiments, the solid electrolyte interphase layer, may comprise fluorine-containing inorganic materials (e.g. LiF) in an amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, or less than or equal to 20 wt %. Combination of the above-referenced ranges are possible (e.g., greater than or equal to 10 wt % and less than or equal to 100 wt %). Other ranges are also possible. In some embodiments, the SEI layer may include additional fluorine-containing inorganic materials associated with the presence of fluorine-containing salts and/or fluorine-containing additives (e.g., LiₓPF_{y}, LiₓPO_{y}F_{z}, etc.).

In some embodiments, the solid electrolyte interphase layer includes Li₂CO₃ in a relatively high amount. In some such embodiments, the solid electrolyte interphase layer comprises Li₂CO₃ in an amount of greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, greater than or equal to 95 wt %. In some embodiments, the solid electrolyte interphase layer comprises Li₂CO₃ in an amount of less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, or less than or equal to 20 wt %. Combination of the above-referenced ranges are possible (e.g., greater than or equal to 10 wt % and less than or equal to 100 wt %). Other ranges are also possible.

In some embodiments, the solid electrolyte interphase layer comprises both LiF and Li₂CO₃ in a relatively high amount. In some such embodiments, LiF and Li₂CO₃ may independently be present in any amount described previously, or in combination.

The solid electrolyte interphase layer may comprise LiF and Li₂CO₃ at any of a variety of appropriate weight ratios. In some embodiment, the weight ratio of LiF to Li₂CO₃ may be greater than or equal to 1:100, greater than or equal to 1:50, greater than or equal to 1:10, greater than or equal to 1:5, greater than or equal to 1:2, greater than or equal to 1:1, greater than or equal to 1:2, greater than or equal to 3:1, greater than or equal to 5:1, greater than or equal to 10:1, greater than or equal to 25:1, greater than or equal to 50:1, or greater than or equal to 75:1. In some embodiments, the weight ratio of LiF to Li₂CO₃ may be less than or equal to 100:1, less than or equal to 75:1, less than or equal to 50:1, less than or equal to 25:1, less than or equal to 10:1, less than or equal to 5:1, less than or equal to 3:1, less than or equal to 2:1, less than or equal to 1:1, less than or equal to 1:2, less than or equal to 1:5, less than or equal to 1:10, or less than or equal to 1:50. Combination of the above-referenced ranges are possible (e.g., greater than or equal to 1:100 and less than or equal to 100:1). Other ranges are also possible.

In some embodiments, other inorganic materials, e.g., Li₂O, may be formed in the SEI layer in any of a variety of suitable amount. For example, the formation of Li₂O may be associated with the presence of fluorinated solvent(s) (e.g., fluoroethylene carbonate) and/or passivating agent(s) (e.g., LiBOB). In some such embodiments, Li₂O may be formed in any of a variety of suitable amounts. For example, in some embodiments, the solid electrolyte interphase layer comprises Li₂O in an amount of greater than or equal to 5 wt %, greater than or equal to 10 wt %, greater than or equal to 20 wt %, greater than or equal to 30 wt %, greater than or equal to 40 wt %, or greater than or equal to 50 wt %. In some embodiments, the solid electrolyte interphase layer comprises Li₂O in an amount of less than or equal to 60 wt %, less than or equal to 50 wt %, less than or equal to 40 wt %, less than or equal to 30 wt %, less than or equal to 20 wt %, or less than or equal to 10 wt %. Combination of the above-referenced ranges are possible (e.g., greater than or equal to 10 wt % and less than or equal to 50 wt %, or greater than or equal to 5 wt % and less than or equal to 50 wt %). Other ranges are also possible.

In some embodiments, the solid electrolyte interphase layer may comprise LiF and Li₂O at any of a variety of appropriate weight ratios. In some embodiment, the weight ratio of LiF to Li₂O may be greater than or equal to 1:5, greater than or equal to 1:4, greater than or equal to 1:3, greater than or equal to 1:2, greater than or equal to 1:1, greater than or equal to 1:2, greater than or equal to 3:1, greater than or equal to 5:1, greater than or equal to 10:1, greater than or equal to 25:1, greater than or equal to 50:1, or greater than or equal to 75:1. In some embodiments, the weight ratio of LiF to Li₂O may be less than or equal to 100:1, less than or equal to 75:1, less than or equal to 50:1, less than or equal to 25:1, less than or equal to 10:1, less than or equal to 5:1, less than or equal to 3:1, less than or equal to 2:1, less than or equal to 1:1, less than or equal to 1:2, less than or equal to 1:3, or less than or equal to 1:4. Combination of the above-referenced ranges are possible (e.g., greater than or equal to 1:5 and less than or equal to 100:1, or greater than or equal to 1:5 and less than or equal to 2:1). Other ranges are also possible. In some embodiments, at least a portion of the inorganic materials (e.g., LiF, Li₂O, Li₂CO₃, etc.) in the solid electrolyte interphase layer may be in crystalline form.

In some embodiments, at least a portion of the inorganic materials may be in nanocrystalline form. In some embodiments, the solid electrolyte interphase layer may comprise nanocrystalline inorganic materials having a size (e.g., a diameter, a width, a length, etc.) of greater than or equal to 5 nm, greater than or equal to 7.5 nm, greater than or equal to 10 nm, greater than or equal to 12.5 nm, greater than or equal to 15 nm, greater than or equal to 20 nm, greater than or equal to 25 nm, greater than or equal to 30 nm, or greater than or equal to 35 nm. In some embodiments, the solid electrolyte interphase layer may comprise nanocrystalline inorganic materials having a size (e.g., a diameter, a width, a length, etc.) of less than or equal to 40 nm, less than or equal to 35 nm, less than or equal to 30 nm, less than or equal to 25 nm, less than or equal to 20 nm, less than or equal to 15 nm, less than or equal to 12.5 nm, or less than or equal to 10 nm, or less than or equal to 7.5 nm. Combination of the above-referenced ranges are possible (e.g., greater than or equal to 5 nm and less than or equal to 40 nm, or greater than or equal to 10 nm and less than or equal to 25 nm). Other ranges are also possible.

For example, in one set of embodiments, at least 5%, at least 10%, at least 20%, at least 30%, at least 40%, at least 50%, at least 70%, at least 80%, or at least 90% of the LiF in the solid electrolyte interphase layer is in crystalline form. For example, in some embodiments, no more than 100%, no more than 90%, no more than 80%, no more than 70%, no more than 60%, no more than 50%, no more than 40%, no more than 30%, no more than 20%, or no more than 10% of the LiF in the solid electrolyte interphase layer is in crystalline form. Combination of the above-referenced ranges are possible (e.g., greater than or equal to 5% and less than or equal to 100%). Other ranges are also possible.

In one set of embodiments, at least 5%, at least 10%, at least 20%, at least 30%, at least 40%, at least 50%, at least 70%, at least 80%, or at least 90% of the Li₂O in the solid electrolyte interphase layer is in crystalline form. For example, in some embodiments, no more than 100%, no more than 90%, no more than 80%, no more than 70%, no more than 60%, no more than 50%, no more than 40%, no more than 30%, no more than 20%, or no more than 10% of the Li₂O in the solid electrolyte interphase layer is in crystalline form. Combination of the above-referenced ranges are possible (e.g., greater than or equal to 5% and less than or equal to 100%). Other ranges are also possible.

A solid electrolyte interphase layer may have any of a variety of suitable porosities. In some embodiments, the SEI layer may have a relatively high porosity, such that the SEI layer can facilitate efficient ion transport across the SEI layer. In some such embodiments, the solid electrolyte interphase layer comprising LiF has a porosity of greater than or equal to 1%, greater than or equal to 5%, greater than or equal to 10%, greater than or equal to 15%, greater than or equal to 20%, greater than or equal to 30%, greater than or equal to 40%, greater than or equal to 50%, greater than or equal to 60%, greater than or equal to 70%, or greater than or equal to 80%. In some embodiments, the solid electrolyte interphase layer has a porosity of less than or equal to 90%, less than or equal to 80%, less than or equal to 70%, less than or equal to 60%, less than or equal to 50%, less than or equal to 40%, less than or equal to 30%, less than or equal to 20%, or less than or equal to 10%. Combination of the above-referenced ranges are possible (e.g., greater than or equal to 10% and less than or equal to 90%). Other ranges are also possible.

A solid electrolyte interphase layer may have any of a variety of suitable hardness values. In some embodiments, the solid electrolyte interphase layer has a hardness of greater than or equal to 0.001 GPa, greater than or equal to 0.005 GPa, greater than or equal to 0.01 GPa, greater than or equal to 0.05 GPa, greater than or equal to 0.1 GPa, greater than or equal to 0.5 GPa, greater than or equal to 1 GPa, greater than or equal to 1.5 GPa, greater than or equal to 2 GPa, greater than or equal to 2.5 GPa, greater than or equal to 3 GPa, greater than or equal to 3.5 GPa, greater than or equal to 4 GPa, or greater than or equal to 5 GPa. In some embodiments, the solid electrolyte interphase layer has a hardness of less than or equal to 10 GPa, less than or equal to 5 GPa, less than or equal to 4.5 GPa, less than or equal to 4 GPa, less than or equal to 3.5 GPa, less than or equal to 3 GPa, less than or equal to 2.5 GPa, less than or equal to 2 GPa, less than or equal to 1.5 GPa, less than or equal to 1 GPa, less than or equal to 0.5 GPa, less than or equal to 0.1 GPa, less than or equal to 0.05 GPa, less than or equal to 0.01 GPa, or less than or equal to 0.005 GPa. Combination of the above-referenced ranges are possible (e.g., greater than or equal to 0.001 GPa and less than or equal to 5 GPa). Other ranges are also possible.

Hardness values may be measured with a nano-hardness tester using a Berkovitch tip. A load of between 0.5N and 2.5N may be used to keep the penetration depth within the SEI layer. Hardness values may be measured according to method disclosed in ASTM E2546 and ISO 14577-4. The methods for measuring hardness, include, but are not limited to Rockwell, Vickers, Martens, etc.

For example, a solid electrolyte interphase layer may have any of a variety of suitable Vickers Pyramid Number (HV) values. For example, the solid electrolyte interphase layer may have a Vickers Pyramid Number of greater than or equal to 0.1, greater than or equal to 1, greater than or equal to 5, greater than or equal to 10, greater than or equal to 20, greater than or equal to 30, greater than or equal to 50, or greater than or equal to 70. In some embodiments, the solid electrolyte interphase layer has a Vickers Pyramid Number (HV) of less than or equal to 90, less than or equal to 70, less than or equal to 50, less than or equal to 30, less than or equal to 10, less than or equal to 5, or less than or equal to 1. Combination of the above-referenced ranges are possible (e.g., greater than or equal to 1 and less than or equal to 90). Other ranges are also possible.

For example, a solid electrolyte interphase layer may have any of a variety of suitable Martens hardness number. For example, the solid electrolyte interphase layer may have a Martens hardness number of greater than or equal to 0.0003, greater than or equal to 0.0005, greater than or equal to 0.001, greater than or equal to 0.005, greater than or equal to 0.01, greater than or equal to 0.05, greater than or equal to 0.1, or greater than or equal to 0.3. In some embodiments, the solid electrolyte interphase layer has a Martens hardness number of less than or equal to 0.5, less than or equal to 0.3, less than or equal to 0.1, less than or equal to 0.05, less than or equal to 0.01, less than or equal to 0.005, less than or equal to 0.001, or less than or equal to 0.0005. Combination of the above-referenced ranges are possible (e.g., greater than or equal to 0.0003 and less than or equal to 0.5). Other ranges are also possible.

A solid electrolyte interphase layer may have any of a variety of suitable thicknesses. For example, the solid electrolyte interphase layer may have a thickness (e.g., as shown by thickness 19, 119, and 129 in FIGS. 1-3) of greater than or equal to 10 nm, greater than or equal to 20 nm, greater than or equal to 50 nm, greater than or equal to 100 nm, greater than or equal to 200 nm, greater than or equal to 500 nm, greater than or equal to 1 um, greater than or equal to 2 um, greater than or equal to 5 um, greater than or equal to 10 um, greater than or equal to 20 um, greater than or equal to 30 um, greater than or equal to 35 um, greater than or equal to 40 um, greater than or equal to 50 um, greater than or equal to 75 um, or greater than or equal to 100 um. In some embodiments, the solid electrolyte interphase layer may have a thickness of less than or equal to 200 um, less than or equal to 100 um, less than or equal to 75 um, less than or equal to 50 um, less than or equal to 40 um, less than or equal to 35 um, less than or equal to 30 um, less than or equal to 20 um, less than or equal to 10 um, less than or equal to 5 um, less than or equal to 2 um, less than or equal to 1 um, less than or equal to 500 nm, less than or equal to 200 nm, less than or equal to 100 nm, less than or equal to 50 nm, or less than or equal to 20 nm. Combination of the above-referenced ranges are possible (e.g., greater than or equal to 10 nm and less than or equal to 200 um, greater than or equal to 10 nm and less than or equal to 75 um, or greater than or equal to 10 nm and less than or equal to 50 um). Other ranges are also possible.

A solid electrolyte interphase layer may have any of a variety of suitable bulk densities. In some embodiments, the solid electrolyte interphase layer may have relatively high bulk density. In some embodiments, the solid electrolyte interphase layer may have a bulk density of greater than or equal to 0.5 g/cm³, greater than or equal to 1.0 g/cm³, greater than or equal to 1.5 g/cm³, greater than or equal to 2.0 g/cm³, greater than or equal to 2.5 g/cm³, greater than or equal to 3.0 g/cm³, greater than or equal to 4.0 g/cm³, greater than or equal to 5.0 g/cm³. In some embodiments, the solid electrolyte interphase layer may have a bulk density of less than or equal to 7.5 g/cm³, less than or equal to 5.0 g/cm³, less than or equal to 4.0 g/cm³, less than or equal to 3.0 g/cm³, less than or equal to 2.5 g/cm³, less than or equal to 2.0 g/cm³, less than or equal to 1.5 g/cm³, or less than or equal to 1 g/cm³. Combination of the above-referenced ranges are possible (e.g., greater than or equal to 0.5 g/cm³ and less than or equal to 7.5 g/cm³, or greater than or equal to 1 g/cm³ and less than or equal to 3 g/cm³). Other ranges are also possible.

A solid electrolyte interphase layer may have any of a variety of suitable elastic modulus values. For example, the solid electrolyte interphase layer may have an elastic modulus of greater than or equal to 0.003 GPa, greater than or equal to 0.005 GPa, greater than or equal to 0.01 GPa, greater than or equal to 0.05 GPa, greater than or equal to 0.1 GPa, greater than or equal to 0.5 GPa, greater than or equal to 1 GPa, greater than or equal to 1.5 GPa, greater than or equal to 2 GPa, greater than or equal to 2.5 GPa, greater than or equal to 3 GPa, greater than or equal to 3.5 GPa, or greater than or equal to 4 GPa. In some embodiments, the solid electrolyte interphase layer has a hardness of less than or equal to 5 GPa, less than or equal to 4.5 GPa, less than or equal to 4 GPa, less than or equal to 3.5 GPa, less than or equal to 3 GPa, less than or equal to 2.5 GPa, less than or equal to 2 GPa, less than or equal to 1.5 GPa, less than or equal to 1 GPa, less than or equal to 0.5 GPa, less than or equal to 0.1 GPa, less than or equal to 0.05 GPa, less than or equal to 0.01 GPa, or less than or equal to 0.005 GPa. Combination of the above-referenced ranges are possible (e.g., greater than or equal to 0.003 GPa and less than or equal to 5 GPa). Other ranges are also possible.

In some embodiments, the solid electrolyte interphase layer (e.g., adjacent the electrolyte and/or a separator imbibed with the electrolyte) comprises particles (e.g., crystalline particles) having any of a variety of appropriate sizes. In some embodiments, the solid electrolyte interphase layer adjacent the electrolyte comprises particles having sizes of greater than or equal to 10 nm, greater than or equal to 20 nm, greater than or equal to 40 nm, greater than or equal to 60 nm, greater than or equal to 80 nm, greater than or equal to 100 nm, greater than or equal to 125 nm, greater than or equal to 150 nm, greater than or equal to 175 nm, or greater than or equal to 200 nm. In some embodiments, the solid electrolyte interphase layer adjacent the electrolyte comprises particles having sizes of less than or equal to 250 nm, less than or equal to 200 nm, less than or equal to 175 nm, less than or equal to 150 nm, less than or equal to 125 nm, less than or equal to 100 nm, less than or equal to 80 nm, less than or equal to 60 nm, less than or equal to 40 nm, or less than or equal to 20 nm. Combination of the above-referenced ranges are possible (e.g., greater than or equal to 10 nm and less than or equal to 200 nm). Other ranges are also possible.

In some embodiments, an electrochemical cell comprising a solid electrolyte interphase layer described herein exhibits a slower rate of decrease in discharge capacity compared to an otherwise equivalent electrochemical cell without such solid electrolyte interphase layer. The discharge capacity C can be calculated by multiplying the current I_{dch} by the time t it takes to reach a discharge voltage cutoff after cycling, according to Eq. (1):

C=I_{dch}·t (1)

As the cycling continues, a discharge capacity can be determined for each subsequent cycle.

In some such embodiments, the electrochemical cell exhibits a decrease in discharge capacity of greater than or equal to 0%, greater than or equal to 0.01%, greater than or equal to 0.05%, greater than or equal to 0.1%, greater than or equal to 0.5%, greater than or equal to 1%, greater than or equal to 5%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, or greater than or equal to 15% after 100 cycles of charge and discharge with respect to a discharge capacity at the 5^{th} charge-discharge cycle after formation (e.g., formation cycles). In some embodiments, the electrochemical cell exhibits an decrease in discharge capacity of less than or equal to 20%, less than or equal to 15%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, less than or equal to 1%, less than or equal to 0.5%, less than or equal to 0.1%, less than or equal to 0.05%, or less than or equal to 0.01% after 100 cycles of charge and discharge with respect to a discharge capacity at the 5^{th} charge-discharge cycle after formation. Combination of the above-referenced ranges are possible (e.g., greater than or equal to 0% and less than or equal to 20%). Other ranges are also possible.

In some embodiments, an electrochemical cell comprising a solid electrolyte interphase layer described herein exhibits a slower rate of increase in discharge resistance compared to an otherwise equivalent electrochemical cell without such solid electrolyte interphase layer. The discharge resistance of an electrochemical cell during cycling may be determined by the following general protocols. First, an electrochemical cell may be connected to a battery cycler channel that is capable of delivering the manufacturer specified current and voltage to the electrochemical cell. The cell was first discharged at a manufacturer specified current to a manufacturer specified voltage, then rested for a period of time (e.g., at least 2 minutes). Next, the cell may be charged at the manufacturer specified current to the manufacturer specified voltage, and the voltage was kept at the specified voltage until the current decayed to a particular value, and the cell was rested again for a period of time (e.g., at least 2 minutes). A voltage at rest (V₁) was measured at the end of this period of rest. The cell was then discharged again at the manufacturer specified current to the specified voltage. A voltage (V₂) can be measured 5 minutes into this discharge. A discharge resistance, otherwise known as 5 min discharge resistance R, can be calculated using Eq. (2):

R=(V₂−V₁)/I_{dch} (2)

where V₁ is the voltage at the end of the rest prior to the discharge, V₂ is the voltage measured after 5 min into discharge, and I_{dch} is the discharge current (A). As the cycling continues, a discharge resistance can be determined for each subsequent cycle.

In some such embodiments, the electrochemical cell exhibits an increase in discharge resistance of greater than or equal to 0%, greater than or equal to 0.01%, greater than or equal to 0.05%, greater than or equal to 0.1%, greater than or equal to 0.5%, greater than or equal to 1%, greater than or equal to 5%, greater than or equal to 2%, greater than or equal to 3%, greater than or equal to 4%, greater than or equal to 5%, greater than or equal to 6%, greater than or equal to 7%, greater than or equal to 8%, greater than or equal to 9%, greater than or equal to 10%, or greater than or equal to 15% after 100 cycles of charge and discharge with respect to a discharge resistance at the 5^{th} charge-discharge cycle after formation. In some embodiments, the electrochemical cell exhibits an increase in discharge resistance of less than or equal to 20%, less than or equal to 15%, less than or equal to 10%, less than or equal to 9%, less than or equal to 8%, less than or equal to 7%, less than or equal to 6%, less than or equal to 5%, less than or equal to 4%, less than or equal to 3%, less than or equal to 2%, less than or equal to 1%, less than or equal to 0.5%, less than or equal to 0.1%, less than or equal to 0.05%, or less than or equal to 0.01% after 100 cycles of charge and discharge with respect to a discharge resistance at the 5^{th} charge-discharge cycle after formation. Combination of the above-referenced ranges are possible (e.g., greater than 0% and less than or equal to 20%). Other ranges are also possible.

In some embodiments, an electrochemical cell comprising a solid electrolyte interphase layer described herein (e.g., comprising one or more of LiF, Li₂CO₃, Li₂O, etc.) exhibits an enhanced cycle life. In some embodiments, an electrochemical cell comprising a solid electrolyte interphase layer described herein exhibits a cycle life of greater than or equal to 100 cycles, greater than or equal to 150 cycles, greater than or equal to 200 cycles, greater than or equal to 250 cycles, greater than or equal to 300 cycles, greater than or equal to 350 cycles, greater than or equal to 400 cycles, greater than or equal to 450 cycles, greater than or equal to 500 cycles, greater than or equal to 1000 cycles, or greater than or equal to 1500 cycles. In some embodiments, an electrochemical cell comprising a solid electrolyte interphase layer described herein exhibits a cycle life of less than or equal to 2000 cycles, less than or equal to 1500 cycles, less than or equal to 1000 cycles, less than or equal to 500 cycles, less than or equal to 450 cycles, less than or equal to 400 cycles, less than or equal to 350 cycles, less than or equal to 300 cycles, less than or equal to 250 cycles, less than or equal to 200 cycles, or less than or equal to 150 cycles. Combination of the above-referenced ranges are possible (e.g., greater than or equal to 100 cycles and less than or equal to 2000 cycles). Other ranges are also possible.

In some embodiments, an electrochemical cell comprising a solid electrolyte interphase layer described herein (e.g., comprising one or more of LiF, Li₂CO₃, Li₂O, etc.) exhibits an enhanced cycle life compared to an otherwise equivalent electrochemical cells without such solid electrolyte interphase layer. In some embodiments, an electrochemical cell comprising a solid electrolyte interphase layer described herein exhibits an cycle life that is greater than or equal to 2 times, greater than or equal to 3 times, greater than or equal to 5 times, greater than or equal to 10 times, greater than or equal to 15 times, greater than or equal to 20 times, greater than or equal to 25 times, greater than or equal to 30 times, greater than or equal to 40 times, greater than or equal to 50 times, greater than or equal to 100 times, greater than or equal to 200 times, greater than or equal 300 times, or greater than or equal to 400 times the cycle life of an otherwise equivalent electrochemical cells without the solid electrolyte interphase. In some embodiments, the electrochemical cell comprising a solid electrolyte interphase layer described herein exhibits an cycle life that is less than or equal to 500 times, less than or equal to 400 times, less than or equal to 300 times, less than or equal to 200 times, less than or equal to 100 times, less than or equal to 50 times, less than or equal to 40 times, less than or equal to 30 times, less than or equal to 20 times, less than or equal to 10 times, or less than or equal to 3 times the cycle life of an otherwise equivalent electrochemical cells without the solid electrolyte interphase layer. Combination of the above-referenced ranges are possible (e.g., greater than or equal to 2 times and less than or equal to 500 times). Other ranges are also possible.

In some embodiments, an electrochemical cell comprising a solid electrolyte interphase layer (e.g., comprising one or more of LiF, Li₂CO₃, Li₂O, etc.) with an application of anisotropic force during at least a period of charge and discharge cycle exhibits enhanced physical properties compared to an otherwise equivalent cell comprising a solid electrolyte interphase layer without the applied anisotropic force. In some embodiments, an electrochemical cell comprising a solid electrolyte interphase layer described herein (e.g., comprising one or more of LiF, Li₂CO₃, Li₂O, etc.) with an application of anisotropic force during at least a period of charge and discharge cycle exhibits an cycle life that is greater than or equal to 2 times, greater than or equal to 3 times, greater than or equal to 5 times, greater than or equal to 10 times, greater than or equal to 15 times, greater than or equal to 20 times, greater than or equal to 25 times, greater than or equal to 30 times, greater than or equal to 40 times, greater than or equal to 50 times, greater than or equal to 100 times, greater than or equal to 200 times, greater than or equal 300 times, or greater than or equal to 400 times the cycle life of an otherwise equivalent electrochemical cell comprising a solid electrolyte interphase layer but formed without pressure application. In some embodiments, the electrochemical cell comprising a solid electrolyte interphase layer described herein with an application of anisotropic force during at least a period of charge and discharge cycle exhibits an cycle life that is less than or equal to 500 times, less than or equal to 400 times, less than or equal to 300 times, less than or equal to 200 times, less than or equal to 100 times, less than or equal to 50 times, less than or equal to 40 times, less than or equal to 30 times, less than or equal to 20 times, less than or equal to 10 times, or less than or equal to 3 times the cycle life of an otherwise equivalent electrochemical cells comprising a solid electrolyte interphase layer formed without pressure application. Combination of the above-referenced ranges are possible (e.g., greater than or equal to 2 times and less than or equal to 500 times). Other ranges are also possible. The magnitude of anisotropic force applied may be in one or more of the ranges described herein.

In some embodiments, an electrochemical cell comprising a solid electrolyte interphase layer (e.g., comprising one or more of LiF, Li₂CO₃, Li₂O, etc.) formed in the presence of a fluorinated electrolyte solvent and subjected to an applied anisotropic force during at least a period of charge and discharge cycles exhibits enhanced physical properties compared to an otherwise equivalent cell comprising a solid electrolyte interphase layer formed in the presence of a non-fluorinated electrolyte solvent and subjected to the same applied anisotropic force. For example, compared to the solid electrolyte interphase layer of the cell comprising the non-fluorinated electrolyte and subjected to the anisotropic force, the solid electrolyte interphase layer in the electrochemical cell comprising the fluorinated electrolyte solvent and subjected to the same applied anisotropic force may exhibit a slower increase in thickness and/or a slower decrease in bulk density over cycles of charge and discharge. These differences in physical properties may, at least in part, contribute to an improved cycle life.

In some embodiments, an electrochemical cell comprising a solid electrolyte interphase layer (e.g., comprising one or more of LiF, Li₂CO₃, Li₂O, etc.) formed under high formation voltage exhibits enhanced physical properties compared to otherwise equivalent cells comprising a solid electrolyte interphase layer formed without the high formation voltage. In some embodiments, an electrochemical cell comprising a solid electrolyte interphase layer described herein (e.g., comprising one or more of LiF, Li₂CO₃, Li₂O, etc.) formed under high formation voltage exhibits an cycle life that is greater than or equal to 2 times, greater than or equal to 3 times, greater than or equal to 5 times, greater than or equal to 10 times, greater than or equal to 15 times, greater than or equal to 20 times, greater than or equal to 25 times, greater than or equal to 30 times, greater than or equal to 40 times, greater than or equal to 50 times, greater than or equal to 100 times, greater than or equal to 200 times, greater than or equal 300 times, or greater than or equal to 400 times the cycle life of an otherwise equivalent electrochemical cells comprising a solid electrolyte interphase layer but formed without the high formation voltage. In some embodiments, the electrochemical cell comprising a solid electrolyte interphase layer formed under high formation voltage exhibits an cycle life that is less than or equal to 500 times, less than or equal to 400 times, less than or equal to 300 times, less than or equal to 200 times, less than or equal to 100 times, less than or equal to 50 times, less than or equal to 40 times, less than or equal to 30 times, less than or equal to 20 times, less than or equal to 10 times, or less than or equal to 3 times the cycle life of an otherwise equivalent electrochemical cells comprising the solid electrolyte interphase formed without the high formation voltage. Combination of the above-referenced ranges are possible (e.g., greater than or equal to 2 times and less than or equal to 500 times). Other ranges are also possible.

In some embodiments, an electrochemical cell comprising a solid electrolyte interphase layer (e.g., rich in one or more of LiF, Li₂CO₃, Li₂O, etc.) help retain charge and discharge capacity in an electrochemical cell at relatively low temperatures (e.g., less than or equal to 0° C., less than or equal to −25° C., less than or equal to −40° C., etc.). In some such embodiments, upon charge and discharge at relatively low temperatures, the electrochemical cell comprising a solid electrolyte interphase layer described herein exhibits an enhanced cycle life of greater than or equal to 60 cycles, greater than or equal to 80 cycles, greater than or equal to 90 cycles, greater than or equal to 100 cycles, greater than or equal to 125 cycles, greater than or equal to 150 cycles, greater than or equal to 250 cycles, greater than or equal to 500 cycles, or greater than or equal to 750 cycles. In some embodiments, upon charge and discharge at relatively low temperatures, the electrochemical cell comprising a solid electrolyte interphase layer described herein exhibits a cycle life of less than or equal to 1000 cycles, less than or equal to 750 cycles, less than or equal to 500 cycles, less than or equal to 250 cycles, less than or equal to 175 cycles, less than or equal to 150 cycles, less than or equal to 125 cycles, less than or equal to 100 cycles, less than or equal to 90 cycles, less than or equal to 80 cycles, or less than or equal to 70 cycles. Combination of the above-referenced ranges are possible (e.g., greater than or equal to 60 cycles and less than or equal to 1000 cycles). Other ranges are also possible.

In some embodiments, the electrolyte comprises a solvent. In one set of embodiments, the solvent comprises at least one fluorinated organic solvent. In some embodiments, a fluorinated organic solvent and/or a mixture of fluorinated organic solvent is used as the sole solvent in the electrolyte. In some embodiments, the fluorinated organic solvent and/or a mixture of fluorinated organic solvents, when subjected to a period of time during charge and discharge cycles, results in the formation of a solid electrolyte interphase layer comprising a relatively high amount of inorganic materials (e.g., LiF, Li₂CO₃, Li₂O, etc.). In some embodiments, non-fluorinated solvents may be present.

In some embodiments, the at least one fluorinated organic solvent is selected from group of cyclic and linear fluorinated carbonates, fluorinated ethers, and fluorinated esters (e.g., fluorinated alkyl esters). For example, in one embodiment, the solvent comprises at least one fluorinated organic solvent that is selected from fluoroethylene carbonate and/or difluoroethylene carbonate. Additional non-limiting examples of fluorinated organic solvent include, but are not limited to, methyl, 2,2,2-trifluoroethyl carbonate, 1,1,2,2-tetrafluoroethyl 2,2,2-trifluoroethylether, 1,1,2,2-tetrafluoroethyl-2,2,3,3-tetrafluoropropylether, methyl difluoroacetate, ethyl difluoroacetate, methyl trifluoroacetate, and ethyl trifluoroacetate.

Fluorinated organic solvent(s) may be present in any of a variety of suitable amounts in the electrolyte. In some embodiments, the fluorinated organic solvent(s) (e.g., fluoroethylene carbonate (FEC)) may be present in an amount of greater than or equal to 10 wt %, greater than or equal to 11 wt %, greater than or equal to 12 wt %, greater than or equal to 13 wt %, greater than or equal to 14 wt %, greater than or equal to 15 wt %, greater than or equal to 17 wt %, greater than or equal to 20 wt %, greater than or equal to 30 wt %, greater than or equal to 35 wt %, greater than or equal to 40 wt %, greater than or equal to 50 wt %, greater than or equal to 60 wt %, greater than or equal to 70 wt %, greater than or equal to 80 wt % of a total electrolyte weight, or greater than or equal to 88 wt %. In some embodiments, the fluorinated organic solvent(s) may be present in an amount of less than or equal to 90 wt %, less than or equal to 88 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 17 wt %, less than or equal to 15 wt %, less than or equal to 13 wt %, less than or equal to 12 wt %, or less than or equal to 11 wt % of a total electrolyte weight. Combination of the above-referenced ranges are possible (e.g., greater than or equal to 10 wt % and less than or equal to 90 wt %, greater than or equal to 14 wt % and less than or equal to 88 wt %, or greater than or equal to 17 wt % and less than or equal to 44 wt %). Other ranges are also possible.

In some embodiments, the solvent further comprises at least one non-fluorinated organic solvent. In some embodiments, the non-fluorinated solvent (or decomposition products thereof), when subjected to a period of time during charge and discharge cycles, result in the formation of one or more inorganic materials (e.g., Li₂CO₃, Li₂O) in the solid electrolyte interphase layer. In some embodiments, the at least one non-fluorinated organic solvent comprises ester-based solvents. In some embodiments, the organic solvent may comprise one or more of esters of carboxylic acids, esters of phosphoric acid, linear and cyclic ethers and acetals, esters of sulfuric acids, esters of sulfonic acids, esters formed from carboxylic acids and halogenated alcohols, and alkyl esters.

In some embodiments, the at least one non-fluorinated organic solvent comprises cyclic and/or linear carbonates. In some such embodiments, the non-fluorinated solvent may comprise one or more of carbonate-based solvents selected from the group of dimethyl carbonate, diethyl carbonate, ethyl methyl carbonate, propylene carbonate, and ethylene carbonate. Additionally or alternatively, the at least one non-fluorinated organic solvent may comprise acetates (e.g., methyl acetate, ethyl acetate), alky esters (e.g, ethyl butyrate), lactones (e.g., gamma-butyrolactone), etc. Non-fluorinated organic solvent(s) may be present in any of a variety of suitable amounts in the electrolyte. In some embodiments, the non-fluorinated organic solvent(s) may be present in an amount of greater than or equal to 0 wt %, greater than or equal to 5 wt %, greater than or equal to 10 wt %, greater than or equal to 15 wt %, greater than or equal to 20 wt %, greater than or equal to 30 wt %, greater than or equal to 35 wt %, greater than or equal to 40 wt %, greater than or equal to 50 wt %, greater than or equal to 60 wt %, or greater than or equal to 70 wt % of a total electrolyte weight. In some embodiments, the non-fluorinated organic solvent(s) may be present in an amount of less than or equal to 75 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, or less than or equal to 5 wt % of a total electrolyte weight. Combination of the above-referenced ranges are possible (e.g., greater than or equal to 0 wt % and less than or equal to 75 wt %). Other ranges are possible.

The electrolyte solvent may comprise fluorinated organic solvent(s) and non-fluorinated organic solvent(s) in any of a variety of appropriate ratios by weight. In some embodiments, the weight-based ratio of fluorinated organic solvent(s) (e.g., fluoroethylene carbonate, etc.) to non-fluorinated organic solvent(s) may be, in some cases, greater than or equal to 1:10, greater than or equal to 1:8, greater than or equal to 1:5, greater than or equal to 1:4, greater than or equal to 1:3, greater than or equal to 1:2, greater than or equal to 1:1, greater than or equal to 2:1, greater than or equal to 3:1, greater than or equal to 5:1, greater than or equal to 10:1, greater than or equal to 30:1, greater than or equal to 50:1, greater than or equal to 70:1, or greater than or equal to 90:1. In some embodiments, the weight-based ratio of fluorinated organic solvent(s) to non-fluorinated organic solvent(s) is less than or equal to 100:1 (e.g., 99:1), less than or equal to 90:1, less than or equal 70:1, less than or equal to 50:1, less than or equal to 30:1, less than or equal to 10:1, less than or equal to 5:1, less than or equal to 3:1, less than or equal to 2:1, less than or equal to 1:1, less than or equal to 1:2, less than or equal to 1:3, less than or equal to 1:4, less than or equal to 1:5, less than or equal to 1:8, less than or equal to 1:10, or less than or equal to 1:15. Combinations of the above-referenced ranges are also possible (e.g., greater than or equal to 1:10 and less than or equal to 100:1, greater than or equal to 1:10 and less than or equal to 2:1, or greater than or equal to 1:4 and less than or equal to 1:1, or greater than or equal to 1:3 and less than or equal to 1:1). Other ranges may be possible.

Additional non-limiting examples of useful electrolyte include, but are not limited to, for example, N-methyl acetamide, acetonitrile, acetals, ketals, esters (e.g., esters of carbonic acid), carbonates (e.g., dimethyl carbonate, diethyl carbonate, ethyl methyl carbonate, propylene carbonate, ethylene carbonate, fluoroethylene carbonate, difluoroethylene carbonate), sulfones, sulfites, sulfolanes, sulfonimides (e.g., bis(trifluoromethane)sulfonimide lithium salt), aliphatic ethers, acyclic ethers, cyclic ethers, glymes, polyethers, phosphate esters (e.g., hexafluorophosphate), siloxanes, dioxolanes, N-alkylpyrrolidones, nitrate containing compounds, substituted forms of the foregoing, and blends thereof. Examples of acyclic ethers that may be used include, but are not limited to, diethyl ether, dipropyl ether, dibutyl ether, dimethoxymethane, trimethoxymethane, 1,2-dimethoxyethane, diethoxyethane, 1,2-dimethoxypropane, and 1,3-dimethoxypropane. Examples of cyclic ethers that may be used include, but are not limited to, tetrahydrofuran, tetrahydropyran, 2-methyltetrahydrofuran, 1,4-dioxane, 1,3-dioxolane, and trioxane. Examples of polyethers that may be used include, but are not limited to, diethylene glycol dimethyl ether (diglyme), triethylene glycol dimethyl ether (triglyme), tetraethylene glycol dimethyl ether (tetraglyme), higher glymes, ethylene glycol divinyl ether, diethylene glycol divinyl ether, triethylene glycol divinyl ether, dipropylene glycol dimethyl ether, and butylene glycol ethers. Examples of sulfones that may be used include, but are not limited to, sulfolane, 3-methyl sulfolane, and 3-sulfolene. Fluorinated derivatives of the foregoing are also useful as liquid electrolyte solvents.

In one set of embodiments, the solvent comprises a mixture of fluoroethylene carbonate (FEC) and non-fluorinated carbonate solvent (e.g., dimethyl carbonate (DMC), ethyl methyl carbonate (EMC), or combination thereof). In some such embodiments, the weight-based ratio of fluoroethylene carbonate to non-fluorinated carbonate solvent in the organic solvent may be, in some cases, greater than or equal to 1:10 (e.g., 1:9), greater than or equal to 1:8, greater than or equal to 1:5, greater than or equal to 1:4, greater than or equal to 1:3, greater than or equal to 1:2, or greater than or equal to 1:1. In some embodiments, the weight-based ratio of fluoroethylene carbonate to non-fluorinated carbonate solvent may be less than or equal to 2:1, less than or equal to 1:1, less than or equal to 1:2, less than or equal to 1:3, less than or equal to 1:4, less than or equal to 1:5, or less than or equal to 1:8. Combinations of the above-referenced ranges are also possible (greater than or equal to 1:10 and less than or equal to 2:1, or greater than or equal to 1:4 and less than or equal to 1:1, or greater than or equal to 1:3 and less than or equal to 1:1). Other ranges are also possible. In some embodiments, a weight ratio of a fluorinated solvent (e.g., FEC) to non-fluorinated solvent (e.g., DMC) is greater than or equal to 1:4 and less than or equal to 1:1.

In some embodiments, the electrolyte comprises at least one passivating agent. In some embodiments, the passivating agent is capable of forming a passivating layer on an electrode (e.g., an anode such as a lithium metal electrode, and/or a cathode such as a lithium intercalation electrode). In some such embodiments, the resultant passivating layer is a part of a solid electrolyte interphase layer described herein. In some embodiments, an electrochemical cell comprising a solid electrolyte interphase layer formed in the presence of a passivating agent may exhibit enhanced physical properties (e.g., anode stability, cycle life, discharge resistance and capacity) compared to otherwise equivalent cells comprising a solid electrolyte interphase layer formed in the absence of the passivating agent, all other factors being equal.

For instance, in some embodiments, an electrochemical cell comprising a solid electrolyte interphase layer (e.g., comprising one or more of LiF, Li₂CO₃, Li₂O, etc.) formed in the presence of a passivating agent exhibits enhanced physical properties compared to an otherwise equivalent cell comprising a solid electrolyte interphase layer in the absence of a passivating agent. In some embodiments, an electrochemical cell comprising a solid electrolyte interphase layer described herein (e.g., comprising one or more of LiF, Li₂CO₃, Li₂O, etc.) formed in the presence of a passivating agent exhibits an cycle life that is greater than or equal to 2 times, greater than or equal to 3 times, greater than or equal to 5 times, greater than or equal to 10 times, greater than or equal to 15 times, greater than or equal to 20 times, greater than or equal to 25 times, greater than or equal to 30 times, greater than or equal to 40 times, greater than or equal to 50 times, greater than or equal to 100 times, greater than or equal to 200 times, greater than or equal 300 times, or greater than or equal to 400 times the cycle life of an otherwise equivalent electrochemical cells comprising a solid electrolyte interphase layer but formed without passivating agent. In some embodiments, the electrochemical cell comprising a solid electrolyte interphase layer formed in the presence of a passivating agent exhibits an cycle life that is less than or equal to 500 times, less than or equal to 400 times, less than or equal to 300 times, less than or equal to 200 times, less than or equal to 100 times, less than or equal to 50 times, less than or equal to 40 times, less than or equal to 30 times, less than or equal to 20 times, less than or equal to 10 times, or less than or equal to 3 times the cycle life of an otherwise equivalent electrochemical cells comprising the solid electrolyte interphase layer formed in the absence of the passivating agent. Combination of the above-referenced ranges are possible (e.g., greater than or equal to 2 times and less than or equal to 500 times). Other ranges are also possible.

Suitable passivating agents may include, but are not limited to, boron-containing compounds, such as compounds comprising an (oxalato)borate group. The (oxalato)borate group may comprise, for example, the bis(oxalato)borate anion and/or the difluoro(oxalato)borate anion. According to certain embodiments, the passivating agent may comprise a salt (e.g., oxalate salt). In some embodiments, a passivating agent comprising a salt may comprise a lithium cation. For example, the lithium salt may comprise lithium bis(oxalato)borate (LiBOB) and/or lithium difluoro(oxalato)borate (LiDFOB). In some embodiments, the lithium salt may comprise lithium tetrafluoroborate (LiBF₄).

In some embodiments, the total weight of the passivating agent(s) (e.g., an (oxalato)borate group such as lithium bis(oxalato)borate (LiBOB) and/or lithium difluoro(oxalato)borate) in the electrochemical cell may be less than or equal to about 30 wt %, less than or equal to about 28 wt %, less than or equal to about 25 wt %, less than or equal to about 22 wt %, less than or equal to about 20 wt %, less than or equal to about 18 wt %, less than or equal to about 15 wt %, less than or equal to about 12 wt %, less than or equal to about 10 wt %, less than or equal to about 8 wt %, less than or equal to about 6 wt %, less than or equal to about 5 wt %, less than or equal to about 4 wt %, less than or equal to about 3 wt %, less than or equal to about 2 wt %, or less than or equal to about 1 wt % versus the total weight of the electrolyte. In certain embodiments, the total weight of the passivating agent(s) in the electrochemical cell is greater than about 0.2 wt %, greater than about 0.5 wt %, greater than about 1 wt %, greater than about 2 wt %, greater than about 3 wt %, greater than about 4 wt %, greater than about 6 wt %, greater than about 8 wt %, greater than about 10 wt %, greater than about 15 wt %, greater about 18 wt %, greater than about 20 wt %, greater than about 22 wt %, greater than about 25 wt %, or greater than about 28 wt % versus the total weight of the electrolyte. Combinations of the above-referenced ranges are also possible (e.g., between about 0.2 wt % and about 30 wt %, between about 0.2 wt % and about 20 wt %, between about 0.5 wt % and about 20 wt %, between about 1 wt % and about 8 wt %, between about 1 wt % and about 6 wt %, between about 4 wt % and about 10 wt %, between about 6 wt % and about 15 wt %, or between about 8 wt % and about 20 wt %). Other ranges are also possible.

In some embodiments, an electrochemical cell may comprise two or more passivating agents. The two or more passivating agents may interact synergistically to enhance one or more properties of the electrochemical cell to an extent beyond what would be expected from the effects on the electrochemical cell of either passivating agent individually.

Additional examples of passivating agent(s) include, but are not limited to, sultones (e.g., 1,3 propane sultone (PS), prop-1-ene-1.3-sultone (PES)), sulfonates (e.g., methylene methanesulfonate (MMDS)), vinylene carbonate, phosphite, lithium salts (e.g., LiBF₄)), xanthate groups (e.g., lithium xanthate, potassium xanthate, lithium ethyl xanthate, potassium ethyl xanthate, lithium isobutyl xanthate, potassium isobutyl xanthate, lithium tert-butyl xanthate, potassium tert-butyl xanthate), polyxanthate groups, carbamate groups (e.g., lithium dithiocarbamate, potassium dithiocarbamate, lithium diethyldithiocarbamate, and potassium diethyldithiocarbamate), polycarbamate groups, N—O groups (e.g., lithium nitrate, magnesium nitrate), silanes, etc. Additional examples of passivating agents(s) and method of use thereof are described in detail, for example, in US 2018-0351158 A1, which is incorporated herein by reference in its entirety.

In some embodiments, the electrolyte comprises at least one lithium salt. In one set of embodiments, the lithium salt may comprise one or more of lithium hexafluorophosphate (LiPF₆), lithium bis(fluorosulfonyl)imide (LiFSI), lithium perchlorate (LiClO₄), lithium hexafluoroarsenate (LiAsF₆), lithium tetrafluoroborate (LiBF₄), lithium trifluoromethanesulfonate (LiCF₃SO₃), and lithium bis(trifluoromethanesulfonyl)imide (LiTFSI). Additional examples of lithium include, but are not limited to, LiSCN, LiBr, LiI, LiSO₃CH₃, LiNO₃, LiPF₆, LiBF₄, LiB(Ph)₄, LiClO₄, LiAsF₆, Li₂SiF₆, LiSbF₆, LiAlCl₄, lithium bis(oxalato)borate, lithium difluoro(oxalato)borate, a salt comprising a tris(oxalato)phosphate anion (e.g., lithium tris(oxalato)phosphate), LiC(SO₂CF₃)₃, LiCF₃SO₃, LiN(SO₂F)₂, LiN(SO₂CF₃)₂, LiC(CₙF₂ₙ₊₁SO₂)₃ wherein n is an integer in the range of from 1 to 20, and (CₙF₂ₙ₊₁SO₂)mXLi with n being an integer in the range of from 1 to 20, m being 1 when X is selected from oxygen or sulfur, m being 2 when X is selected from nitrogen or phosphorus, and m being 3 when X is selected from carbon or silicon. Other electrolyte salts that may be useful include lithium polysulfides (Li2Sx), and lithium salts of organic polysulfides (LiSxR)n, where x is an integer from 1 to 20, n is an integer from 1 to 3, and R is an organic group, and those disclosed in U.S. Pat. No. 5,538,812 to Lee et al., which is incorporated herein by reference in its entirety for all purposes.

When present, a lithium salt may be present in the electrolyte at a variety of suitable concentrations. In some embodiments, the lithium salt is present in the electrolyte at a concentration of greater than or equal to 0.01 M, greater than or equal to 0.02 M, greater than or equal to 0.05 M, greater than or equal to 0.1 M, greater than or equal to 0.2 M, greater than or equal to 0.5 M, greater than or equal to 1 M, greater than or equal to 2 M, or greater than or equal to 5 M. The lithium salt may be present in the electrolyte at a concentration of less than or equal to 10 M, less than or equal to 5 M, less than or equal to 2 M, less than or equal to 1 M, less than or equal to 0.5 M, less than or equal to 0.2 M, less than or equal to 0.1 M, less than or equal to 0.05 M, or less than or equal to 0.02 M. Combinations of the above-referenced ranges are also possible (e.g., greater than or equal to 0.01 M and less than or equal to 10 M, or greater than or equal to 0.01 M and less than or equal to 5 M). Other ranges are also possible.

In some embodiments, the electrolyte comprises one or more room temperature ionic liquids. The room temperature ionic liquid, if present, typically comprises one or more cations and one or more anions. Non-limiting examples of suitable cations include lithium cations and/or one or more quaternary ammonium cations such as imidazolium, pyrrolidinium, pyridinium, tetraalkylammonium, pyrazolium, piperidinium, pyridazinium, pyrimidinium, pyrazinium, oxazolium, and trizolium cations. Non-limiting examples of suitable anions include trifluromethylsulfonate (CF₃SO₃⁻), bis (fluorosulfonyl)imide (N(FSO₂)₂⁻, bis (trifluoromethyl sulfonyl)imide ((CF₃SO₂)₂N⁻, bis (perfluoroethylsulfonyl)imide((CF₃CF₂SO₂)₂N⁻ and tris(trifluoromethylsulfonyl)methide ((CF₃SO₂)₃C⁻. Non-limiting examples of suitable ionic liquids include N-methyl-N-propylpyrrolidinium/bis(fluorosulfonyl) imide and 1,2-dimethyl-3-propylimidazolium/bis(trifluoromethanesulfonyl)imide. In some embodiments, the electrolyte comprises both a room temperature ionic liquid and a lithium salt. In some other embodiments, the electrolyte comprises a room temperature ionic liquid and does not include a lithium salt.

Suitable active electrode materials for use in the first electrode (e.g., as an anode active electrode species in an anode of an electrochemical cells described herein) include, but are not limited to, lithium metal such as lithium foil and lithium deposited onto a substrate, and lithium alloys (e.g., lithium-aluminum alloys and lithium-tin alloys). Lithium can be contained as one film or as several films, optionally separated by a protective material such as a ceramic material or an ion conductive material described herein. Suitable ceramic materials include silica-, alumina-, and/or lithium-containing glassy materials such as lithium phosphates, lithium aluminates, lithium silicates, lithium carbonates, lithium oxides, lithium phosphorous oxynitrides, lithium tantalum oxide, lithium aluminosulfides, lithium titanium oxides, lithium silcosulfides, lithium germanosulfides, lithium aluminosulfides, lithium borosulfides, lithium phosphosulfides, and combinations of two or more of the preceding. Suitable lithium alloys for use in the embodiments described herein can include alloys of lithium and aluminum, magnesium, silicium (silicon), indium, silver, and/or tin. While these materials may be preferred in some embodiments, other cell chemistries are also contemplated. In some embodiments, the first electrode may comprise one or more binder materials (e.g., polymers, etc.).

In some embodiments, the thickness of the first electrode (e.g., an anode) may vary from, e.g., about 1 to about 200 microns. For instance, the first electrode (e.g., an anode) may have a thickness of less than about 200 microns, less than about 100 microns, less than about 50 microns, less than about 25 microns, less than about 10 microns, or less than about 5 microns. In some embodiments, the first electrode (e.g., an anode) may have a thickness of greater than or equal to about 1 micron, greater than or equal to about 5 microns, greater than or equal to about 10 microns, greater than or equal to about 25 microns, greater than or equal to about 50 microns, greater than or equal to about 100 microns, or greater than or equal to about 150 microns. Combinations of the above-referenced ranges are also possible (e.g., between about 1 micron and about 200 microns, between about 1 micron and about 100 microns, between about 5 microns and about 50 microns, between about 5 microns and about 25 microns, or between about 10 microns and about 25 microns). Other ranges are also possible. The choice of the thickness may depend on cell design parameters such as the excess amount of lithium desired, cycle life, and the thickness of the second electrode.

Methods for depositing a negative electrode material (e.g., an alkali metal anode such as lithium) onto a substrate may include methods such as thermal evaporation, sputtering, jet vapor deposition, and laser ablation. Alternatively, where the anode comprises a lithium foil, or a lithium foil and a substrate, these can be laminated together by a lamination process as known in the art to form an anode.

In some embodiments, the electroactive material within a second electrode (e.g., a cathode active electrode species in a cathode of an electrochemical cell described herein) can comprise metal oxides. In some embodiments, an intercalation electrode (e.g., a lithium-intercalation cathode, also referred to herein as a lithium ion intercalation cathode) may be used (e.g., as a second electrode). Non-limiting examples of suitable materials that may intercalate ions of an electroactive material (e.g., alkaline metal ions) include oxides, titanium sulfide, and iron sulfide. In some embodiments, the second electrode (e.g., a cathode) may comprise an intercalation electrode that comprises a lithium transition metal oxide or a lithium transition metal phosphate. Additional examples include LiₓCoO₂ (also referred to herein as lithium cobalt oxide; e.g., Li_{1.1}CoO₂), LiₓNiO₂, LiₓMnO₂, LiₓMn₂O₄ (e.g., Li_{1.05}Mn₂O₄), LiₓCoPO₄, LiₓMnPO₄, LiCoₓNi₍₁₋ₓ₎O₂, and LiCoₓNi_{y}Mn_{(1-x-y)}O₂ (also referred to herein as lithium nickel manganese cobalt oxide; e.g., LiNi_{1/3}Mn_{1/3}Co_{1/3}O₂, LiNi_{3/5}Mn_{3/5}Co_{3/5}O₂, LiNi_{4/5}Mn_{1/10}Co_{1/10}O₂, LiNi_{1/2}Mn_{3/10}Co_{1/5}O₂). X (e.g., for intercalation cathodes with a chemical composition LiₓM_{y}O_{z} as described elsewhere herein, where M is a metal or combination of metals) may be greater than or equal to 0 and less than or equal to 2. X is typically greater than or equal to 1 and less than or equal to 2 when the electrochemical cell is fully discharged, and less than 1 when the electrochemical cell is fully charged. In some embodiments, a fully charged electrochemical cell may have a value of x that is greater than or equal to 1 and less than or equal to 1.05, greater than or equal to 1 and less than or equal to 1.1, or greater than or equal to 1 and less than or equal to 1.2. Further examples include LiₓNiPO₄, where 0≤x≤1, LiMnₓNi_{y}O₄ where x+y=2 (e.g., LiMn_{1.5}Ni_{0.5}O₄), LiNiₓCo_{y}Al_{z}O₂ where x+y+z=1 (also referred to herein as lithium nickel cobalt aluminum oxide), LiFePO₄ (also referred to herein as lithium iron phosphate), and combinations thereof. In some embodiments, the electroactive material within the second electrode (e.g., a cathode) can comprise lithium transition metal phosphates (e.g., LiFePO₄), which can, in some embodiments, be substituted with borates and/or silicates.

In some embodiments, the electroactive material within a second electrode (e.g., a cathode active electrode species in a cathode of an electrochemical cell described herein) can comprise electroactive transition metal chalcogenides, electroactive conductive polymers, and/or electroactive sulfur-containing materials, and combinations thereof. As used herein, the term “chalcogenides” pertains to compounds that contain one or more of the elements of oxygen, sulfur, and selenium. Examples of suitable transition metal chalcogenides include, but are not limited to, the electroactive oxides, sulfides, and selenides of transition metals selected from the group consisting of Mn, V, Cr, Ti, Fe, Co, Ni, Cu, Y, Zr, Nb, Mo, Ru, Rh, Pd, Ag, Hf, Ta, W, Re, Os, and Ir. In one embodiment, the transition metal chalcogenide is selected from the group consisting of the electroactive oxides of nickel, manganese, cobalt, and vanadium, and the electroactive sulfides of iron. In one embodiment, a second electrode (e.g., as a cathode active electrode species in the cathode of the electrochemical cells described herein) can comprise an electroactive conductive polymer. Examples of suitable electroactive conductive polymers include, but are not limited to, electroactive and electronically conductive polymers selected from the group consisting of polypyrroles, polyanilines, polyphenylenes, polythiophenes, and polyacetylenes. In some embodiments, it may be desirable to use polypyrroles, polyanilines, and/or polyacetylenes as conductive polymers.

A variety of cathode active materials are suitable for use with cathodes of the electrochemical cells described herein, according to certain embodiments. In some embodiments, the cathode active material comprises a lithium intercalation compound (e.g., a compound that is capable of reversibly inserting lithium ions at lattice sites and/or interstitial sites). In certain cases, the cathode active material comprises a layered oxide. A layered oxide generally refers to an oxide having a lamellar structure (e.g., a plurality of sheets, or layers, stacked upon each other). Non-limiting examples of suitable layered oxides include lithium cobalt oxide (LiCoO₂), lithium nickel oxide (LiNiO₂), and lithium manganese oxide (LiMnO₂).

In some embodiments, the layered oxide is lithium nickel manganese cobalt oxide (LiNiₓMn_{y}Co_{z}O₂, also referred to as “NMC” or “NCM”). In some such embodiments, the sum of x, y, and z is 1. For example, non-limiting examples of a suitable NMC compound are LiNi_{1/3}Mn_{1/3}Co_{1/3}O₂ (NCM 333), LiNi_{0.5}Co_{0.2}Mn_{0.3}O₂ (NCM 523), LiNi_{0.6}Co_{0.2}Mn_{0.2}O₂ (NCM 622), LiNi_{0.5}Co_{0.1}Mn_{0.1}O₂ (NCM 811), and Li₁₊ₓ(Ni_{0.85}Co_{0.10}Mn_{0.05})₁₋ₓO₂ (NCM851005), where x≈0.01 In some embodiments, a layered oxide may have the formula (Li₂MnO₃)ₓ(LiMO₂)₍₁₋ₓ₎ where M is one or more of Ni, Mn, and Co. For example, the layered oxide may be (Li₂MnO₃)_{0.25}(LiNi_{0.3}Co_{0.15}Mn_{0.55}O₂)_{0.75}.

In some embodiments, the layered oxide is lithium nickel cobalt aluminum oxide (LiNiₓCo_{y}Al_{z}O₂, also referred to as “NCA”). In some such embodiments, the sum of x, y, and z is 1. For example, a non-limiting example of a suitable NCA compound is LiNi_{0.8}Co_{0.15}Al_{0.05}O₂. In certain embodiments, the cathode active material is a transition metal polyanion oxide (e.g., a compound comprising a transition metal, an oxygen, and/or an anion having a charge with an absolute value greater than 1). A non-limiting example of a suitable transition metal polyanion oxide is lithium iron phosphate (LiFePO₄, also referred to as “LFP”). Another non-limiting example of a suitable transition metal polyanion oxide is lithium manganese iron phosphate (LiMnₓFe₁₋ₓPO₄, also referred to as “LMFP”). A non-limiting example of a suitable LMFP compound is LiMn_{0.8}Fe_{0.2}PO₄. In some embodiments, the cathode active material is a spinel (e.g., a compound having the structure AB₂O₄, where A can be Li, Mg, Fe, Mn, Zn, Cu, Ni, Ti, or Si, and B can be Al, Fe, Cr, Mn, or V). A non-limiting example of a suitable spinel is a lithium manganese oxide with the chemical formula LiMₓMn₂₋ₓO₄ where M is one or more of Co, Mg, Cr, Ni, Fe, Ti, and Zn. In some embodiments, x may equal 0 and the spinel may be lithium manganese oxide (LiMn₂O₄, also referred to as “LMO”). Another non-limiting example is lithium manganese nickel oxide (LiNiₓM₂₋ₓO₄, also referred to as “LMNO”). A non-limiting example of a suitable LMNO compound is LiNi_{0.5}Mn_{1.5}O₄. In certain cases, the electroactive material of the second electrode comprises Li_{1.14}Mn_{0.42}Ni_{0.25}Co_{0.29}O₂ (“HC-MNC”), lithium carbonate (Li₂CO₃), lithium carbides (e.g., Li₂C₂, Li₄C, Li₆C₂, Li₈C₃, Li₆C₃, Li₄C₃, Li₄C₅), vanadium oxides (e.g., V₂O₅, V₂O₃, V₆O₁₃), and/or vanadium phosphates (e.g., lithium vanadium phosphates, such as Li₃V₂(PO₄)₃), or any combination thereof.

In some embodiments, the cathode active material comprises a conversion compound. For instance, the cathode may be a lithium conversion cathode. It has been recognized that a cathode comprising a conversion compound may have a relatively large specific capacity. Without wishing to be bound by a particular theory, a relatively large specific capacity may be achieved by utilizing all possible oxidation states of a compound through a conversion reaction in which more than one electron transfer takes place per transition metal (e.g., compared to 0.1-1 electron transfer in intercalation compounds). Suitable conversion compounds include, but are not limited to, transition metal oxides (e.g., Co₃O₄), transition metal hydrides, transition metal sulfides, transition metal nitrides, and transition metal fluorides (e.g., CuF₂, FeF₂, FeF₃). A transition metal generally refers to an element whose atom has a partially filled d sub-shell (e.g., Sc, Ti, V, Cr, Mn, Fe, Co, Ni, Cu, Zn, Y, Zr, Nb, Mo, Tc, Ru, Rh, Pd, Ag, Cd, Hf, Ta, W, Re, Os, Ir, Pt, Au, Hg, Rf, db, Sg, Bh, Hs).

The electrodes described herein can be part of an electrochemical cell that is integrated into a battery (e.g., a rechargeable battery). In some embodiments, the electrochemical cells (comprising one or more or the electrodes described herein) can be used to provide power to an electric vehicle or otherwise be incorporated into an electric vehicle. As a non-limiting example, electrochemical cells described herein can, in some cases, be used to provide power to a drive train of an electric vehicle. The vehicle may be any suitable vehicle, adapted for travel on land, sea, and/or air. For example, the vehicle may be an automobile, truck, motorcycle, boat, helicopter, airplane, and/or any other suitable type of vehicle.

In some embodiments, an electrochemical cell described herein comprises at least one current collector. For example, referring again to FIG. 1, electrochemical cell 10 comprises a cathode current collector 20 and an anode current collector 22. Materials for the current collector may be selected, in some cases, from metals (e.g., copper, nickel, aluminum, passivated metals, and other appropriate metals), metallized polymers, electrically conductive polymers, polymers comprising conductive particles dispersed therein, and other appropriate materials. In some embodiments, the current collector is deposited onto the electrode layer using physical vapor deposition, chemical vapor deposition, electrochemical deposition, sputtering, doctor blading, flash evaporation, or any other appropriate deposition technique for the selected material. In some cases, the current collector may be formed separately and bonded to the electrode structure. It should be appreciated, however, that in some embodiments a current collector separate from the electroactive layer is not needed or present.

One set of embodiments described herein relate to the formation of electrode slurries, such as electrode slurries which maintain fluid-like properties over the time period between formation of the slurry and application of the slurry to a current collector. These slurries may be easier to process (e.g., easier to mix, easier to apply, easier to apply uniformly) than slurries that do not maintain fluid-like properties (e.g., slurries that have at least a portion that has gelled and/or solidified). The slurry may comprise a particulate electroactive material and a solvent. In some embodiments, the slurry may further comprise a binder and/or one or more additives. The particulate electroactive material within the slurry may have one or more features that tend to promote gelation (e.g., it may have a small average particle size, it may comprise certain amounts of nickel), but still be a component of a slurry with fluid-like properties. In some embodiments, one or more reactive groups present on the surface of the particulate electroactive material (e.g., —OH groups, —COOH groups) may be passivated prior to slurry formation (e.g., by exposure to a second passivating agent as described herein, by exposure to a silane compound).

As used herein, slurries are typically, but not always, materials which comprise at least one liquid component and at least one solid component. The solid component may be at least partially suspended in the liquid and/or at least partially dissolved within the liquid.

As described herein, in some embodiments, an electrochemical cell includes a separator. The separator generally comprises a polymeric material (e.g., polymeric material that does or does not swell upon exposure to electrolyte). In some embodiments, the separator is located between the electrolyte and an electrode (e.g., between the electrolyte and a first electrode, between the electrolyte and a second electrode, between the electrolyte and an anode, or between the electrolyte and a cathode).

In some embodiments, electrochemical cells may further comprise a separator interposed between the cathode and anode. The separator may be a solid non-conductive or insulative material which separates or insulates the anode and the cathode from each other preventing short circuiting, and which permits the transport of ions between the anode and the cathode. In some embodiments, the porous separator may be permeable to the electrolyte.

The pores of the separator may be partially or substantially filled with electrolyte. Separators may be supplied as porous free standing films which are interleaved with the anodes and the cathodes during the fabrication of cells. Alternatively, the porous separator layer may be applied directly to the surface of one of the electrodes, for example, as described in PCT Publication No. WO 99/33125 to Carlson et al. and in U.S. Pat. No. 5,194,341 to Bagley et al.

A separator can be made of a variety of materials. The separator may be polymeric in some instances, or formed of an inorganic material (e.g., glass fiber filter papers) in other instances. Examples of suitable separator materials include, but are not limited to, polyolefins (e.g., polyethylenes, poly(butene-1), poly(n-pentene-2), polypropylene, polytetrafluoroethylene), polyamines (e.g., poly(ethylene imine) and polypropylene imine (PPI)); polyamides (e.g., polyamide (Nylon), poly(ϵ-caprolactam) (Nylon 6), poly(hexamethylene adipamide) (Nylon 66)), polyimides (e.g., polyimide, polynitrile, and poly(pyromellitimide-1,4-diphenyl ether) (Kapton®) (NOMEX®) (KEVLAR®)); polyether ether ketone (PEEK); vinyl polymers (e.g., polyacrylamide, poly(2-vinyl pyridine), poly(N-vinylpyrrolidone), poly(methylcyanoacrylate), poly(ethylcyanoacrylate), poly(butylcyanoacrylate), poly(isobutylcyanoacrylate), poly(vinyl acetate), poly(vinyl alcohol), poly(vinyl chloride), poly(vinyl fluoride), poly(2-vinyl pyridine), vinyl polymer, polychlorotrifluoro ethylene, and poly(isohexylcynaoacrylate)); polyacetals; polyesters (e.g., polycarbonate, polybutylene terephthalate, polyhydroxybutyrate); polyethers (poly(ethylene oxide) (PEO), poly(propylene oxide) (PPO), poly(tetramethylene oxide) (PTMO)); vinylidene polymers (e.g., polyisobutylene, poly(methyl styrene), poly(methylmethacrylate) (PMMA), poly(vinylidene chloride), and poly(vinylidene fluoride)); polyaramides (e.g., poly(imino-1,3-phenylene iminoisophthaloyl) and poly(imino-1,4-phenylene iminoterephthaloyl)); polyheteroaromatic compounds (e.g., polybenzimidazole (PBI), polybenzobisoxazole (PBO) and polybenzobisthiazole (PBT)); polyheterocyclic compounds (e.g., polypyrrole); polyurethanes; phenolic polymers (e.g., phenol-formaldehyde); polyalkynes (e.g., polyacetylene); polydienes (e.g., 1,2-polybutadiene, cis or trans-1,4-polybutadiene); polysiloxanes (e.g., poly(dimethylsiloxane) (PDMS), poly(diethylsiloxane) (PDES), polydiphenylsiloxane (PDPS), and polymethylphenylsiloxane (PMPS)); and inorganic polymers (e.g., polyphosphazene, polyphosphonate, polysilanes, polysilazanes). In some embodiments, the polymer may be selected from poly(n-pentene-2), polypropylene, polytetrafluoroethylene, polyamides (e.g., polyamide (Nylon), poly(ϵ-caprolactam) (Nylon 6), poly(hexamethylene adipamide) (Nylon 66)), polyimides (e.g., polynitrile, and poly(pyromellitimide-1,4-diphenyl ether) (Kapton®) (NOMEX®) (KEVLAR®)), polyether ether ketone (PEEK), and combinations thereof.

A separator can be coated by various materials (e.g. ceramics). In some embodiments, a separator is a ceramic coated separator. Non-limiting examples of ceramic include alumina, boehmite, and/or silica. In some embodiments, a separator comprising a polymeric material described previously (e.g., polyolefin) may be coated by a ceramic described herein.

Liquid electrolyte solvents can also be useful as plasticizers for gel polymer electrolytes, i.e., electrolytes comprising one or more polymers forming a semi-solid network. Examples of useful gel polymer electrolytes include, but are not limited to, those comprising one or more polymers selected from the group consisting of polyethylene oxides, polypropylene oxides, polyacrylonitriles, polysiloxanes, polyimides, polyphosphazenes, polyethers, sulfonated polyimides, perfluorinated membranes (NAFION resins), polydivinyl polyethylene glycols, polyethylene glycol diacrylates, polyethylene glycol dimethacrylates, polysulfones, polyethersulfones, derivatives of the foregoing, copolymers of the foregoing, crosslinked and network structures of the foregoing, and blends of the foregoing, and optionally, one or more plasticizers. In some embodiments, a gel polymer electrolyte comprises between 10-20%, between 20-40%, between 60-70%, between 70-80%, between 80-90%, or between 90-95% of a heterogeneous electrolyte by volume.

In some embodiments, one or more solid polymers can be used to form an electrolyte. Examples of useful solid polymer electrolytes include, but are not limited to, those comprising one or more polymers selected from the group consisting of polyethers, polyethylene oxides, polypropylene oxides, polyimides, polyphosphazenes, polyacrylonitriles, polysiloxanes, derivatives of the foregoing, copolymers of the foregoing, crosslinked and network structures of the foregoing, and blends of the foregoing.

In addition to electrolyte solvents, gelling agents, and polymers as known in the art for forming electrolytes, the electrolyte may further comprise one or more ionic electrolyte salts, also as known in the art, to increase the ionic conductivity.

It can be advantageous, according to some embodiments, to apply an anisotropic force to the electrochemical cells described herein during charge and/or discharge. In some embodiments, the electrochemical cells and/or the electrodes described herein can be configured to withstand an applied anisotropic force (e.g., a force applied to enhance the morphology of an electrode within the cell) while maintaining their structural integrity.

In some embodiments, any of the electrodes described herein can be part of an electrochemical cell that is constructed and arranged such that, during at least one period of time during charge and/or discharge of the cell, an anisotropic force with a component normal to a surface (e.g., an active surface) of an electrode within the electrochemical cell (e.g., an anode comprising lithium metal and/or a lithium alloy) is applied to the cell. In one set of embodiments, the applied anisotropic force can be selected to enhance the morphology of an electrode (e.g., an anode such as a lithium metal and/or a lithium alloy anode).

An “anisotropic force” is given its ordinary meaning in the art and means a force that is not equal in all directions. A force equal in all directions is, for example, internal pressure of a fluid or material within the fluid or material, such as internal gas pressure of an object. Examples of forces not equal in all directions include forces directed in a particular direction, such as the force on a table applied by an object on the table via gravity. Another example of an anisotropic force includes a force applied by a band arranged around a perimeter of an object. For example, a rubber band or turnbuckle can apply forces around a perimeter of an object around which it is wrapped. However, the band may not apply any direct force on any part of the exterior surface of the object not in contact with the band. In addition, when the band is expanded along a first axis to a greater extent than a second axis, the band can apply a larger force in the direction parallel to the first axis than the force applied parallel to the second axis.

In some such cases, the anisotropic force comprises a component normal to a surface (e.g., an active surface) of an electrode within an electrochemical cell. As used herein, the term “active surface” is used to describe a surface of an electrode at which electrochemical reactions may take place. A force with a “component normal” to a surface is given its ordinary meaning as would be understood by those of ordinary skill in the art and includes, for example, a force which at least in part exerts itself in a direction substantially perpendicular to the surface. For example, in the case of a horizontal table with an object resting on the table and affected only by gravity, the object exerts a force essentially completely normal to the surface of the table. If the object is also urged laterally across the horizontal table surface, then it exerts a force on the table which, while not completely perpendicular to the horizontal surface, includes a component normal to the table surface. Those of ordinary skill can understand other examples of these terms, especially as applied within the description of this document. In the case of a curved surface (for example, a concave surface or a convex surface), the component of the anisotropic force that is normal to a surface (e.g., an active surface) of an electrode may correspond to the component normal to a plane that is tangent to the curved surface at the point at which the anisotropic force is applied. The anisotropic force may be applied, in some cases, at one or more pre-determined locations, optionally distributed over the surface (e.g., the active surface) of the anode. In some embodiments, the anisotropic force is applied uniformly over the surface (e.g., the active surface) of the first electrode (e.g., of the anode).

Any of the electrochemical cell properties and/or performance metrics described herein may be achieved, alone or in combination with each other, while an anisotropic force is applied to the electrochemical cell (e.g., during charge and/or discharge of the cell) during charge and/or discharge. In certain embodiments, the anisotropic force applied to the electrode, to the electrochemical cell (e.g., during at least one period of time during charge and/or discharge of the cell) can include a component normal to a surface (e.g., an active surface) of an electrode (e.g., an anode such as a lithium metal and/or lithium alloy anode within the electrochemical cell).

As described herein, in some embodiments, the surface of an anode can be enhanced during cycling (e.g., for lithium, the development of mossy or a rough surface of lithium may be reduced or eliminated) by application of an externally-applied (in some embodiments, uniaxial) pressure. The externally-applied pressure may, in some embodiments, be chosen to be greater than the yield stress of a material forming the anode. For example, for an anode comprising lithium, the cell may be under an externally-applied anisotropic force with a component defining a pressure of at least about 8 kg_{f}/cm², at least about 9 kg_{f}/cm², at least about 10 kg_{f}/cm², at least about 20 kg_{f}/cm², at least about 30 kg_{f}/cm², at least about 40 kg_{f}/cm², or at least about 50 kg_{f}/cm². This is because the yield stress of lithium is around 7-8 kg_{f}/cm². Thus, at pressures (e.g., uniaxial pressures) greater than this value, mossy Li, or any surface roughness at all, may be reduced or suppressed. The lithium surface roughness may mimic the surface that is pressing against it. Accordingly, when cycling under at least about 8 kg_{f}/cm², at least about 9 kg_{f}/cm², at least about 10 kg_{f}/cm², at least about 20 kg_{f}/cm², at least about 30 kg_{f}/cm², at least about 40 kg_{f}/cm², or at least about 50 kg_{f}/cm² of externally-applied pressure, the lithium surface may become smoother with cycling when the pressing surface is smooth. As described herein, the pressing surface may be modified by choosing the appropriate material(s) positioned between the anode and the cathode.

The anisotropic forces applied during charge and/or discharge as described herein may be applied using any method known in the art. In some embodiments, the force may be applied using compression springs. Forces may be applied using other elements (either inside or outside a containment structure) including, but not limited to Belleville washers, machine screws, pneumatic devices, and/or weights, among others. In some cases, cells may be pre-compressed before they are inserted into containment structures, and, upon being inserted to the containment structure, they may expand to produce a net force on the cell. Suitable methods for applying such forces are described in detail, for example, in U.S. Pat. No. 9,105,938, which is incorporated herein by reference in its entirety.

In some embodiments, an electrochemical cell described herein is designed to include a second electrode with an electroactive material (e.g., a cathode active electrode species in a cathode of an electrochemical cell described herein) having a moderate voltage with respect to lithium metal. The voltage of an electroactive material with respect to lithium metal may be measured by first cycling an electrochemical cell comprising the electroactive material and lithium metal at least four times (e.g., 5 times, 6 times, 8 times, 10 times) at a rate of C/5, then discharging the electrochemical cell at a rate of C/5 and measuring the voltage as the cell discharges. The average voltage measured over the discharge process is then determined, and this value is considered to be the voltage with respect to lithium metal. In some embodiments, the electroactive material within the second electrode has a voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

In some embodiments, an electrochemical cell described herein is designed to include a second electrode with an electroactive material (e.g., a cathode active electrode species in a cathode of an electrochemical cell described herein) having a moderate open circuit voltage with respect to lithium metal. The open circuit voltage of an electroactive material with respect to lithium metal may be measured by determining the open circuit voltage of a battery comprising the electroactive material and lithium metal when the battery is charged to half its capacity. This may be accomplished by first determining the capacity of the battery by cycling the battery. The battery can then be charged to half of its measured capacity and allowed to rest for two minutes. After these steps, the open circuit voltage may be measured. In some embodiments, the electroactive material within the second electrode has an open circuit voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has an open circuit voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

Characteristics of electroactive materials (e.g., for a second electrode) other than their voltages and open circuit voltages with respect to lithium may also be relevant in some embodiments. For example, in some embodiments, an electrochemical cell may include a second electrode comprising an electroactive material (e.g., a cathode active electrode species in a cathode of an electrochemical cell described herein) that exhibits one or more plateaus in the value of voltage with respect to lithium as a function of cycle life during charging and/or discharging, and the value of the plateau(s) may be one or more of the values described above in relation to the voltage of the material with respect to lithium metal. As used herein, an electroactive material exhibits a plateau (i.e., a plateau voltage) when it shows a constant or substantially constant voltage (e.g., varying by less than or equal to 10%, or less than or equal to 5%) with respect to lithium during at least some portion of a charging and/or discharging procedure. The voltage at which a plateau occurs for an electroactive material (i.e., a plateau voltage) may be determined by employing the same procedure used to determine the voltage of an electroactive material with respect to lithium metal, evaluating whether any regions consistent with plateaus are observed, and determining the average voltage in those region(s) if present. In some embodiments, the electroactive material within the second electrode has a plateau voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a plateau voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

As another example, the electrochemical cell may include a second electrode comprising an electroactive material that would be suitable for charging to less than 5 V, less than 4.5 V, less than 4 V, or less than 3.5 V under normal operating conditions (e.g., if one were to charge the second electrode to, e.g., 5 V, 4.5 V, 4 V, or 3.5 V or higher, respectively, it would typically be considered an abuse test, would not be recommended by the manufacturer, and/or would present safety concerns).

In some embodiments, one or more of the voltages measured during the charge and/or discharge process in a cell comprising a lithium metal electrode (e.g., maximum voltage, minimum voltage, median voltage, modal voltage) may have one or more of the values described above in relation to the average voltage. In some embodiments, the electroactive material within the second electrode has a maximum voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a maximum voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

In some embodiments, the electroactive material within the second electrode has a minimum voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a minimum voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

In some embodiments, the electroactive material within the second electrode has a median voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a median voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

In some embodiments, the electroactive material within the second electrode has a modal voltage with respect to lithium metal of greater than or equal to 2.8 V, greater than or equal to 3 V, greater than or equal to 3.2 V, greater than or equal to 3.4 V, greater than or equal to 3.6 V, greater than or equal to 3.8 V, greater than or equal to 4.0 V, greater than or equal to 4.2 V, or greater than or equal to 4.4 V. In some embodiments, the electroactive material within the second electrode has a modal voltage with respect to lithium metal of less than or equal to 4.5 V, less than or equal to 4.2 V, less than or equal to 4.0 V, less than or equal to 3.8 V, less than or equal to 3.6 V, less than or equal to 3.4 V, less than or equal to 3.2 V, or less than or equal to 3 V. Combinations of the above-referenced ranges are also possible (e.g., greater than or equal to 2.8 V and less than or equal to 4.5 V). Other ranges are also possible.

In some embodiments, additional layers may be present in the electrochemical cell described herein. In some instances, one or more intervening layers (e.g., ion conductive layer) may be present between the anode 12 and the electrolyte 14 of FIG. 1. In one set of embodiments, the ion conductive layer (e.g., single-ion conductive layer) may have a shape or structure that protects the anode electroactive material layer from one or more undesirable components (within the electrolyte) within the electrochemical cell. In some such embodiments, the anode electroactive material layer may be at least partially encapsulated by the ion conductive layer.

In some embodiments, the ion conductive layer may be formed by any of a variety of appropriate methods and comprise any of a variety of appropriate materials. Some methods relate to forming an ion conductive layer by an aerosol deposition process. Aerosol deposition processes are known in the art and generally comprise depositing (e.g., spraying) particles (e.g., inorganic particles, polymeric particles) at a relatively high velocity on a surface. Aerosol deposition, as described herein, generally results in the collision and/or elastic deformation of at least some of the plurality of particles. In some aspects, aerosol deposition can be carried out under conditions (e.g., using a velocity) sufficient to cause fusion of at least some of the plurality of particles to at least another portion of the plurality of particles. For example, in some embodiments, a plurality of particles is deposited on an electroactive material (and/or any sublayer(s) disposed thereon) at a relative high velocity such that at least a portion of the plurality of particles fuse (e.g., forming the portion and/or sublayer of the protective layer). The velocity required for particle fusion may depend on factors such as the material composition of the particles, the size of the particles, the Young's elastic modulus of the particles, and/or the yield strength of the particles or material forming the particles.

In some embodiments, an ion conductive layer described herein comprises an inorganic material. The inorganic material(s) may comprise a ceramic material (e.g., a glass, a glassy-ceramic material). The inorganic material(s) may be crystalline, amorphous, or partially crystalline and partially amorphous. In some embodiments, the ion conductive layer comprises LiₓMP_{y}S_{z}. For such inorganic materials, x, y, and z may be integers (e.g., integers less than 32) and/or M may comprise Sn, Ge, and/or Si. By way of example, the inorganic material may comprise Li₂₂SiP₂S₁₈, Li₂₄MP₂S₁₉ (e.g., Li₂₄SiP₂S₁₉), LiMP₂S₁₂ (e.g., where M=Sn, Ge, Si), and/or LiSiPS. Even further examples of suitable inorganic materials include garnets, sulfides, phosphates, perovskites, anti-perovskites, other ion conductive inorganic materials and/or mixtures thereof. When LiₓMP_{y}S_{z} particles are employed in an ion conductive layer thereof, they may be formed, for example, by using raw components Li₂S, SiS₂ and P₂S₅ (or alternatively Li₂S, Si, S and P₂S₅).

In some embodiments, an ion conductive layer described herein comprises an oxide, nitride, and/or oxynitride of lithium, aluminum, silicon, zinc, tin, vanadium, zirconium, magnesium, and/or indium, and/or an alloy thereof. Non-limiting examples of suitable oxides include Li₂O, LiO, LiO₂, LiRO₂ where R is a rare earth metal (e.g., lithium lanthanum oxides), lithium titanium oxides, Al₂O₃, ZrO₂, SiO₂, CeO₂, and Al₂TiO₅. Further examples of suitable materials that may be employed include lithium nitrates (e.g., LiNO₃), lithium silicates, lithium borates (e.g., lithium bis(oxalate)borate, lithium difluoro(oxalate)borate), lithium aluminates, lithium oxalates, lithium phosphates (e.g., LiPO₃, Li₃PO₄), lithium phosphorus oxynitrides, lithium silicosulfides, lithium germanosulfides, lithium fluorides (e.g., LiF, LiBF₄, LiAlF₄, LiPF₆, LiAsF₆, LiSbF₆, Li₂SiF₆, LiSO₃F, LiN(SO₂F)₂, LiN(SO₂CF₃)₂), lithium borosulfides, lithium aluminosulfides, lithium phosphosulfides, oxy-sulfides (e.g., lithium oxy-sulfides), and/or combinations thereof. In some embodiments, the plurality of particles comprises Li—Al—Ti—PO₄ (LATP).

In some embodiments, an ion conductive layer described herein comprises a plurality of particles that are at least partially fused together and/or that have a structure indicative of particles deposited by aerosol deposition comprises an inorganic material. For instance, a plurality of particles that are at least partially fused together and/or that have a structure indicative of particles deposited by aerosol deposition may be formed of an inorganic material. In some embodiments, a plurality of particles that are at least partially fused together and/or that have a structure indicative of particles deposited by aerosol deposition comprise two or more types of inorganic materials. The plurality of particles may comprise any appropriate materials described above.

The following applications are incorporated herein by reference, in their entirety, for all purposes: U.S. Publication No. US-2007-0221265-A1 published on Sep. 27, 2007, filed as U.S. application Ser. No. 11/400,781 on Apr. 6, 2006, and entitled “RECHARGEABLE LITHIUM/WATER, LITHIUM/AIR BATTERIES”; U.S. Publication No. US-2009-0035646-A1, published on Feb. 5, 2009, filed as U.S. application Ser. No. 11/888,339 on Jul. 31, 2007, and entitled “SWELLING INHIBITION IN BATTERIES”; U.S. Publication No. US-2010-0129699-A1 published on May 17, 2010, filed as U.S. application Ser. No. 12/312,764 on Feb. 2, 2010; patented as U.S. Pat. No. 8,617,748 on Dec. 31, 2013, and entitled “SEPARATION OF ELECTROLYTES”; U.S. Publication No. US-2010-0291442-A1 published on Nov. 18, 2010, filed as U.S. application Ser. No. 12/682,011 on Jul. 30, 2010, patented as U.S. Pat. No. 8,871,387 on Oct. 28, 2014, and entitled “PRIMER FOR BATTERY ELECTRODE”; U.S. Publication No. US-2009-0200986-A1 published on Aug. 13, 2009, filed as U.S. application Ser. No. 12/069,335 on Feb. 8, 2008, patented as U.S. Pat. No. 8,264,205 on Sep. 11, 2012, and entitled “CIRCUIT FOR CHARGE AND/OR DISCHARGE PROTECTION IN AN ENERGY-STORAGE DEVICE”; U.S. Publication No. US-2007-0224502-A1 published on Sep. 27, 2007, filed as U.S. application Ser. No. 11/400,025 on Apr. 6, 2006, patented as U.S. Pat. No. 7,771,870 on Aug. 10, 2010, and entitled “ELECTRODE PROTECTION IN BOTH AQUEOUS AND NON-AQUEOUS ELECTROCHEMICAL CELLS, INCLUDING RECHARGEABLE LITHIUM BATTERIES”; U.S. Publication No. US-2008-0318128-A1 published on Dec. 25, 2008, filed as U.S. application Ser. No. 11/821,576 on Jun. 22, 2007, and entitled “LITHIUM ALLOY/SULFUR BATTERIES”; U.S. Publication No. US-2002-0055040-A1 published on May 9, 2002, filed as U.S. application Ser. No. 09/795,915 on Feb. 27, 2001, patented as U.S. Pat. No. 7,939,198 on May 10, 2011, and entitled “NOVEL COMPOSITE CATHODES, ELECTROCHEMICAL CELLS COMPRISING NOVEL COMPOSITE CATHODES, AND PROCESSES FOR FABRICATING SAME”; U.S. Publication No. US-2006-0238203-A1 published on Oct. 26, 2006, filed as U.S. application Ser. No. 11/111,262 on Apr. 20, 2005, patented as U.S. Pat. No. 7,688,075 on Mar. 30, 2010, and entitled “LITHIUM SULFUR RECHARGEABLE BATTERY FUEL GAUGE SYSTEMS AND METHODS”; U.S. Publication No. US-2008-0187663-A1 published on Aug. 7, 2008, filed as U.S. application Ser. No. 11/728,197 on Mar. 23, 2007, patented as U.S. Pat. No. 8,084,102 on Dec. 27, 2011, and entitled “METHODS FOR CO-FLASH EVAPORATION OF POLYMERIZABLE MONOMERS AND NON-POLYMERIZABLE CARRIER SOLVENT/SALT MIXTURES/SOLUTIONS”; U.S. Publication No. US-2011-0006738-A1 published on Jan. 13, 2011, filed as U.S. application Ser. No. 12/679,371 on Sep. 23, 2010, and entitled “ELECTROLYTE ADDITIVES FOR LITHIUM BATTERIES AND RELATED METHODS”; U.S. Publication No. US-2011-0008531-A1 published on Jan. 13, 2011, filed as U.S. application Ser. No. 12/811,576 on Sep. 23, 2010, patented as U.S. Pat. No. 9,034,421 on May 19, 2015, and entitled “METHODS OF FORMING ELECTRODES COMPRISING SULFUR AND POROUS MATERIAL COMPRISING CARBON”; U.S. Publication No. US-2010-0035128-A1 published on Feb. 11, 2010, filed as U.S. application Ser. No. 12/535,328 on Aug. 4, 2009, patented as U.S. Pat. No. 9,105,938 on Aug. 11, 2015, and entitled “APPLICATION OF FORCE IN ELECTROCHEMICAL CELLS”; U.S. Publication No. US-2011-0165471-A9 published on Jul. 15, 2011, filed as U.S. application Ser. No. 12/180,379 on Jul. 25, 2008, and entitled “PROTECTION OF ANODES FOR ELECTROCHEMICAL CELLS”; U.S. Publication No. US-2006-0222954-A1 published on Oct. 5, 2006, filed as U.S. application Ser. No. 11/452,445 on Jun. 13, 2006, patented as U.S. Pat. No. 8,415,054 on Apr. 9, 2013, and entitled “LITHIUM ANODES FOR ELECTROCHEMICAL CELLS”; U.S. Publication No. US-2010-0239914-A1 published on Sep. 23, 2010, filed as U.S. application Ser. No. 12/727,862 on Mar. 19, 2010, and entitled “CATHODE FOR LITHIUM BATTERY”; U.S. Publication No. US-2010-0294049-A1 published on Nov. 25, 2010, filed as U.S. application Ser. No. 12/471,095 on May 22, 2009, patented as U.S. Pat. No. 8,087,309 on Jan. 3, 2012, and entitled “HERMETIC SAMPLE HOLDER AND METHOD FOR PERFORMING MICROANALYSIS UNDER CONTROLLED ATMOSPHERE ENVIRONMENT”; U.S. Publication No. US-2011-0076560-A1 published on Mar. 31, 2011, filed as U.S. application Ser. No. 12/862,581 on Aug. 24, 2010, and entitled “ELECTROCHEMICAL CELLS COMPRISING POROUS STRUCTURES COMPRISING SULFUR”; U.S. Publication No. US-2011-0068001-A1 published on Mar. 24, 2011, filed as U.S. application Ser. No. 12/862,513 on Aug. 24, 2010, and entitled “RELEASE SYSTEM FOR ELECTROCHEMICAL CELLS”; U.S. Publication No. US-2012-0048729-A1 published on Mar. 1, 2012, filed as U.S. application Ser. No. 13/216,559 on Aug. 24, 2011, and entitled “ELECTRICALLY NON-CONDUCTIVE MATERIALS FOR ELECTROCHEMICAL CELLS”; U.S. Publication No. US-2011-0177398-A1 published on Jul. 21, 2011, filed as U.S. application Ser. No. 12/862,528 on Aug. 24, 2010, patented as U.S. Pat. No. 10,629,947 on Apr. 21, 2020, and entitled “ELECTROCHEMICAL CELL”; U.S. Publication No. US-2011-0070494-A1 published on Mar. 24, 2011, filed as U.S. application Ser. No. 12/862,563 on Aug. 24, 2010, and entitled “ELECTROCHEMICAL CELLS COMPRISING POROUS STRUCTURES COMPRISING SULFUR”; U.S. Publication No. US-2011-0070491-A1 published on Mar. 24, 2011, filed as U.S. application Ser. No. 12/862,551 on Aug. 24, 2010, and entitled “ELECTROCHEMICAL CELLS COMPRISING POROUS STRUCTURES COMPRISING SULFUR”; U.S. Publication No. US-2011-0059361-A1 published on Mar. 10, 2011, filed as U.S. application Ser. No. 12/862,576 on Aug. 24, 2010, patented as U.S. Pat. No. 9,005,809 on Apr. 14, 2015, and entitled “ELECTROCHEMICAL CELLS COMPRISING POROUS STRUCTURES COMPRISING SULFUR”; U.S. Publication No. US-2012-0052339-A1 published on Mar. 1, 2012, filed as U.S. application Ser. No. 13/216,579 on Aug. 24, 2011, and entitled “ELECTROLYTE MATERIALS FOR USE IN ELECTROCHEMICAL CELLS”; U.S. Publication No. US-2012-0070746-A1 published on Mar. 22, 2012, filed as U.S. application Ser. No. 13/240,113 on Sep. 22, 2011, and entitled “LOW ELECTROLYTE ELECTROCHEMICAL CELLS”; U.S. Publication No. US-2011-0206992-A1 published on Aug. 25, 2011, filed as U.S. application Ser. No. 13/033,419 on Feb. 23, 2011, and entitled “POROUS STRUCTURES FOR ENERGY STORAGE DEVICES”; U.S. Publication No. US-2012-0082872-A1 published on Apr. 5, 2012, filed as U.S. application Ser. No. 13/249,605 on Sep. 30, 2011, and entitled “ADDITIVE FOR ELECTROLYTES”; U.S. Publication No. US-2012-0082901-A1 published on Apr. 5, 2012, filed as U.S. application Ser. No. 13/249,632 on Sep. 30, 2011, and entitled “LITHIUM-BASED ANODE WITH IONIC LIQUID POLYMER GEL”; U.S. Publication No. US-2013-0164635-A1 published on Jun. 27, 2013, filed as U.S. application Ser. No. 13/700,696 on Mar. 6, 2013, patented as U.S. Pat. No. 9,577,243 on Feb. 21, 2017, and entitled “USE OF EXPANDED GRAPHITE IN LITHIUM/SULPHUR BATTERIES”; U.S. Publication No. US-2013-0017441-A1 published on Jan. 17, 2013, filed as U.S. application Ser. No. 13/524,662 on Jun. 15, 2012, patented as U.S. Pat. No. 9,548,492 on Jan. 17, 2017, and entitled “PLATING TECHNIQUE FOR ELECTRODE”; U.S. Publication No. US-2013-0224601-A1 published on Aug. 29, 2013, filed as U.S. application Ser. No. 13/766,862 on Feb. 14, 2013, patented as U.S. Pat. No. 9,077,041 on Jul. 7, 2015, and entitled “ELECTRODE STRUCTURE FOR ELECTROCHEMICAL CELL”; U.S. Publication No. US-2013-0252103-A1 published on Sep. 26, 2013, filed as U.S. application Ser. No. 13/789,783 on Mar. 8, 2013, patented as U.S. Pat. No. 9,214,678 on Dec. 15, 2015, and entitled “POROUS SUPPORT STRUCTURES, ELECTRODES CONTAINING SAME, AND ASSOCIATED METHODS”; U.S. Publication No. US-2015-0287998-A1 published on Oct. 8, 2015, filed as U.S. application Ser. No. 14/743,304 on Jun. 18, 2015, patented as U.S. Pat. No. 9,577,267 on Feb. 21, 2017, and entitled “ELECTRODE STRUCTURE AND METHOD FOR MAKING SAME”; U.S. Publication No. US-2013-0095380-A1 published on Apr. 18, 2013, filed as U.S. application Ser. No. 13/644,933 on Oct. 4, 2012, patented as U.S. Pat. No. 8,936,870 on Jan. 20, 2015, and entitled “ELECTRODE STRUCTURE AND METHOD FOR MAKING THE SAME”; U.S. Publication No. US-2012-0052397-A1 published on Mar. 1, 2012, filed as U.S. application Ser. No. 13/216,538 on Aug. 24, 2011, patented as U.S. Pat. No. 9,853,287 on Dec. 26, 2017, and entitled “ELECTROLYTE MATERIALS FOR USE IN ELECTROCHEMICAL CELLS”; U.S. Publication No. US-2014-0123477-A1 published on May 8, 2014, filed as U.S. application Ser. No. 14/069,698 on Nov. 1, 2013, patented as U.S. Pat. No. 9,005,311 on Apr. 14, 2015, and entitled “ELECTRODE ACTIVE SURFACE PRETREATMENT”; U.S. Publication No. US-2014-0193723-A1 published on Jul. 10, 2014, filed as U.S. application Ser. No. 14/150,156 on Jan. 8, 2014, patented as U.S. Pat. No. 9,559,348 on Jan. 31, 2017, and entitled “CONDUCTIVITY CONTROL IN ELECTROCHEMICAL CELLS”; U.S. Publication No. US-2014-0255780-A1 published on Sep. 11, 2014, filed as U.S. application Ser. No. 14/197,782 on Mar. 5, 2014, patented as U.S. Pat. No. 9,490,478 on Nov. 8, 2016, and entitled “ELECTROCHEMICAL CELLS COMPRISING FIBRIL MATERIALS”; U.S. Publication No. US-2014-0272594-A1 published on Sep. 18, 2014, filed as U.S. application Ser. No. 13/833,377 on Mar. 15, 2013, and entitled “PROTECTIVE STRUCTURES FOR ELECTRODES”; U.S. Publication No. US-2014-0272597-A1 published on Sep. 18, 2014, filed as U.S. application Ser. No. 14/209,274 on Mar. 13, 2014, patented as U.S. Pat. No. 9,728,768 on Aug. 8, 2017, and entitled “PROTECTED ELECTRODE STRUCTURES AND METHODS”; U.S. Publication No. US-2015-0280277-A1 published on Oct. 1, 2015, filed as U.S. application Ser. No. 14/668,102 on Mar. 25, 2015, patented as U.S. Pat. No. 9,755,268 on Sep. 5, 2017, and entitled “GEL ELECTROLYTES AND ELECTRODES”; U.S. Publication No. US-2015-0180037-A1 published on Jun. 25, 2015, filed as U.S. application Ser. No. 14/576,570 on Dec. 19, 2014, patented as U.S. Pat. No. 10,020,512 on Jul. 10, 2018, and entitled “POLYMER FOR USE AS PROTECTIVE LAYERS AND OTHER COMPONENTS IN ELECTROCHEMICAL CELLS”; U.S. Publication No. US-2015-0349310-A1 published on Dec. 3, 2015, filed as U.S. application Ser. No. 14/723,132 on May 27, 2015, patented as U.S. Pat. No. 9,735,411 on Aug. 15, 2017, and entitled “POLYMER FOR USE AS PROTECTIVE LAYERS AND OTHER COMPONENTS IN ELECTROCHEMICAL CELLS”; U.S. Publication No. US-2014-0272595-A1 published on Sep. 18, 2014, filed as U.S. application Ser. No. 14/203,802 on Mar. 11, 2014, and entitled “COMPOSITIONS FOR USE AS PROTECTIVE LAYERS AND OTHER COMPONENTS IN ELECTROCHEMICAL CELLS”; U.S. Publication No. US-2019-0006699-A1 published on Jan. 3, 2019, filed as U.S. application Ser. No. 15/727,438 on Oct. 6, 2017, and entitled “PRESSURE AND/OR TEMPERATURE MANAGEMENT IN ELECTROCHEMICAL SYSTEMS”; U.S. Publication No. US-2014-0193713-A1 published on Jul. 10, 2014, filed as U.S. application Ser. No. 14/150,196 on Jan. 8, 2014, patented as U.S. Pat. No. 9,531,009 on Dec. 27, 2016, and entitled “PASSIVATION OF ELECTRODES IN ELECTROCHEMICAL CELLS”; U.S. Publication No. US-2014-0127577-A1 published on May 8, 2014, filed as U.S. application Ser. No. 14/068,333 on Oct. 31, 2013, patented as U.S. Pat. No. 10,243,202 on Mar. 26, 2019, and entitled “POLYMERS FOR USE AS PROTECTIVE LAYERS AND OTHER COMPONENTS IN ELECTROCHEMICAL CELLS”; U.S. Publication No. US-2015-0318539-A1 published on Nov. 5, 2015, filed as U.S. application Ser. No. 14/700,258 on Apr. 30, 2015, patented as U.S. Pat. No. 9,711,784 on Jul. 18, 2017, and entitled “ELECTRODE FABRICATION METHODS AND ASSOCIATED SYSTEMS AND ARTICLES”; U.S. Publication No. US-2014-0272565-A1 published on Sep. 18, 2014, filed as U.S. application Ser. No. 14/209,396 on Mar. 13, 2014, patented as U.S. Pat. No. 10,862,105 on Dec. 8, 2020 and entitled “PROTECTED ELECTRODE STRUCTURES”; U.S. Publication No. US-2015-0010804-A1 published on Jan. 8, 2015, filed as U.S. application Ser. No. 14/323,269 on Jul. 3, 2014, patented as U.S. Pat. No. 9,994,959 on Jun. 12, 2018, and entitled “CERAMIC/POLYMER MATRIX FOR ELECTRODE PROTECTION IN ELECTROCHEMICAL CELLS, INCLUDING RECHARGEABLE LITHIUM BATTERIES”; U.S. Publication No. US-2015-0162586-A1 published on Jun. 11, 2015, filed as U.S. application Ser. No. 14/561,305 on Dec. 5, 2014, and entitled “NEW SEPARATOR”; U.S. Publication No. US-2015-0044517-A1 published on Feb. 12, 2015, filed as U.S. application Ser. No. 14/455,230 on Aug. 8, 2014, patented as U.S. Pat. No. 10,020,479 on Jul. 10, 2018, and entitled “SELF-HEALING ELECTRODE PROTECTION IN ELECTROCHEMICAL CELLS”; U.S. Publication No. US-2015-0236322-A1 published on Aug. 20, 2015, filed as U.S. application Ser. No. 14/184,037 on Feb. 19, 2014, patented as U.S. Pat. No. 10,490,796 on Nov. 26, 2019, and entitled “ELECTRODE PROTECTION USING ELECTROLYTE-INHIBITING ION CONDUCTOR”; U.S. Publication No. US-2015-0236320-A1 published on Aug. 20, 2015, filed as U.S. application Ser. No. 14/624,641 on Feb. 18, 2015, patented as U.S. Pat. No. 9,653,750 on May 16, 2017, and entitled “ELECTRODE PROTECTION USING A COMPOSITE COMPRISING AN ELECTROLYTE-INHIBITING ION CONDUCTOR”; U.S. Publication No. US-2016-0118638-A1 published on Apr. 28, 2016, filed as U.S. application Ser. No. 14/921,381 on Oct. 23, 2015, and entitled “COMPOSITIONS FOR USE AS PROTECTIVE LAYERS AND OTHER COMPONENTS IN ELECTROCHEMICAL CELLS”; U.S. Publication No. US-2016-0118651-A1 published on Apr. 28, 2016, filed as U.S. application Ser. No. 14/918,672 on Oct. 21, 2015, and entitled “ION-CONDUCTIVE COMPOSITE FOR ELECTROCHEMICAL CELLS”; U.S. Publication No. US-2016-0072132-A1 published on Mar. 10, 2016, filed as U.S. application Ser. No. 14/848,659 on Sep. 9, 2015, patented as U.S. Pat. No. 11,038,178 on Jun. 15, 2021 and entitled “PROTECTIVE LAYERS IN LITHIUM-ION ELECTROCHEMICAL CELLS AND ASSOCIATED ELECTRODES AND METHODS”; U.S. Publication No. US-2018-0138542-A1 published on May 17, 2018, filed as U.S. application Ser. No. 15/567,534 on Oct. 18, 2017, patented as U.S. Pat. No. 10,847,833 on Nov. 24, 2020 and entitled “GLASS-CERAMIC ELECTROLYTES FOR LITHIUM-SULFUR BATTERIES”; U.S. Publication No. US-2016-0344067-A1 published on Nov. 24, 2016, filed as U.S. application Ser. No. 15/160,191 on May 20, 2016, patented as U.S. Pat. No. 10,461,372 on Oct. 29, 2019, and entitled “PROTECTIVE LAYERS FOR ELECTROCHEMICAL CELLS”; U.S. Publication No. US-2020-0099108-A1 published on Mar. 26, 2020, filed as U.S. application Ser. No. 16/587,939 on Sep. 30, 2019, and entitled “PROTECTIVE LAYERS FOR ELECTROCHEMICAL CELLS”; U.S. Publication No. US-2017-0141385-A1 published on May 18, 2017, filed as U.S. application Ser. No. 15/343,890 on Nov. 4, 2016, and entitled “LAYER COMPOSITE AND ELECTRODE HAVING A SMOOTH SURFACE, AND ASSOCIATED METHODS”; U.S. Publication No. US-2017-0141442-A1 published on May 18, 2017, filed as U.S. application Ser. No. 15/349,140 on Nov. 11, 2016, and entitled “ADDITIVES FOR ELECTROCHEMICAL CELLS”; patented as U.S. patent Ser. No. 10/320,031 on Jun. 11, 2019, and entitled “ADDITIVES FOR ELECTROCHEMICAL CELLS”; U.S. Publication No. US-2017-0149086-A1 published on May 25, 2017, filed as U.S. application Ser. No. 15/343,635 on Nov. 4, 2016, patented as U.S. Pat. No. 9,825,328 on Nov. 21, 2017, and entitled “IONICALLY CONDUCTIVE COMPOUNDS AND RELATED USES”; U.S. Publication No. US-2018-0337406-A1 published on Nov. 22, 2018, filed as U.S. application Ser. No. 15/983,352 on May 18, 2018, patented as U.S. Pat. No. 10,868,306 on Dec. 15, 2020 and entitled “PASSIVATING AGENTS FOR ELECTROCHEMICAL CELLS”; U.S. Publication No. US-2018-0261820-A1 published on Sep. 13, 2018, filed as U.S. application Ser. No. 15/916,588 on Mar. 9, 2018, patented as U.S. Pat. No. 11,024,923 on Jun. 1, 2021 and entitled “ELECTROCHEMICAL CELLS COMPRISING SHORT-CIRCUIT RESISTANT ELECTRONICALLY INSULATING REGIONS”; U.S. Publication No. US-2020-0243824-A1 published on Jul. 30, 2020, filed as U.S. application Ser. No. 16/098,654 on Nov. 2, 2018, patented as U.S. Pat. No. 10,991,925 on Apr. 27, 2021 and entitled “COATINGS FOR COMPONENTS OF ELECTROCHEMICAL CELLS”; U.S. Publication No. US-2018-0351158-A1 published on Dec. 6, 2018, filed as U.S. application Ser. No. 15/983,363 on May 18, 2018, patented as U.S. Pat. No. 10,944,094 on Mar. 9, 2021 and entitled “PASSIVATING AGENTS FOR ELECTROCHEMICAL CELLS”; U.S. Publication No. US-2018-0277850-A1 published on Sep. 27, 2018, filed as U.S. application Ser. No. 15/923,342 on Mar. 16, 2018, and patented as U.S. Pat. No. 10,720,648 on Jul. 21, 2020, and entitled “ELECTRODE EDGE PROTECTION IN ELECTROCHEMICAL CELLS”; U.S. Publication No. US-2018-0358651-A1 published on Dec. 13, 2018, filed as U.S. application Ser. No. 16/002,097 on Jun. 7, 2018, and patented as U.S. Pat. No. 10,608,278 on Mar. 31, 2020, and entitled “IN SITU CURRENT COLLECTOR”; U.S. Publication No. US-2017-0338475-A1 published on Nov. 23, 2017, filed as U.S. application Ser. No. 15/599,595 on May 19, 2017, patented as U.S. Pat. No. 10,879,527 on Dec. 29, 2020, and entitled “PROTECTIVE LAYERS FOR ELECTRODES AND ELECTROCHEMICAL CELLS”; U.S. Publication No. US-2019-0088958-A1 published on Mar. 21, 2019, filed as U.S. application Ser. No. 16/124,384 on Sep. 7, 2018, and entitled “PROTECTIVE MEMBRANE FOR ELECTROCHEMICAL CELLS”; U.S. Publication No. US-2019-0348672-A1 published on Nov. 14, 2019, filed as U.S. application Ser. No. 16/470,708 on Jun. 18, 2019. patented as U.S. Pat. No. 11,183,690 on Nov. 23, 2021, and entitled “PROTECTIVE LAYERS COMPRISING METALS FOR ELECTROCHEMICAL CELLS”; U.S. Publication No. US-2017-0200975-A1 published Jul. 13, 2017, filed as U.S. application Ser. No. 15/429,439 on Feb. 10, 2017, and patented as U.S. Pat. No. 10,050,308 on Aug. 14, 2018, and entitled “LITHIUM-ION ELECTROCHEMICAL CELL, COMPONENTS THEREOF, AND METHODS OF MAKING AND USING SAME”; U.S. Publication No. US-2018-0351148-A1 published Dec. 6, 2018, filed as U.S. application Ser. No. 15/988,182 on May 24, 2018, patented as U.S. Pat. No. 11,251,501 on Feb. 15, 2022, and entitled “IONICALLY CONDUCTIVE COMPOUNDS AND RELATED USES”; U.S. Publication No. US-2018-0254516-A1 published Sep. 6, 2018, filed as U.S. application Ser. No. 15/765,362 on Apr. 2, 2018, and entitled “NON-AQUEOUS ELECTROLYTES FOR HIGH ENERGY LITHIUM-ION BATTERIES”; U.S. Publication No. US-2020-0044460-A1 published Feb. 6, 2020, filed as U.S. application Ser. No. 16,527,903 on Jul. 31, 2019, and entitled “MULTIPLEXED CHARGE DISCHARGE BATTERY MANAGEMENT SYSTEM”; U.S. Publication No. US-2020-0220146-A1 published Jul. 9, 2020, filed as U.S. application Ser. No. 16/724,586 on Dec. 23, 2019, and entitled “ISOLATABLE ELECTRODES AND ASSOCIATED ARTICLES AND METHODS”; U.S. Publication No. US-2020-0220149-A1 published Jul. 9, 2020, filed as U.S. application Ser. No. 16/724,596 on Dec. 23, 2019, and entitled “ELECTRODES, HEATERS, SENSORS, AND ASSOCIATED ARTICLES AND METHODS”; U.S. Publication No. US-2020-0220197-A1 published Jul. 9, 2020, filed as U.S. application Ser. No. 16/724,612 on Dec. 23, 2019, and entitled “FOLDED ELECTROCHEMICAL DEVICES AND ASSOCIATED METHODS AND SYSTEMS”, U.S. Publication No. US-2020-0373578-A1 published Nov. 26, 2020, filed as U.S. application Ser. No. 16/879,861 on May 21, 2020, and entitled “ELECTROCHEMICAL DEVICES INCLUDING POROUS LAYERS”, U.S. Publication No. US-2020-0373551-A1 published Nov. 26, 2020, filed as U.S. application Ser. No. 16/879,839 on May 21, 2020, and entitled “ELECTRICALLY COUPLED ELECTRODES, AND ASSOCIATED ARTICLES AND METHODS”, U.S. Publication No. US-2020-0395585-A1 published Dec. 17, 2020, filed as U.S. application Ser. No. 16/057,050 on Aug. 7, 2018, and entitled “LITHIUM-COATED SEPARATORS AND ELECTROCHEMICAL CELLS COMPRISING THE SAME”, U.S. Publication No. US-2021-0057753-A1 published Feb. 25, 2021, filed as U.S. application Ser. No. 16/994,006 on Aug. 14, 2020, and entitled “ELECTROCHEMICAL CELLS AND COMPONENTS COMPRISING THIOL GROUP-CONTAINING SPECIES”, U.S. Publication No. US-2021-0135297-A1 published on May 6, 2021, filed as U.S. application Ser. No. 16/670,905 on Oct. 31, 2019, and entitled SYSTEM AND METHOD FOR OPERATING A RECHARGEABLE ELECTROCHEMICAL CELL OR BATTERY”, U.S. Publication No. US-2021-0138673-A1 published on May 13, 2021, filed as U.S. application Ser. No. 17/089,092 on Nov. 4, 2020, and entitled “ELECTRODE CUTTING INSTRUMENT”, U.S. Publication No. US-2021-0135294-A1 published on May 6, 2021, filed as U.S. application Ser. No. 16/670,933 on Oct. 31, 2019, patented as U.S. Pat. No. 11,056,728 on Jul. 6, 2021 and entitled “SYSTEM AND METHOD FOR OPERATING A RECHARGEABLE ELECTROCHEMICAL CELL OR BATTERY”; U.S. Publication No. US-2021-0151839-A1 published on May 20, 2021, filed as U.S. application Ser. No. 16/952,177 on Nov. 19, 2020, and entitled “BATTERIES, AND ASSOCIATED SYSTEMS AND METHODS”; U.S. Publication No. US-2021-0151830-A1 published on May 20, 2021, filed as U.S. application Ser. No. 16/952,235 on Nov. 19, 2020, and entitled “BATTERIES WITH COMPONENTS INCLUDING CARBON FIBER, AND ASSOCIATED SYSTEMS AND METHODS”; U.S. Publication No. US-2021-0151817-A1 published on May 20, 2021, filed as U.S. application Ser. No. 16/952,228 on Nov. 19, 2020, and entitled “BATTERY ALIGNMENT, AND ASSOCIATED SYSTEMS AND METHODS”; U.S. Publication No. US-2021-0151841-A1 published on May 20, 2021, filed as U.S. application Ser. No. 16/952,240 on Nov. 19, 2020, and entitled “SYSTEMS AND METHODS FOR APPLYING AND MAINTAINING COMPRESSION PRESSURE ON ELECTROCHEMICAL CELLS”; U.S. Publication No. US-2021-0151816-A1 published on May 20, 2021, filed as U.S. application Ser. No. 16/952,223 on Nov. 19, 2020, and entitled “THERMALLY INSULATING COMPRESSIBLE COMPONENTS FOR BATTERY PACKS”; U.S. Publication No. US-2021-0151840-A1 published on May 20, 2021, filed as U.S. application Ser. No. 16/952,187 on Nov. 19, 2020, and entitled “COMPRESSION SYSTEMS FOR BATTERIES”; U.S. Publication No. US-2021-0193984-A1 published on Jun. 24, 2021, filed as U.S. application Ser. No. 17/125,124 on Dec. 17, 2020, and entitled “SYSTEMS AND METHODS FOR FABRICATING LITHIUM METAL ELECTRODES”; U.S. Publication No. US-2021-0193985-A1 published on Jun. 24, 2021, filed as U.S. application Ser. No. 17/125,110 on Dec. 17, 2020, and entitled “LITHIUM METAL ELECTRODES AND METHODS”; U.S. Publication No. US-2021-0193996-A1 published on Jun. 24, 2021, filed as U.S. application Ser. No. 17/125,070 on Dec. 17, 2020, and entitled “LITHIUM METAL ELECTRODES”; U.S. Publication No. US-2021-0194069-A1 published on Jun. 24, 2021, filed as U.S. application Ser. No. 17/126,390 on Dec. 18, 2020, and entitled “SYSTEMS AND METHODS FOR PROVIDING, ASSEMBLING, AND MANAGING INTEGRATED POWER BUS FOR RECHARGEABLE ELECTROCHEMICAL CELL OR BATTERY”; U.S. Publication No. US-2021-0218243 published on Jul. 15, 2021, filed as U.S. application Ser. No. 17/126,424 on Dec. 18, 2020, and entitled “SYSTEMS AND METHODS FOR PROTECTING A CIRCUIT, RECHARGEABLE ELECTROCHEMICAL CELL, OR BATTERY”; U.S. Publication No. 2022-0069593 published on Mar. 3, 2022, filed as U.S. application Ser. No. 17/463,467 filed on Aug. 31, 2021, and entitled “Multiplexed Battery Management System”; U.S. Publication No. 2022-0048121 published on Feb. 17, 2022, filed as U.S. application Ser. No. 17/397,114 filed on Aug. 9, 2021, and entitled “Ultrasonic Blade for Cutting a Metal”.

### EXAMPLES

In the following examples and comparative examples, the cells were prepared by the following methods: the anode was either vacuum deposited Li (VDLi) (thickness approximately 15-25 μm) positioned on a 200 nm Cu as current collector disposed on a polyethylene terephthalate (PET) substrate, or commercially available Li foil (2 mil) from Rockwood Lithium (thickness is 1 mil/cathode). VDLi had different degree of passivation by CO₂, denoted as HP VDLi or LP VDLi. The degree of passivation was indicated by the lightness of the lithium appearance measured by Konica Minolta Color Reader CR-10 Plus 1001575, the L color space. In general, Li was considered heavily passivated and denoted as HP VDLi if L was less than 40; Li was considered as less passivated and denoted as LP VDLI if L was greater than 60. It was considered as regular passivated Li if L color space was within 40-60, and denoted as VDLi.

The porous separator used was either 25 μm polyolefin (Celgard 2325), or 9 μm polyethylene (Entek EP) and the cathode used included NCM622, NCM721, or NCM811 coated on 12-20 μm aluminum substrate with ACM loading of approximately 19.3-22 mg/cm²/side. The above components were assembled in a stacked three-layer structure of anode/separator/cathode/separator/anode. The total active cathode surface area was 100 cm². After sealing the cell components in a foil pouch, 0.5 mL to 0.55 mL of the appropriate electrolytes was added. The cell package was then vacuum sealed. These cells were soaked in the electrolyte for 24-72 hours unrestrained and then 10-12 kg/cm² pressure was applied. All the cells were cycled under such pressure except otherwise noted. All cells were cycled at 4.35 V charge voltage cut-off at ˜C/12 (30 mA), tapered down to 3 mA, and discharged at C/3 (120 mA) rate during the first three formation cycles unless otherwise noted. Subsequent charge and discharge cycles were performed under the following condition unless otherwise noted: 0.2 C (75 mA) charge to 4.35V, followed by taper at 4.35V to 3 mA; and 0.8 C (300 mA) discharge to 3.2V.

Specific protocols used for measuring discharge capacity of the electrochemical cell in the following examples and comparative examples during cycling are as follows. First, the cell was connected to a battery cycler channel (such as Maccor, Arbin or Bitrode) capable of delivering the manufacturer specified current and voltage. The cell was first discharged at the recommended current (e.g., C-rate) to the recommended voltage (e.g., 3.2V), then rested for 5 minutes. The cell was then charged at the recommended current (e.g., C/4) to the recommended voltage (e.g., 4.35V), where voltage was kept at the recommended voltage (e.g., 4.35V) until the current decayed to a particular value (e.g., C/20), and the cell was rested again for 5 minutes. A voltage at rest (V₁) was measured at the end of this 5 minute rest. The cell was then discharged again at the recommended current (e.g., C-rate) to the recommended voltage (e.g., 3.2V). A voltage (V₂) was measured 5 minutes into this discharge.

A discharge capacity C can be calculated by multiplying the current I_{dch} by the time t it takes to reach the discharge voltage cutoff, according to Eq. (1), reproduced below:

C=I_{dch}·t

A discharge resistance R (e.g., 5 min discharge resistance), can be calculated using Eq. (2), reproduced below:

R=(V₂−V₁)/I_{dch}

where V₁ is the voltage at the end of the rest prior to the discharge, V₂ is the voltage measured after 5 min into discharge, and I_{dch} is the discharge current (A). As the cycling continued according to protocols described in the preceding paragraph, the discharge capacity and discharge resistance were calculated for each subsequent cycle. All cells were cycled at room temperature unless otherwise stated.

### Examples 1-5 and Comparative Examples 1-5

These examples and comparative examples compare the cycle life of cells comprising a LiF rich SEI layer formed under pressure application to otherwise equivalent cells without pressure application.

In the following examples and comparative examples, the cells were prepared, assembled, and cycled by the methods described previously. Specifically, the anode was vacuum deposited Li (HP VDLi) (thickness approximately 15-25 μm) positioned on a 200 nm Cu as current collector disposed on a polyethylene terephthalate (PET) substrate. The cathode used was NCM811 coated on 12-20 μm aluminum substrate with ACM loading of approximately 19.3-22 mg/cm²/side. The specific components and properties of the cells are tabulated in Table 1.

Comparative Example 1: The above cell was prepared with an electrolyte containing 1M of LiPF₆ in an electrolyte solvent mixture of 1:1.5:1.5 weight ratio of fluoroethylene carbonate (FEC):dimethyl carbonate (DMC):ethyl methyl carbonate (EMC). The electrolyte solvent mixture further contained 1 wt % of LiBOB. The cell was not cycled under pressure application.

Comparative Example 2: The above cell was prepared with an electrolyte containing 1M of LiPF₆ in an electrolyte solvent mixture of 1:2:1 weight ratio of fluoroethylene carbonate (FEC):dimethyl carbonate (DMC):methyl acetate (MA). The electrolyte solvent mixture further contained 1 wt % of LiBOB. The cell was not cycled under pressure application.

Comparative Example 3: The above cell was prepared with an electrolyte containing 1M of LiPF₆ in an electrolyte solvent mixture of 1:2:1 weight ratio of fluoroethylene carbonate (FEC):ethyl methyl carbonate (EMC):methyl acetate (MA). The electrolyte solvent mixture further contained 1 wt % of LiBOB. The cell was not cycled under pressure application.

Comparative Example 4: The above cell was prepared with an electrolyte containing 1M of LiPF₆ in an electrolyte solvent mixture of 1:2:1 weight ratio of fluoroethylene carbonate (FEC):dimethyl carbonate (DMC):ethyl acetate (EA). The electrolyte solvent mixture further contained 1 wt % of LiBOB. The cell was not cycled under pressure application.

Comparative Example 5: The above cell was prepared with an electrolyte containing 1M of LiPF₆ in an electrolyte solvent mixture of 1:3 weight ratio of fluoroethylene carbonate (FEC):dimethyl carbonate (DMC). The electrolyte solvent mixture further contained 1 wt % of LiBOB. The cell was not cycled under pressure application.

Example 1: The electrochemical cell was identical to the cell of Comparative Example 1, except that the cell in Example 1 was cycled under pressure application.

Example 2: The electrochemical cell was identical to the cell of Comparative Example 2, except that the cell in Example 2 was cycled under pressure application.

Example 3: The electrochemical cell was identical to the cell of Comparative Example 3, except that the cell in Example 3 was cycled under pressure application.

Example 4: The electrochemical cell was identical to the cell of Comparative Example 4, except that the cell in Example 4 was cycled under pressure application.

Example 5: The electrochemical cell was identical to the cell of Comparative Example 5, except that the cell in Example 5 was cycled under pressure application.

TABLE 1

| | Li | | | Pressure | Formation Voltage | Inorganic | | No. of cycles to |
|---|---|---|---|---|---|---|---|---|
| Example | Anode | Cathode | Electrolyte | Application | Cut-off (V) | rich SEI | Additive | 80% capacity |
| Comparative | HP | NCM | FEC:DMC:EM | No | 4.35 | LiF | LiBOB | 50 |
| Example 1 | VDLI | 811 | (1:1.5:1.5) | | | | | |
| Comparative | HP | NCM | FEC:DMC:MA | No | 4.35 | LiF | LiBOB | 26 |
| Example 2 | VDLI | 811 | (1:2:1) | | | | | |
| Comparative | HP | NCM | FEC:EMC:MA | No | 4.35 | LiF | LiBOB | 21 |
| Example 3 | VDLI | 811 | (1:2:1) | | | | | |
| Comparative | HP | NCM | FEC:DMC:EA | No | 4.35 | LiF | LiBOB | 20 |
| Example 4 | VDLI | 811 | (1:2:1) | | | | | |
| Comparative | HP | NCM | FEC:DMC | No | 4.35 | LiF | LiBOB | 21 |
| Example 5 | VDLI | 811 | (1:3) | | | | | |
| Example 1 | HP | NCM | FEC:DMC:EM | Yes | 4.35 | LiF | LiBOB | 239 |
| | VDLI | 811 | (1:1.5:1.5) | | | | | |
| Example 2 | HP | NCM | FEC:DMC:MA | Yes | 4.35 | LiF | LiBOB | 277 |
| | VDLI | 811 | (1:2:1) | | | | | |
| Example 3 | HP | NCM | FEC:EMC:MA | Yes | 4.35 | LiF | LiBOB | 247 |
| | VDLI | 811 | (1:2:1) | | | | | |
| Example 4 | HP | NCM | FEC:DMC:EA | Yes | 4.35 | LiF | LiBOB | 225 |
| | VDLI | 811 | (1:2:1) | | | | | |
| Example 5 | HP | NCM | FEC:DMC | Yes | 4.35 | LiF | LiBOB | 259 |
| | VDLI | 811 | (1:3) | | | | | |

### Effect of Pressure Application on Cycle Life

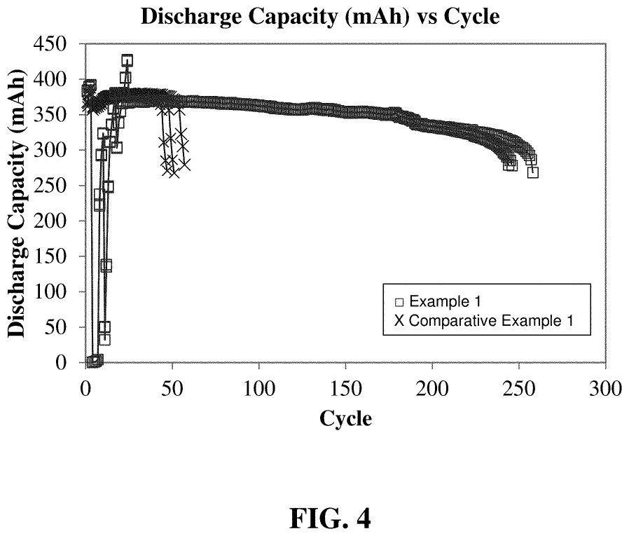

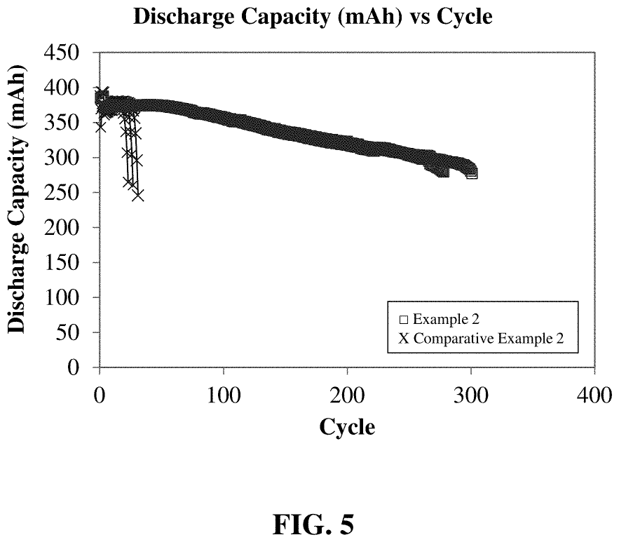

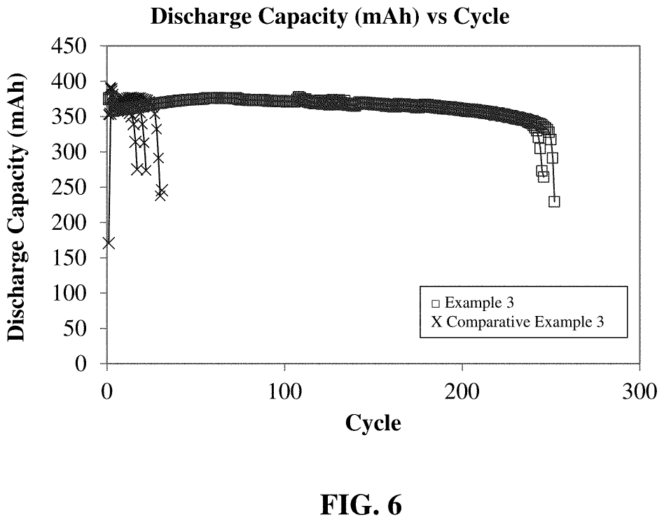

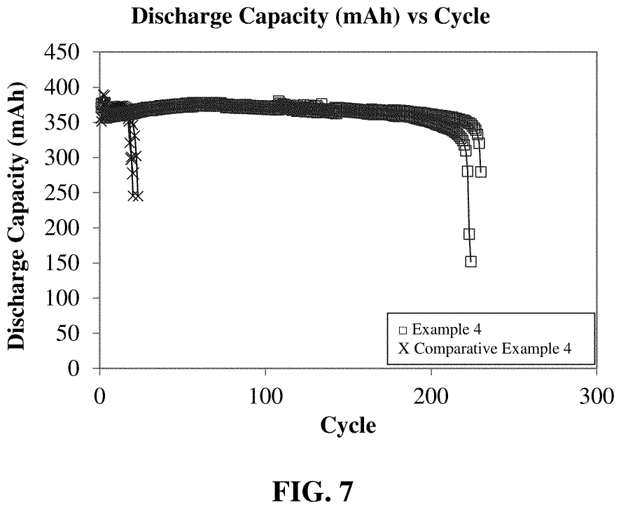

The application of pressure on cycle life of electrochemical cells comprising a LiF rich SEI layer (SEI layer that contained a relatively high amount of LiF) was investigated. FIGS. 4-8A show discharge capacity as a function of number of cycles comparing cells with pressure application (Examples 1-5) to cells without pressure application (Comparative Example 1-5) for various electrolyte systems. As shown in Table 1, LiF rich SEI layers were formed as a result of FEC degradation during cycling in both cells cycled with and without pressure application. As shown, the cells comprising LiF rich SEI layers formed under pressure application exhibited longer cycle life compared to the cells comprising LiF rich SEI layers formed without pressure application (as shown in FIGS. 4-8A). Additional inorganics materials (e.g., Li₂O) associated with degradation of the electrolyte (e.g., FEC) was also observed in the SEI layer in Examples 1-5.

As shown in FIGS. 4-8A, in the presence of a passivating agent (e.g., LiBOB), cells without pressure application (Comparative Examples 1-5) had approximately a cycle life of 20-50 cycles, while cells cycled under 12 kg/cm² of pressure had a cycle life of more than 250 cycles. As such, the cells comprising a LiF rich SEI layer formed without pressure application significantly underperformed the cells comprising a LiF rich SEI layer formed with pressure application. This result suggested that pressure application assisted with in-situ regulation of SEI growth during cycling and hence resulted in an increase in cell cycle life.

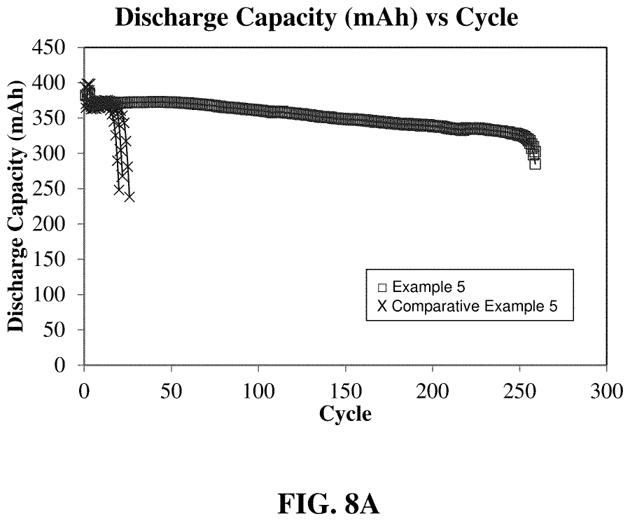

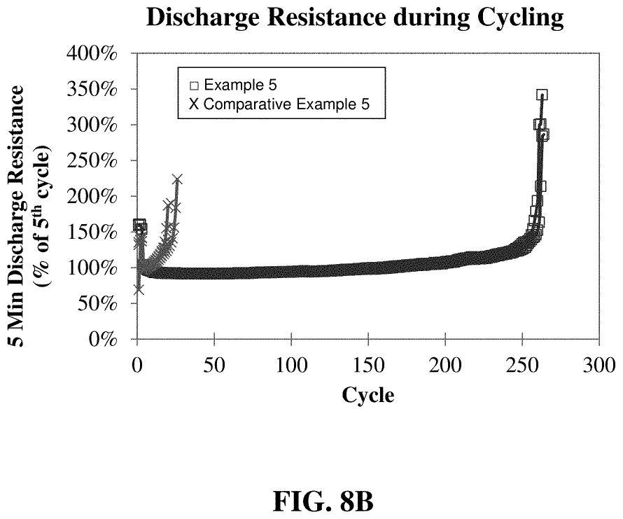

Formation of resistive SEI, which continued to grow during cycling, was one of the main causes leading to cell failure due to polarization buildup. To investigate the effect of pressure application on in-situ formation of resistive SEI during cycling, discharge resistance (i.e., 5 min discharge resistance) was calculated for Example 5 and compared to that of Comparative Example 5, according to Eq. (2). FIG. 8B shows 5-minute discharge resistance for cells with and without pressure application normalized to the 5-minute discharge resistance at the 5^{th} cycle of charge and discharge of the respective cells. As shown in FIG. 8B, cell with pressure application (Example 5) exhibited a slower increase in 5-minute discharge resistance compared to the cell without pressure application (Comparative Example 5). This result suggested that application of pressure during cycling suppressed the SEI resistance growth, therefore slowed down cell polarization build-up and significantly increased cycle performance from approximately 20 cycles (Comparative Example 5) to approximately 250 cycles (Example 5).

### Example 6 and Comparative Examples 6-10

These examples and comparative examples compare cycle life of cells comprising a LiF rich SEI layer to otherwise equivalent cells without the LiF rich SEI layer.

In the following examples and comparative examples, the cells were prepared, assembled, and cycled by the methods described previously. Specifically, the anode was vacuum deposited Li (HP VDLi) (thickness approximately 15-25 μm) positioned on a 200 nm Cu as current collector disposed on a polyethylene terephthalate (PET) substrate. The cathode used was NCM622 coated on 12-20 μm aluminum substrate with ACM loading of approximately 19.3-22 mg/cm²/side. The specific components and properties of the cells are tabulated in Table 2.

Comparative Example 6: The above cell was prepared with an electrolyte containing 1M of LiPF₆ in an electrolyte solvent mixture of 3:7 weight ratio of ethylene carbonate (EC):ethyl methyl carbonate (EMC) (BASF LP57).

Comparative Example 7: The above cell was prepared with an electrolyte containing 1M of LiPF₆ in a electrolyte solvent mixture of 3:7 weight ratio of ethylene carbonate (EC):diethyl carbonate (DEC) (BASF LP47).

Comparative Example 8: The above cell was prepared with an electrolyte containing 1M of LiPF₆ in an electrolyte solvent mixture of 1:1 weight ratio of ethylene carbonate (EC):ethyl methyl carbonate (EMC) (BASF LP50).

Comparative Example 9: The above cell was prepared with an electrolyte containing 1M of LiPF₆ in a electrolyte solvent mixture of 1:1 weight ratio of ethylene carbonate (EC):diethyl carbonate (DEC) (BASF LP40).

Comparative Example 10: The above cell was prepared with an electrolyte containing 1M of LiPF₆ in a electrolyte solvent mixture of 1:1 weight ratio of ethylene carbonate (EC):dimethyl carbonate (DMC) (BASF LP30).

Example 6: The above cell was prepared with an electrolyte containing 1M of LiPF₆ in a electrolyte solvent mixture of 1:4 weight ratio of fluoroethylene carbonate (FEC):dimethyl carbonate (DMC).

TABLE 2

| | Li | | | Pressure | Formation Voltage | Inorganic | | No. Of Cycles to |
|---|---|---|---|---|---|---|---|---|
| Example | Anode | Cathode | Electrolyte | Application | Cut-off (V) | rich SEI | Additive | 80% Capacity |
| Comparative | HP | NCM 622 | LP57 | Yes | 4.35 | None | None | 30 |
| Example 6 | VDLI | | (EC:EMC) | | | | | |
| Comparative | HP | NCM 622 | LP47 | Yes | 4.35 | None | None | 50 |
| Example 7 | VDLI | | (EC:DEC) | | | | | |
| Comparative | HP | NCM 622 | LP50 | Yes | 4.35 | None | None | 78 |
| Example 8 | VDLI | | (EC:EMC) | | | | | |
| Comparative | HP | NCM 622 | LP40 | Yes | 4.35 | None | None | 92 |
| Example 9 | VDLI | | (EC:DEC) | | | | | |
| Comparative | HP | NCM 622 | LP30 | Yes | 4.35 | None | None | 106 |
| Example 10 | VDLI | | (EC:DMC) | | | | | |
| Example 6 | HP | NCM 622 | FEC:DMC | Yes | 4.35 | LiF | None | 185 |
| | VDLI | | (1:4) | | | | | |

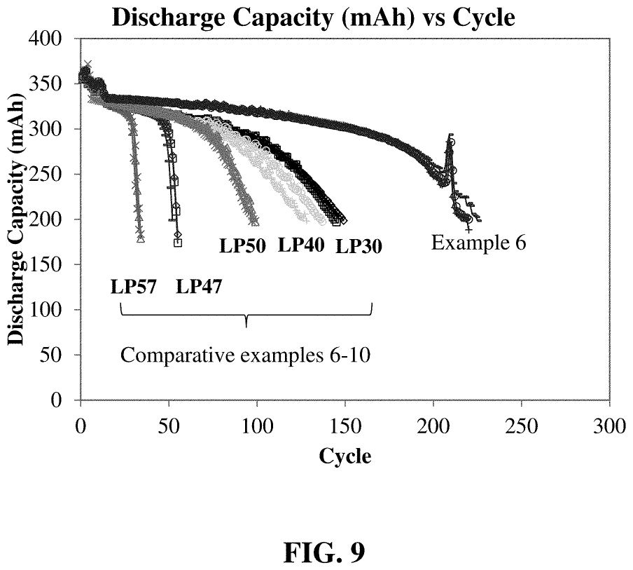

As shown in FIG. 9, cells comprising EC based electrolytes (Comparative Examples 6-10), even under pressure application during cycling, exhibited a life cycle of approximately 30 to 110 cycles (which was 80% of the rated capacity), which significantly underperformed the cells with FEC as co-solvent (Example 6). As shown, cell comprising FEC as a co-solvent in the electrolyte mixture exhibited a life cycle of approximately 190 cycles and exhibited a formation of LiF rich SEI layer (SEI layer that contained a relatively high amount of LiF) that was not formed in the cells in Comparative Examples 6-10 (Table 1). This result indicated that the formation of inorganic rich SET layer (e.g., LIF) was important for increased cycle life of Li metal cells. It should be noted LP30, LP40, LP50, LP47, and LP57 are standard electrolytes commonly used in Li-ion batteries.

### Example 7 and Comparative Examples 11-15

These examples and comparative examples compare the individual effects of pressure application, additives, cathode types, and fluorinated electrolyte solvent (e.g., FEC) on the life cycle of electrochemical cells.

In the following examples and comparative examples, the cells were prepared, assembled, and cycled by the methods described previously. Specifically, the anode was vacuum deposited Li (HP VDLi or LP VDLi) (thickness approximately 15-25 μm) positioned on a 200 nm Cu as current collector disposed on a polyethylene terephthalate (PET) substrate. The cathode used was NCM622 coated on 12-20 μm aluminum substrate with ACM loading of approximately 19.3-22 mg/cm²/side. The specific components and properties of the cells are tabulated in Table 3.

Comparative Example 11: The above cell was prepared with an electrolyte containing 1M of LiPF₆ in an electrolyte solvent mixture of 1:1 weight ratio of ethylene carbonate (EC):dimethyl carbonate (DMC) (BASF LP30). The cell was not cycled under pressure application.

Comparative Example 12: The above cell was prepared with an electrolyte containing 1M of LiPF₆ in a electrolyte solvent mixture of 1:4 weight ratio of fluoroethylene carbonate (FEC):dimethyl carbonate (DMC). The cell was not cycled under pressure application.

Comparative Example 13: The above cell was prepared with an electrolyte containing 1M of LiPF₆ in an electrolyte solvent mixture of 1:4 weight ratio of fluoroethylene carbonate (FEC):dimethyl carbonate (DMC). The electrolyte solvent mixture further contained 1 wt % of LiBOB. The cell was not cycled under pressure application.

Comparative Example 14: The above cell was prepared with an electrolyte containing 1M of LiPF₆ in a electrolyte solvent mixture of 1:1 weight ratio of ethylene carbonate (EC):dimethyl carbonate (DMC) (BASF LP30). The cell was cycled under pressure application.

Comparative Example 15: The above cell was prepared with an electrolyte containing 1M of LiPF₆ in a electrolyte solvent mixture of 1:10:10 weight ratio of fluoroethylene carbonate (FEC):ethylene carbonate (EC):dimethyl carbonate (DMC) (BASF LP30 with 4 wt % of FEC). The cell was cycled under pressure application.

Example 7: The above cell was prepared with an electrolyte containing 1M of LiPF₆ in a electrolyte solvent mixture of 1:4 weight ratio of fluoroethylene carbonate (FEC):dimethyl carbonate (DMC). The cell was cycled under pressure application.

TABLE 3

| | Li | | | Pressure | Formation Voltage | Inorganic | | No. of cycles to |
|---|---|---|---|---|---|---|---|---|
| Example | Anode | Cathode | Electrolyte | Application | Cut-off (V) | rich SEI | Additive | 80% capacity |
| Comparative | HP | NCM | EC:DMC | No | 4.35 | None | None | 10 |
| Example 11 | VDLI | 622 | (1:1) | | | | | |
| Comparative | HP | NCM | FEC:DMC | No | 4.35 | LiF | None | 3 |
| Example 12 | VDLI | 622 | (1:4) | | | | | |
| Comparative | HP | NCM | FEC:DMC | No | 4.35 | LiF | LiBOB | 3 |
| Example 13 | VDLI | 622 | (1:4) | | | | | |
| Comparative | LP | NCM | EC:DMC | Yes | 4.35 | None | None | 14 |
| Example 14 | VDLI | 622 | (1:1) | | | | | |
| Comparative | LP | NCM | FEC:EC:DMC | Yes | 4.35 | None | None | 24 |
| Example 15 | VDLI | 622 | (1:10:10) | | | | | |
| Example 7 | LP | NCM | FEC:DMC | Yes | 4.35 | LiF | None | 84 |
| | VDLI | 622 | (1:4) | | | | | |

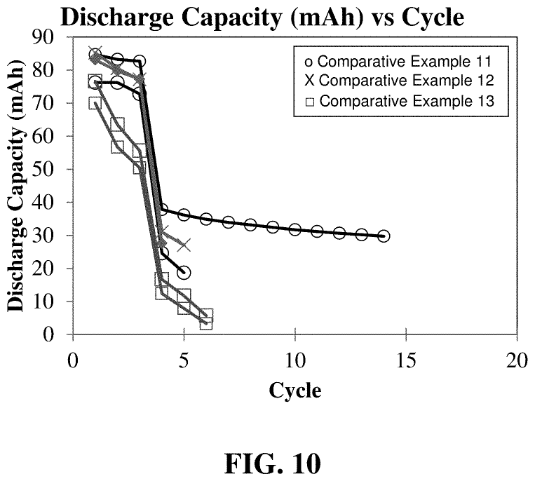

As shown in FIG. 10, cells cycled without pressure application (Comparative Examples 11-13) had limited cycle life, even in the presence of LiF rich SEI and in the presence of LiBOB additive. This poor cycle performance resulting from a lack of pressure application in Li metal cells was observed regardless of the cathode type in the cell, e.g., NCM622 in Comparative Examples 11-13 or NCM811 in Comparative Examples 1-5.

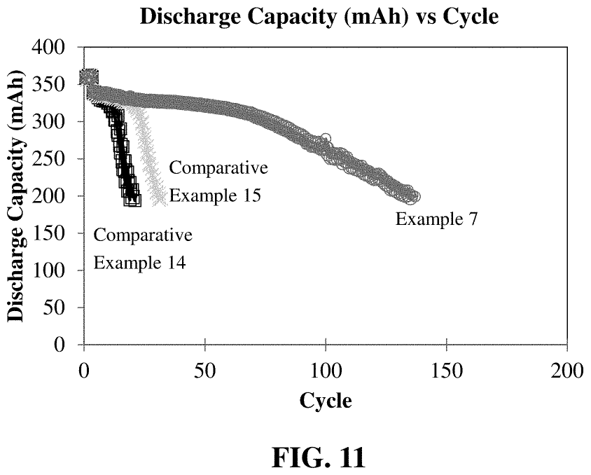

Furthermore, as shown in FIG. 11, although the cell with 4% FEC in the electrolyte (Comparative Example 15) exhibited slightly improved cycle performance compared to the cell without FEC in the electrolyte (Comparative Example 14), it still significantly underperformed the cell comprising a higher amount of FEC that resulted in the formation of a LiF rich SEI layer (Example 7), according to Table 3. Moreover, FIG. 11 demonstrates that for cell with cathode NCM622 and Li metal (LP VDLI), the combination of LiF rich SEI layer and pressure application slowed down the polarization built-up during cell cycling, and therefore resulted in enhanced cycle life of the electrochemical cell.

### Examples 8-16

These examples compare the cycle life of cells comprising a SEI layer rich in LiF and Li₂CO₃ to otherwise equivalent cells comprising a SEI layer rich only in LiF.

In the following examples and comparative examples, the cells were prepared, assembled, and cycled by the methods described previously. Specifically, the anode used was commercially available Li foil (2 mil) from Rockwood Lithium (thickness is 1 mil/cathode). The cathode used was NCM811 coated on 12-20 μm aluminum substrate with ACM loading of approximately 19.3-22 mg/cm²/side. The specific components and properties of the cells are tabulated in Table 4.

Example 8: The above cell was prepared with an electrolyte containing 1M of LiPF₆ in an electrolyte solvent mixture of 1:4 weight ratio of fluoroethylene carbonate (FEC):dimethyl carbonate (DMC). The cell had a formation voltage of 4.35V.

Example 9: The above cell was prepared with an electrolyte containing 1M of LiPF₆ in an electrolyte solvent mixture of 1:4 weight ratio of fluoroethylene carbonate (FEC):dimethyl carbonate (DMC). The cell had a formation voltage of 4.6V.

Example 10: The above cell was prepared with an electrolyte containing 1M of LiPF₆ in an electrolyte solvent mixture of 1:4 weight ratio of fluoroethylene carbonate (FEC):dimethyl carbonate (DMC). The cell had a formation voltage of 4.7V.

Example 11: The above cell was prepared with an electrolyte containing 1M of LiPF₆ in an electrolyte solvent mixture of 1:4 weight ratio of fluoroethylene carbonate (FEC):dimethyl carbonate (DMC). The cell had a formation voltage of 4.4V. The electrolyte solvent mixture further contained 1 wt % of LiBOB.

Example 12: The above cell was prepared with an electrolyte containing 1M of LiPF₆ in an electrolyte solvent mixture of 1:4 weight ratio of fluoroethylene carbonate (FEC):dimethyl carbonate (DMC). The cell had a formation voltage of 4.6V. The electrolyte solvent mixture further contained 1 wt % of LiBOB.

Example 13: The above cell was prepared with an electrolyte containing 1M of LiPF₆ in an electrolyte solvent mixture of 1:3 weight ratio of fluoroethylene carbonate (FEC):dimethyl carbonate (DMC). The cell had a formation voltage of 4.35V.

Example 14: The above cell was prepared with an electrolyte containing 1M of LiPF₆ in an electrolyte solvent mixture of 1:3 weight ratio of fluoroethylene carbonate (FEC):dimethyl carbonate (DMC). The cell had a formation voltage of 4.6V.

Example 15: The above cell was prepared with an electrolyte containing 1M of LiPF₆ in an electrolyte solvent mixture of 1:3 weight ratio of fluoroethylene carbonate (FEC):dimethyl carbonate (DMC). The cell had a formation voltage of 4.4V. The electrolyte solvent mixture further contained 1 wt % of LiBOB.

Example 16: The above cell was prepared with an electrolyte containing 1M of LiPF₆ in an electrolyte solvent mixture of 1:3 weight ratio of fluoroethylene carbonate (FEC):dimethyl carbonate (DMC). The cell had a formation voltage of 4.7V. The electrolyte solvent mixture further contained 1 wt % of LiBOB.

TABLE 4

| | Li | | | Pressure | Formation Voltage | Inorganic | | No. of cycles to |
|---|---|---|---|---|---|---|---|---|
| Example | Anode | Cathode | Electrolyte | Application | Cut-off (V) | rich SEI | Additive | 80% capacity |
| Example 8 | Li foil | NCM | FEC:DMC | Yes | 4.35 | LiF | None | 224 |
| | | 811 | (1:4) | | | | | |
| Example 9 | Li foil | NCM | FEC:DMC | Yes | 4.6 | LiF & | None | 276 |
| | | 811 | (1:4) | | | Li₂CO₃ | | |
| Example 10 | Li foil | NCM | FEC:DMC | Yes | 4.7 | LiF & | None | 356 |
| | | 811 | (1:4) | | | Li₂CO₃ | | |
| Example 11 | Li foil | NCM | FEC:DMC | Yes | 4.4 | LiF | LiBOB | 250 |
| | | 811 | (1:4) | | | | | |
| Example 12 | Li foil | NCM | FEC:DMC | Yes | 4.6 | LiF & | LiBOB | 345 |
| | | 811 | (1:4) | | | Li₂CO₃ | | |
| Example 13 | Li foil | NCM | FEC:DMC | Yes | 4.35 | LiF | None | 250 |
| | | 811 | (1:3) | | | | | |
| Example 14 | Li foil | NCM | FEC:DMC | Yes | 4.6 | LiF & | None | 307 |
| | | 811 | (1:3) | | | Li₂CO₃ | | |
| Example 15 | Li foil | NCM | FEC:DMC | Yes | 4.4 | LiF | LiBOB | 251 |
| | | 811 | (1:3) | | | | | |
| Example 16 | Li foil | NCM | FEC:DMC | Yes | 4.7 | LiF & | LiBOB | 308 |
| | | 811 | (1:3) | | | Li₂CO₃ | | |

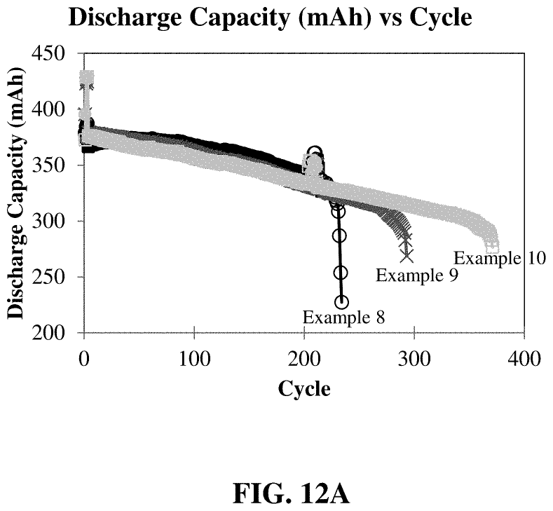

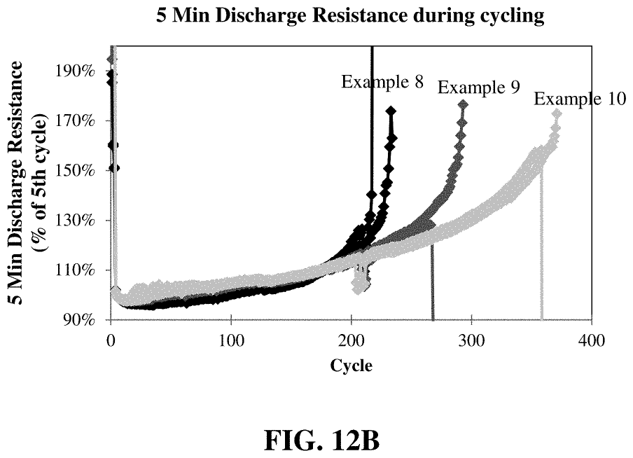

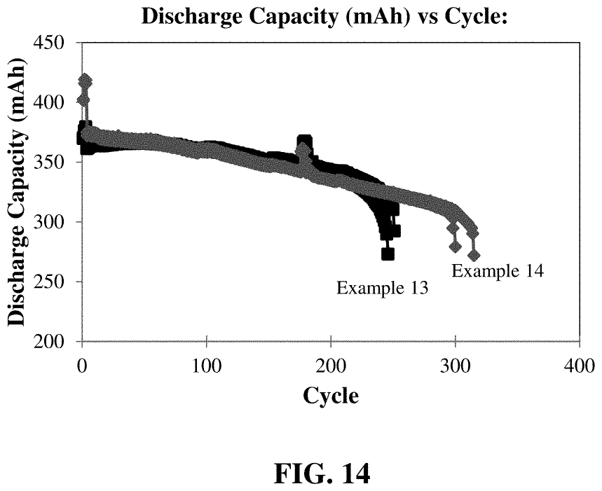

The effect of higher formation voltage was investigated in Examples 8 to 10. As shown in Table 4, a higher formation voltage resulted in the formation of inorganic SEI layer rich in Li₂CO₃ in addition to LiF (Examples 9-10). An SEI layer that is rich in LiF and Li₂CO₃ contained LiF and Li₂CO₃ in a relatively high amount. Furthermore, as shown in FIG. 12A, a higher formation voltage further resulted in an increase in the cell cycle performance to >350 cycles (Example 10). A similar increase in cell cycle performance at higher formation voltage was observed in cells with an electrolyte having a higher FEC content (Examples 13-14, as shown in FIG. 14).

The effect of high formation voltage on in-situ formation of resistive SEI during cycling was investigated and shown in FIG. 12B. Discharge resistance (i.e., 5 min discharge resistance) was calculated for Examples 8-10. FIG. 12B plots 5 min discharge resistance for the cells normalized to the 5 min discharge resistance at the 5^{th} cycle of the respective cells. As shown, cells with higher formation voltage (Example 10) exhibited a slower increase in 5 min discharge resistance compared to the cell with lower formation voltage (Example 8) upon cycling. This suggests that the application of high formation voltage influenced the formation of SEI layer in situ and suppressed the SEI resistance growth. As a result, as shown in FIG. 12A, the cycle performance of cells subjected to 4.7 V formation (Example 10) improved by more than 100 cycles in comparison to cells going through normal 4.35V formation (Example 8).

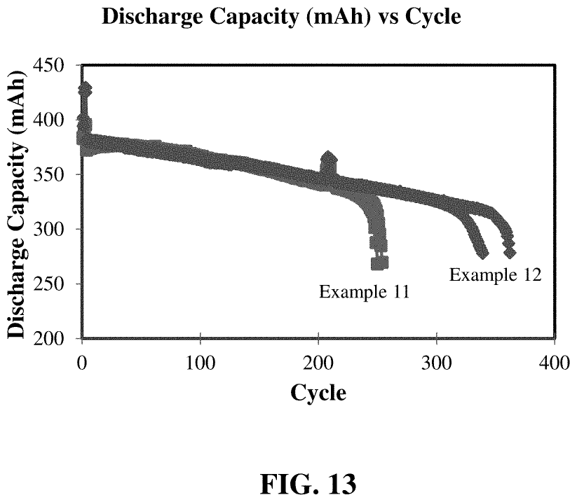

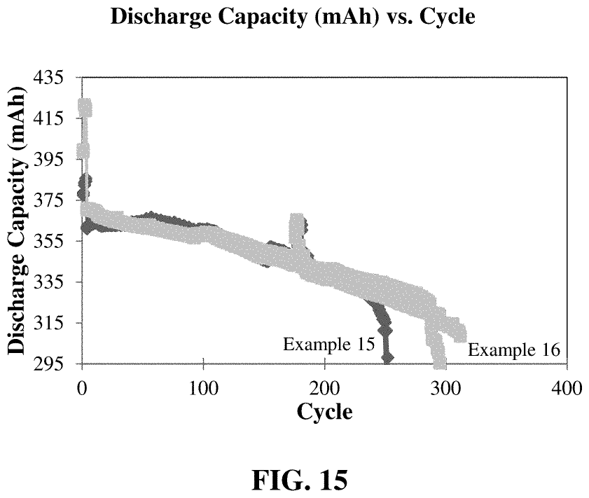

The effect of an additive (LiBOB) in addition to a higher formation voltage was investigated and shown in FIG. 13. As shown, the cycle performance at higher voltage (4.6V) with LiBOB further improved cycle life to ˜350 cycles (Example 12). A similar increase in cell cycle performance with LiBOB at higher formation voltage was observed in cells with an electrolyte having a higher FEC content (Examples 15-16, as shown in FIG. 15).

These examples demonstrated that in-situ Li passivation resulted from CO₂ generated at higher formation voltage (e.g. 4.4, 4.6 and 4.7 V) increased the inorganic content of SEI layer. Such high inorganic compound content in the SEI layer (LiF and Li₂CO₃) resulted from FEC and higher formation voltage along with in-situ control of SEI growth by pressure application significantly suppressed cell impedance built-up and improved cycle performance dramatically.

### Examples 17-20

These examples illustrate cycle life of cells comprising an acetate-based electrolyte cosolvent at various temperatures (e.g., 0 C, room temperature (RT)) and various formation voltages.

In the following examples and comparative examples, the cells were prepared, assembled, and cycled by the methods described previously. Specifically, the anode was vacuum deposited Li (HP VDLi) (thickness approximately 15-25 μm) positioned on a 200 nm Cu as current collector disposed on a polyethylene terephthalate (PET) substrate. The cathode used was NCM811 coated on 12-20 μm aluminum substrate with ACM loading of approximately 19.3-22 mg/cm²/side. The specific components and properties of the cells are tabulated in Table 5.

Example 17: The above cell was prepared with an electrolyte containing 1M of LiPF₆ in an electrolyte solvent mixture of 1:2:1 weight ratio of fluoroethylene carbonate (FEC):dimethyl carbonate (DMC):methyl acetate (MA). The cell had a formation voltage of 4.35V and was cycled at room temperature.

Example 18: The above cell was prepared with an electrolyte containing 1M of LiPF₆ in an electrolyte solvent mixture of 1:2:1 weight ratio of fluoroethylene carbonate (FEC):dimethyl carbonate (DMC):methyl acetate (MA). The cell had a formation voltage of 4.6V and was cycled at room temperature.

Example 19: The above cell was prepared with an electrolyte containing 1M of LiPF₆ in an electrolyte solvent mixture of 1:2:1 weight ratio of fluoroethylene carbonate (FEC):dimethyl carbonate (DMC):methyl acetate (MA). The cell had a formation voltage of 4.35V and was cycled at 0° C.

Example 20: The above cell was prepared with an electrolyte containing 1M of LiPF₆ in an electrolyte solvent mixture of 1:2:1 weight ratio of fluoroethylene carbonate (FEC):dimethyl carbonate (DMC):methyl acetate (MA). The cell had a formation voltage of 4.6V and was cycled at 0° C.

TABLE 5

| | Li | | | Pressure | Formation Voltage | Inorganic | | No. of cycles to |
|---|---|---|---|---|---|---|---|---|
| Example | Anode | Cathode | Electrolyte | Application | Cut-off (V) | rich SEI | Additive | 80% capacity |
| Example 17 | HP | NCM | FEC:DMC:MA | Yes | 4.35 | LiF | None | 192 |
| (RT) | VDLi | 811 | (1:2:1) | | | | | |
| Example 18 | HP | NCM | FEC:DMC:MA | Yes | 4.6 | LiF & | None | 219 |
| (RT) | VDLi | 811 | (1:2:1) | | | Li₂CO₃ | | |
| Example 19 | HP | NCM | FEC:DMC:MA | Yes | 4.35 | LiF | None | 88 |
| (0° C.) | VDLi | 811 | (1:2:1) | | | | | |
| Example 20 | HP | NCM | FEC:DMC:MA | Yes | 4.6 | LiF & | None | 144 |
| (0° C.) | VDLi | 811 | (1:2:1) | | | Li₂CO₃ | | |

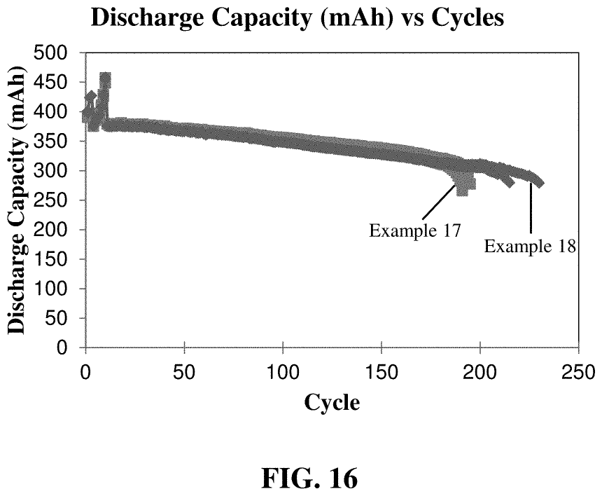

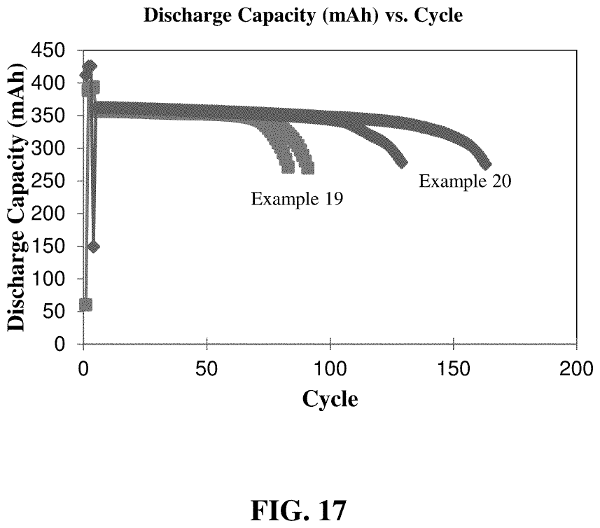

The effect of high formation voltage on cycle life was investigated in Examples 17-18 and shown in FIG. 16. As shown, a higher formation voltage at 4.6V (Example 18) resulted in an increase in cycle life for a cell cycled at room temperature containing LiF and Li₂CO₃ rich SEI layer and included methyl acetate (MA) as co-solvent. A similar positive effect (e.g., increase in cycle life) was demonstrated for higher formation voltage at 4.6V in for cells cycled at 0° C. containing LiF and Li₂CO₃ rich SEI layer and included MA as co-solvent (Examples 19-20 in FIG. 17).

### Examples 21-22 and Comparative Examples 16-17

These examples compare cycle life of cells comprising LiFSI and a LiF rich SEI layer cycled with an application of pressure versus without an application of pressure, all other factors being equal.

In the following examples and comparative examples, the cells were prepared, assembled, and cycled by the methods described previously. Specifically, the anode was vacuum deposited Li (HP VDLi) (thickness approximately 15-25 μm) positioned on a 200 nm Cu as current collector disposed on a polyethylene terephthalate (PET) substrate. The cathode used was NCM811 coated on 12-20 μm aluminum substrate with ACM loading of approximately 19.3-22 mg/cm²/side. The specific components and properties of the cells are tabulated in Table 6.

Comparative Example 16: The above cell was prepared with an electrolyte containing 0.8M of LiFSI in an electrolyte solvent mixture of 1:4 weight ratio of fluoroethylene carbonate (FEC):dimethyl carbonate (DMC). The cell was not cycled under pressure application. The electrolyte solvent mixture further contained 1 wt % of LiBOB.

Comparative Example 17: The above cell was prepared with an electrolyte containing 0.8M of LiFSI in an electrolyte solvent mixture of 1:3 weight ratio of fluoroethylene carbonate (FEC):ethyl methyl carbonate (EMC). The cell was not cycled under pressure application. The electrolyte solvent mixture further contained 1 wt % of LiBOB.

Example 21: The electrochemical cell was identical to the cell of Comparative Example 16, except that the cell in Example 21 was cycled under pressure application.

Example 22: The electrochemical cell was identical to the cell of Comparative Example 17, except that the cell in Example 22 was cycled under pressure application.

TABLE 6

| | Li | | | Pressure | Formation Voltage | Inorganic | | No. of cycles to |
|---|---|---|---|---|---|---|---|---|
| Example | Anode | Cathode | Electrolyte | Application | Cut-off (V) | rich SEI | Additive | 80% capacity |
| Example 21 | HP | NCM | FEC:DMC | Yes | 4.35 | LiF | LiBOB | 265 |
| | VDLi | 811 | (1:4) | | | | | |
| Example 22 | HP | NCM | FEC:EMC | Yes | 4.35 | LiF | LiBOB | 297 |
| | VDLi | 811 | (1:3) | | | | | |
| Comparative | HP | NCM | FEC:DMC | No | 4.35 | LiF | LiBOB | 13 |
| Example 16 | VDLi | 811 | (1:4) | | | | | |
| Comparative | HP | NCM | FEC:EMC | No | 4.35 | LiF | LiBOB | 17 |
| Example 17 | VDLi | 811 | (1:3) | | | | | |

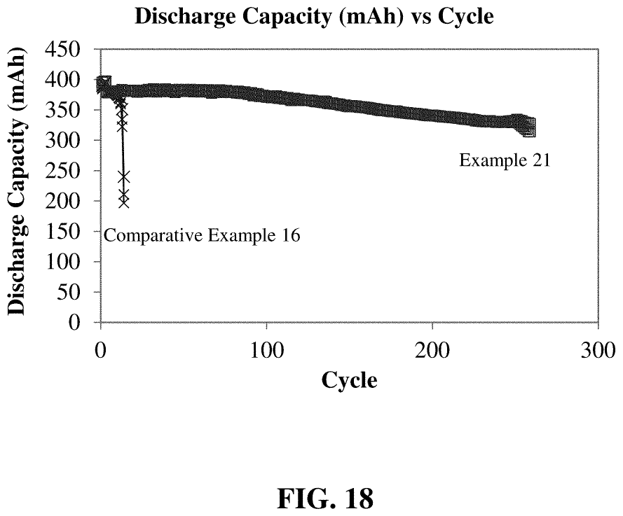

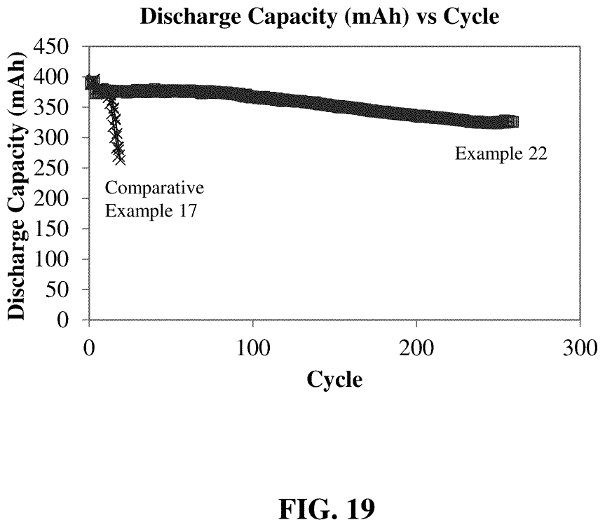

These examples demonstrated that in lithium bis (fluorosulfonyl)imide (LiFSI) based electrolytes, inorganic (e.g., LiF) rich SEI layer generated by FEC solvents, and pressure application led to enhanced cycle performance (e.g., Examples 21 and 22 as shown in FIGS. 18-19). The trend was in agreement with previous examples using LiPF6 as salt (Examples 1-20).

As shown in FIGS. 18-19, the SEI layers in each example and comparative showed formation of inorganic compounds (e.g., rich in LiF) due to the presence of FEC. However, the cells without pressure application in general had less than 20 cycles, which significantly underperformed the ones cycling under 12 kg/cm² pressure (Examples 21-22), which had more than 250 cycles. This result suggested that in-situ regulation of SEI growth via pressure was important in LiFSI based electrolytes.

Furthermore, a promising result was observed when these LiFSI were used in the cell. LiFSI, a salt that is known to cause Al corrosion, is typically used as a co-salt with LiPF₆, an Al corrosion inhibitor, to prevent Al corrosion. However, as shown by the result in Examples 21-22, Al corrosion was suppressed even when LiFSI was used as a single salt. Using LiFSI as a single salt in an electrochemical cell may be advantageous for high temperature applications due to its high thermal stability.

### Example 23

This example provides physical characterization of a SEI layer formed in an electrochemical cell.

The cells were prepared, assembled, and cycled by the methods described previously. Specifically, the anode used was commercially available Li foil (2 mil) from Rockwood Lithium (thickness is 1 mil/cathode). The porous separator used was 25 μm polyolefin (Celgard 2325) and the cathode used include NCM622 coated on 12-20 μm aluminum substrate with ACM loading of approximately 19.3-22 mg/cm²/side. The above components were assembled in a stacked three-layer structure of anode/separator/cathode/separator/anode. The cell was prepared with an electrolyte containing 1M of LiPF₆ in an electrolyte solvent mixture of 1:4 weight ratio of fluoroethylene carbonate (FEC):dimethyl carbonate (DMC). The electrolyte solvent mixture further contained 1 wt % of LiBOB.

The cell was cycled to 4.35 V charge at 30 mA, tapered down to 10 mA, and discharged at 120 mA during the first three formation cycles. Subsequent charge and discharge cycles were performed under the following condition: charged at 200 mA to 4.35V, tapered to 10 mA, followed by 800 mA is pulsed discharge and with 3 s rest between each pulse, until reaching a voltage of 3.2 V. The capacity cut-off was 60% of rated capacity. The cell was cycled under pressure application.

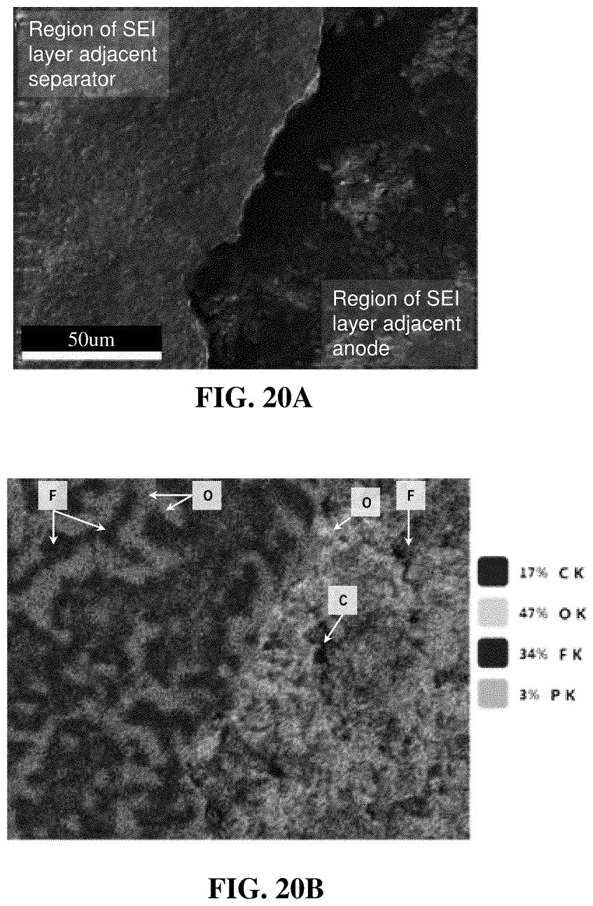

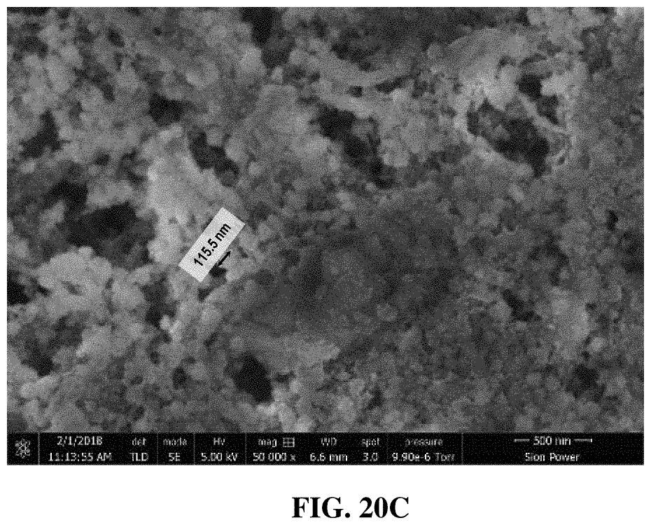

SEM/EDS characterization of the SEI was performed (FIGS. 20A-20B). Cycled anode was retrieved from end of life cell (after 123 cycles of charge and discharge), rinsed with dimethyl carbonate and analyzed by SEM/EDS. As shown, FIGS. 20A-20B show the presence of a SEI layer comprising two regions having different atomic content: a first region of SEI layer adjacent the separator and a second region of SEI layer adjacent the anode, with the first region of SEI layer adjacent the separator rich in fluorine atoms. Furthermore, FIG. 20C shows that the portion of SEI layer adjacent the separator contained nano sized particles.

### Example 24

This example provides chemical composition of a SEI layer formed in an electrochemical cell.

The cells were prepared, assembled, and cycled by the methods described previously. Specifically, the anode was vacuum deposited Li (HP VDLi) (thickness approximately 20 μm) positioned on a 200 nm Cu as current collector disposed on a polyethylene terephthalate (PET) substrate. The porous separator used was 9 μm polyethylene (Entek EP) and the cathode used was NCM721 coated on 12-20 μm aluminum substrate with ACM loading of approximately 19.3-22 mg/cm²/side. The above components were assembled in a stacked three-layer structure of anode/separator/cathode/separator/anode. The cell was prepared with an electrolyte containing 1M of LiPF₆ in an electrolyte solvent mixture of 1:4 weight ratio of fluoroethylene carbonate (FEC):dimethyl carbonate (DMC). The electrolyte solvent mixture further contained 1 wt % of LiBOB.

The cell was cycled to 4.4 V charge at 30 mA, tapered down to 10 mA, and discharged at 120 mA during the first three formation cycles. Subsequent charge and discharge cycles were performed under the following condition: charged at 75 mA to 4.4V, tapered to 10 mA, followed by 300 mA to 3.2V. The cell was cycled under pressure application.

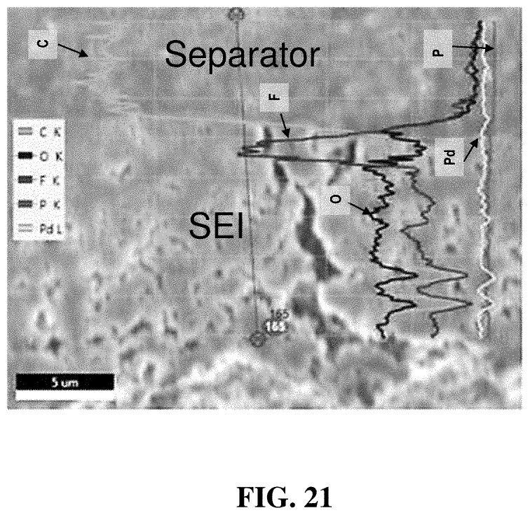

SEM/EDS was performed on a cross-section of the SEI layer/separator interface (FIG. 21). The sample was prepared by sputter coating of an ultra-thin conductive palladium layer on the cross-section. The composition of the SEI layer was shown by an EDS line scan of ion-milled cross-section (Line width 0.1 μm at 5 KV). As indicated by the EDS line scan, the region of SEI layer next to separator was rich in fluorine.

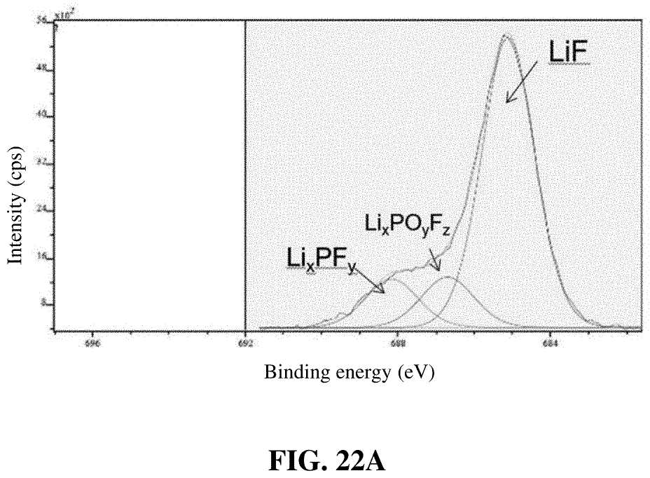

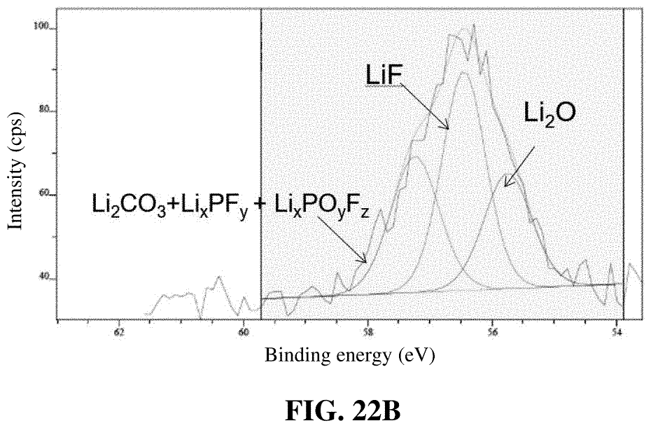

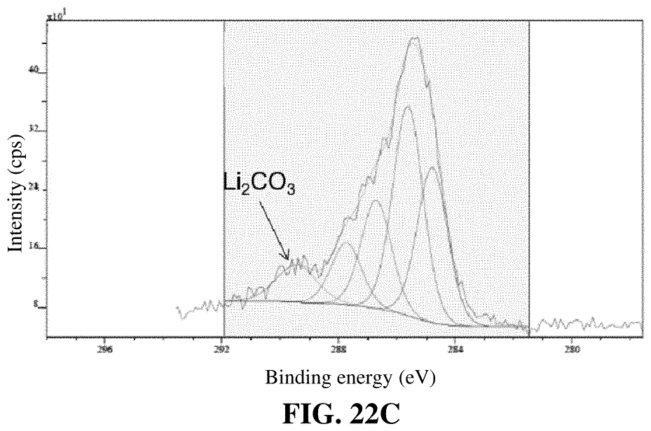

Chemical compositions of fluorine in the SEI layer are shown in FIG. 22A. As shown, at least 70% of total fluorine content in the SEI layer originated from LiF.

Chemical compositions of lithium in the SEI layer are shown in FIG. 22B. As shown, in addition to LiF, other inorganic materials (e.g., Li₂O) were also present in the SEI layer.

Chemical compositions of carbon in the SEI layer are shown in FIG. 22C. Other carbon-containing species such as alkyl carbonates (ROCO₂Li), and possibly alkoxide (ROLi) and polyethers (—CH₂O—) were also present in the SEI layer.

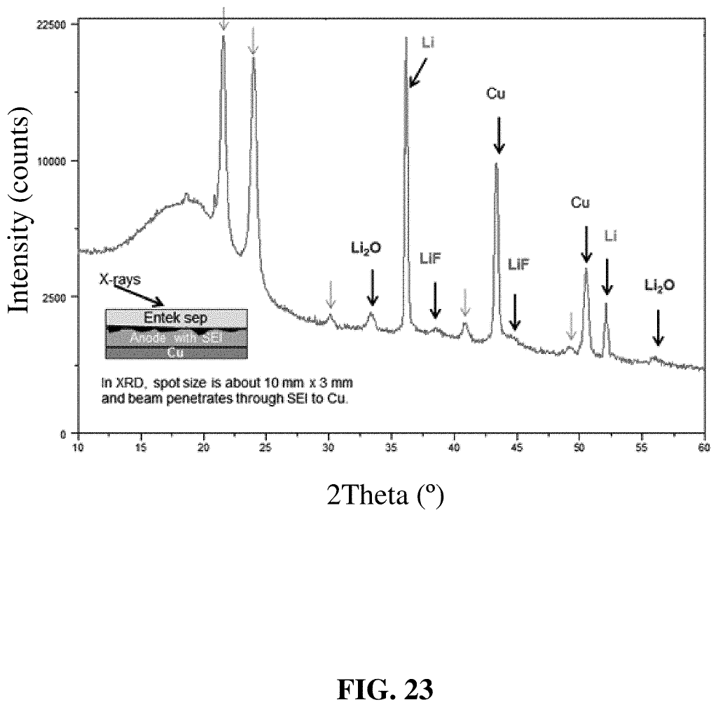

The crystallinity of the SEI layer was measured and shown in FIG. 23. As shown, XRD results indicated the presence of crystalline LiF and Li₂O in the SEI layer.

### Examples 25-26 and Comparative Examples 18-19

This example compares cycle life of cells comprising SEI layers formed with an application of pressure versus cells comprising SEI layers formed without an application of pressure, all other factors being equal.

In the following examples and comparative examples, the cells were prepared and assembled by methods described previously. Specifically, the anode was vacuum deposited Li (HP VDLi) (thickness approximately 15-25 μm). The cathode used was NCM811. The porous separator used was a 9 μm polyethylene (Entek EP) separator. The above components were assembled in a stacked three-layer structure of anode/separator/cathode/separator/anode. After sealing the cell components in a foil pouch, the electrolytes was added. The cell package was then vacuum sealed. These cells were soaked in the electrolyte for 24-72 hours unrestrained and then 12 kg/cm² pressure was applied. All the cells were cycled under such pressure except otherwise noted. Each cell had a cell capacity of 370 mAh. All cells were cycled at 4.35 V charge voltage cut-off at ˜C/12 (30 mA), tapered down to 10 mA, and discharged at C/3 (120 mA) rate to 3.2 V for the first three formation cycles unless otherwise noted. Subsequent charge and discharge cycles were performed under the following condition unless otherwise noted: 0.2 C (75 mA) charge to 4.35 V, taper down to 10 mA, and 0.8 C (300 mA) discharge to 3.2V.

Comparative Example 18: The above cell was prepared with an electrolyte containing 1M of LiPF₆ in an electrolyte solvent mixture of 1:1 weight ratio of ethylene carbonate (EC):dimethyl carbonate (DMC). The cell was not cycled under pressure application. The cell had a formation voltage of 4.35V.

Comparative Example 19: The above cell was prepared with an electrolyte containing 1M of LiPF₆ in an electrolyte solvent mixture of 1:1 weight ratio of fluoroethylene carbonate (FEC):dimethyl carbonate (DMC). The cell was not cycled under pressure application. The cell had a formation voltage of 4.35V.

Example 25: The electrochemical cell was identical to the cell of Comparative Example 18, except that the cell in Example 25 was cycled under 12 kg/cm² pressure application. The cell had a formation voltage of 4.35V.

Example 26: The electrochemical cell was identical to the cell of Comparative Example 19, except that the cell in Example 26 was cycled under 12 kg/cm² pressure application. The cell had a formation voltage of 4.35V.

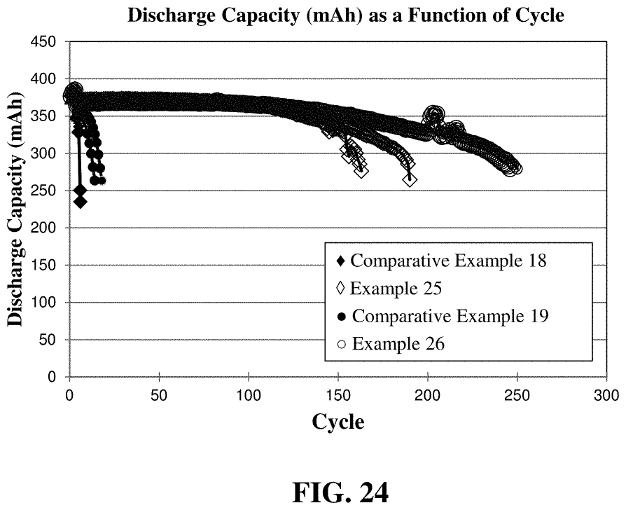

FIG. 24 illustrates cycle performance of electrochemical cells cycled with pressure application (Examples 25 and 26) versus cells cycled without pressure application (Comparative Examples 18 and 19). In each of the Examples and Comparative Examples shown in FIG. 24, two identical cells were tested (n=2). As shown in FIG. 24, cells cycled with pressure application (Examples 25 and 26) exhibited significantly longer cycle life than cells cycled without pressure application (Comparative Examples 18 and 19). Cells without a fluorinated solvent (Comparative Example 18) exhibited poor cycle life when cycled without pressure application. Moreover, even when subjected to an application of pressure during cycling, cells without a fluorinated solvent (Example 25) underperformed (i.e., had a shorter cycle life than) cells comprising a fluorinated solvent (Example 26), all other factors being equal. The longest cycle life was observed for cells comprising a fluorinated solvent and cycled under pressure application (Example 26).

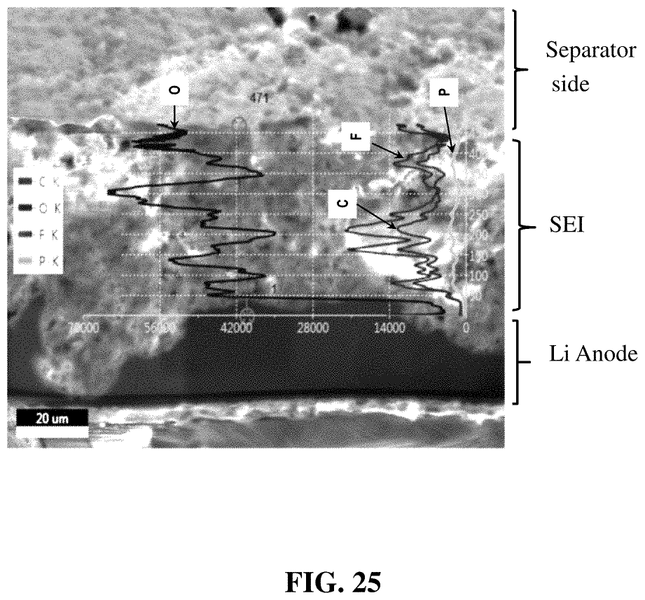

XRD, SEM, and EDS measurements were performed on a cross-section of the separator interface/SEI layer/anode interface. After the 25^{th} discharge, each sample was opened and sections including Li anode with SEI were retrieved. Ion-milled cross-sections were obtained for each example. The composition of the SEI layer was shown by an EDS line scan of ion-milled cross-section. FIGS. 25-28 are SEM/EDS line scans of electrochemical cells from Comparative Example 18, Example 25, Comparative Example 19, and Example 26, respectively.

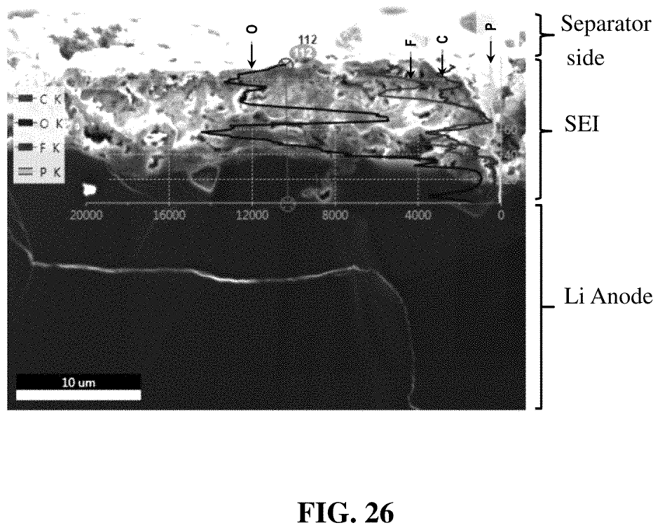

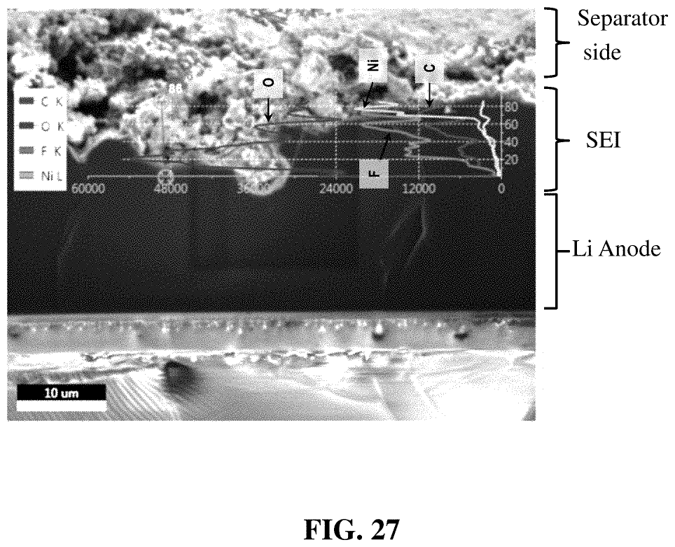

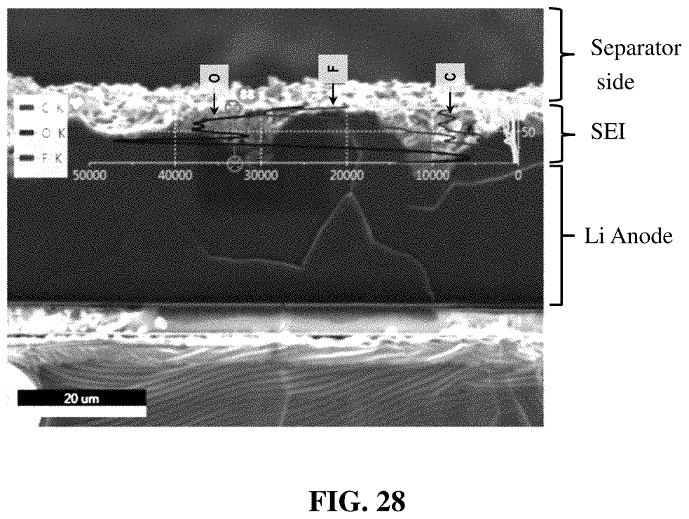

As indicated by the EDS line scan in FIG. 25, for an electrochemical cell comprising a non-fluorinated solvent and cycled without pressure application (Comparative Example 18), the SEI layer in the cell was rich in oxygen across the thickness of the SEI. Similarly, as indicated by the EDS line scan in FIG. 26, for an electrochemical cell comprising a non-fluorinated solvent and cycled with pressure application (Example 25), the SEI layer in the cell was still rich in oxygen across the thickness of the SEI. Moreover, as shown in FIG. 27, for an electrochemical cell comprising a fluorinated solvent and cycled without pressure application (Comparative Example 19), the SEI layer in the cell was rich in oxygen across the thickness of the SEI. However, as shown in FIG. 28, for an electrochemical cell comprising a fluorinated solvent and cycled with pressure application (Example 26), the region of SEI layer next to separator was rich in fluorine.

XDR was performed to measure the crystallinity and composition of various SEI layers in samples from Examples 25-26 and Comparative Examples 18-19. As shown in Table 7, nanocrystalline LiF was observed in samples comprising a FEC-containing electrolyte (Comparative Example 19 and Example 26), regardless of whether the samples had been cycled with or without pressure application. Moreover, the electrolyte in samples from Comparative Example 19 and Example 26 induced the formation of an inorganic-rich SEI comprising both nanocrystalline LiF and Li₂O. Furthermore, the cell cycled with pressure application (Example 26) exhibited a LiF/Li₂O ratio of 0.2, which is lower than the LiF/Li₂O ratio of 2.1 of the cell cycled without pressure application (Comparative Example 19). As shown in Table 7 and FIG. 24, cycle performance could be improved by controlling the presence of various SEI components, e.g., such as by an application of pressure to achieve a favorable LiF/Li₂O ratio. The presence of other inorganic species detected in the SEI layer is tabulated in Table 7.

TABLE 7

| | Main crystalline | Size of crystalline | Weight Ratio | |
|---|---|---|---|---|
| Samples | product(s) | product(s) (nm) | of LiF/Li₂O | Other Inorganics |
| Comparative | LiH | 43.2 | N/A | LiH₂PO₄ |
| Example 18 | | | | |
| Example 25 | Li₂O | 17.4 | N/A | F₄O₃P₂, LiH₂PO₄ |
| Comparative | LiF and Li₂O | 15.4 (LiF) | 2.1 | H₆Li₃O₁₂P₃ |
| Example 19 | | 11.0 (Li₂O) | | |
| Example 26 | LiF and Li₂O | 14.4 (LiF) | 0.2 | H₆Li₃O₁₂P₃ |
| | | 20.8 (Li₂O) | | |

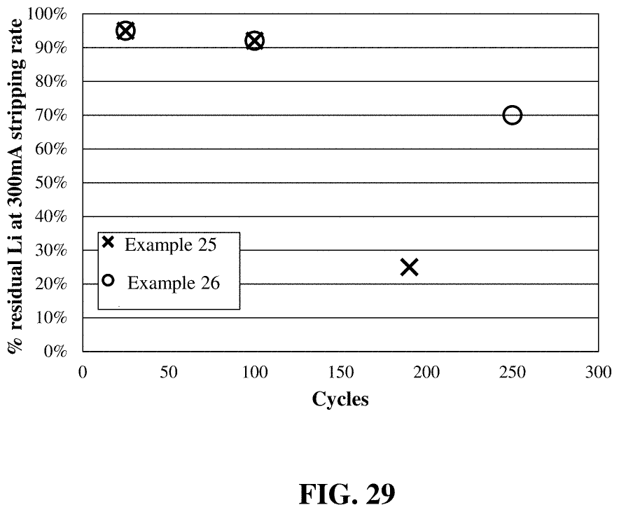

Growth of SEI resistivity (or polarization) and Li protection capability were measured for various cells in Examples 25-56 and Comparative Examples 18-19 utilizing the C-rate Li Stripping technique (e.g., as shown in FIG. 29). The Li Stripping technique was performed as follows: Cells at the 25^{th} discharge (Q25), the 100^{th} discharge (Q100), and 75% of cutoff capacity (EOL) were discharged at 300 mA, 50 mA, 25 mA, 10 mA, 5 mA, and 2 mA to 0V, respectively. The realized capacity was converted to lithium thickness based on its theoretical capacity (3862 mAh/g) and density (0.534 g/cc). As shown in Tables 8 and 9, SEI thickness and density were measured at Q25 and Q100 to assess the SEI layer's physical property and growth. In particular, cells without pressure application (Comparative Example 18 and 19) reached EOL before 25 cycles. The weight of the SEI layer was calculated based on the difference of cycled anode weight and the residual metallic Li of sister cell determined by Li stripping.

FIG. 29 shows percentage (%) of residual Li for a cell without a fluorinated solvent and cycled with pressure application (Example 25) to a cell comprising a fluorinated solvent and cycled with pressure application (Example 26). Percentage (%) of residual Li at C rate would equal to Li stripped at C rate/total Li stripped at all rates. The percentage (%) of Li stripped at C-rate could be used to indicate the resistivity of the SET. A higher percentage (%) Li stripped (corresponding to a lower percentage (%) of residual Li) would correlate with a less polarized cell and indicate a less resistive SET. As shown in FIG. 29, compared to the SEI resistivity of a cell without a fluorinated solvent (Example 25), the SEI resistivity of a cell comprising a fluorinated solvent (Example 26) increased at a slower rate over the course of the cycle life. The cell comprising a fluorine-rich SEI (Example 26) exhibited reduced polarization.

As shown in Tables 8 and 9, it was observed that the effect of pressure application on the resulting thickness and density of the SEI layer differed for a cell with a fluorinated electrolyte solvent (Example 26) and a cell without a fluorinated electrolyte solvent (Example 25). Under a pressure application, a significantly reduced increase in thickness and bulk density was observed for the cell without a fluorinated electrolyte solvent (Example 25), while no substantial change in thickness and bulk density was observed for the cell with a fluorinated electrolyte solvent (Example 26). This result indicated that the combination of a fluorinated solvent and pressure application during cycling could be employed to tune the SEI chemical composition and improve cycle performance, which is in line with the XRD results presented in Table 7. Furthermore, in comparison to a cell without a fluorinated electrolyte solvent (Example 25), the combination of a fluorinated electrolyte solvent and pressure application was observed to slow down the growth in SEI thickness and the decrease in SEI bulk density.

TABLE 8

| SEI | After 25^{th} discharge | After 100^{th} | |
|---|---|---|---|
| Thickness | (Q25) or at 75% cutoff | discharge | Q100-Q25 |
| (μm) | capacity (EOL) | (Q100) | (% change) |
| Comparative | 111.9 | N/A | N/A |
| Example 18 | | | |
| Example 25 | 14.1 | 32.4 | 131% |
| Comparative | 20.6 | N/A | N/A |
| Example 19 | | | |
| Example 26 | 16.5 | 28.1 | 70% |

TABLE 9

| | After 25^{th} discharge | After 100^{th} | |
|---|---|---|---|
| SEI Bulk | (Q25) or at 75% cutoff | discharge | Q100-Q25 |
| Density (g/cm³) | capacity (EOL) | (Q100) | (% change) |
| Comparative | 0.47 | N/A | N/A |
| Example 18 | | | |
| Example 25 | 2.52 | 1.11 | 56% |
| Comparative | 1.96 | N/A | N/A |
| Example 19 | | | |
| Example 26 | 2.00 | 1.17 | 42% |

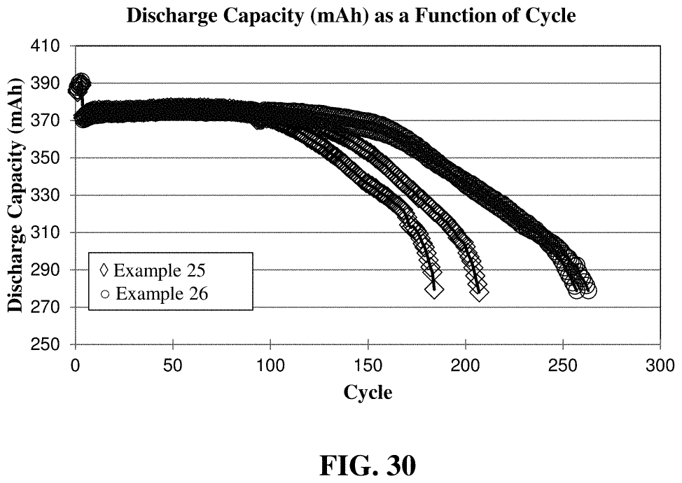

FIG. 30 shows discharge capacity as a function of cycle for cells with or without a fluorinated solvent and cycled with pressure application (Examples 25 and 26). Table 10 shows the effect of lithium stripping on the cells in FIG. 30. Two identical cells were test (n=2) for each of Examples 25 and 26. As indicated by the significantly greater amount of lithium stripped at C-rate shown in Table 10, a cell comprising a fluorine-rich SEI layer (Example 26) was more conductive compared to a cell that did not contain a fluorine-rich SEI layer (Example 25). Additionally, a cell comprising a fluorine-rich SEI layer (Example 26) had greater protective capability and thus less lithium loss per cycle and lithium loss per accumulated capacity.

TABLE 10

| Sample | Cell | Stripping Current (mA) | | | | | | μm of Li | | μm Li | μm Li |
|---|---|---|---|---|---|---|---|---|---|---|---|
| No. | No. | −300 | −50 | −25 | −10 | −5 | −2 | Stripped | Cycles | loss/cycle | loss/acc. Ah |
| Example | 1 | 0.1 | 0.4 | 2.8 | 1.7 | 0.5 | 2.3 | 7.9 | 207 | 0.097 | 0.271 |
| 25 | 2 | 0.2 | 10.4 | 1.1 | 3.4 | 1.4 | 2.3 | 18.8 | 184 | 0.050 | 0.140 |
| Example | 1 | 13.3 | 6.4 | 1.1 | 0.8 | 0.4 | 0.3 | 22.3 | 263 | 0.022 | 0.061 |
| 26 | 2 | 13 | 7 | 1.1 | 0.6 | 0.5 | 0.4 | 22.7 | 257 | 0.021 | 0.058 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. An electrochemical cell, comprising:
an anode comprising lithium metal, lithium alloy or combination thereof as an anode active material;
an electrolyte comprising a fluorinated organic solvent;
a cathode; and
a solid electrolyte interphase layer disposed between the anode and the electrolyte, wherein the solid electrolyte interphase layer comprises an inorganic material comprising LiF and Li₂CO₃, and wherein a first ratio of fluorine atoms to oxygen atoms adjacent the electrolyte is higher than a second ratio of fluorine atoms to oxygen atoms adjacent the anode in the solid electrolyte interphase layer.

2. An electrochemical cell, comprising:
an anode comprising lithium metal, lithium alloy or a combination thereof as an anode active material;
an electrolyte comprising a fluorinated organic solvent;
a cathode; and
a solid electrolyte interphase layer disposed between the anode and the electrolyte, wherein the solid electrolyte interphase layer comprises LiF and has:
(1) a hardness of greater than or equal to 0.001 GPa and less than or equal to 5 GPa; and/or
(2) a porosity of greater than equal to 1% and less than or equal to 90%; and
wherein the electrochemical cell exhibits a decrease in discharge capacity of less than or equal to 10% after 100 cycles of charge and discharge with respect to a discharge capacity at the 5^{th} charge-discharge cycle after formation.

3. (canceled)

4. A method of electrical energy storage and use, comprising:
in an electrochemical cell comprising:
an anode comprising lithium metal, lithium alloy or combination thereof as an anode active material, the anode having a surface;
a cathode; and
an electrolyte comprising a fluorinated organic solvent disposed between the anode and the cathode, performing the steps of:
applying an anisotropic force to the surface of the anode;
applying a formation voltage during at least one period of time during charge and/or discharge of the cell, wherein the formation voltage is greater than 4.35 V; and
forming a solid electrolyte interphase layer adjacent the surface of the anode, wherein the solid electrolyte interphase layer comprises an inorganic material comprising LiF and Li₂CO₃.

5-6. (canceled)

7. An electrochemical cell as in claim 1, wherein the LiF is present in an amount of at least 10 wt % in the solid electrolyte interphase layer.

8. An electrochemical cell as in claim 1, wherein the solid electrolyte interphase layer further comprises Li₂O in an amount of at least 10 wt % in the solid electrolyte interphase layer.

9-10. (canceled)

11. An electrochemical cell as in claim 1, further comprising a separator disposed between the anode and the cathode, wherein the separator comprises pores in which the electrolyte resides.

12. An electrochemical cell as in claim 1, wherein the solid electrolyte interphase layer comprises inorganic material particles having sizes of greater than or equal to 10 nm and less than or equal to 200 nm.

13. (canceled)

14. An electrochemical cell as in claim 1, wherein a formation of the solid electrolyte interphase layer is associated with a formation voltage applied during at least one period of time during charge and/or discharge of the cell and/or an application of anisotropic force applied to a surface of the anode during at least one period of time during charge and/or discharge of the cell.

15. (canceled)

16. An electrochemical cell as in claim 14, wherein the formation voltage is greater than 4.35 V and less than or equal to 4.9 V.

17-19. (canceled)

20. An electrochemical cell as in claim 1, wherein the Li₂CO₃ is formed by a reaction of CO₂ with lithium at the surface of the anode.

21. An electrochemical cell as in claim 1, wherein the solid electrolyte interphase layer comprises intermixed LiF and Li₂CO₃.

22. (canceled)

23. An electrochemical cell as in claim 1, wherein the Li₂CO₃ is present in an amount of at least 10 wt % in the solid electrolyte interphase layer.

24-25. (canceled)

26. An electrochemical cell as in claim 1, wherein the solid electrolyte interphase layer further comprises one or more of lithium alkoxides, lithium oxide, lithium salts, and decomposition products of electrolyte.

28. An electrochemical cell as in claim 1, wherein the electrolyte comprises at least one fluorinated organic solvent selected from cyclic and linear fluorinated carbonates, fluorinated ethers, and fluorinated esters.

29. An electrochemical cell as in claim 1, wherein the electrolyte comprises at least one fluorinated organic solvent selected from fluoroethylene carbonate and/or difluoroethylene carbonate.

30. (canceled)

31. An electrochemical cell as in claim 1, wherein the electrolyte comprises at least one non-fluorinated organic solvent, and wherein the at least one non-fluorinated organic solvent comprises an ester-based solvent and/or a cyclic or linear carbonate.

32. (canceled)

33. An electrochemical cell as in claim 1, wherein the fluorinated organic solvent is present in amount of greater than or equal to 14 wt % and less than or equal to 88 wt % of a total electrolyte weight.

34. An electrochemical cell as in claim 1, wherein the electrolyte further comprises at least one passivating agent, and wherein the passivating agent comprises an oxalate salt.

35-37. (canceled)

38. An electrochemical cell as in claim 1, wherein the cathode is a lithium-intercalation cathode.

39. (canceled)

40. An electrochemical cell as in claim 1, wherein the first ratio of fluorine atoms to oxygen atoms adjacent the electrolyte is higher than a second ratio of fluorine atoms to oxygen atoms adjacent the anode in the solid electrolyte interphase layer based on an average ratio and/or a maximum ratio of fluorine atoms to oxygen atoms across a thickness of the solid electrolyte interphase layer.

41-43. (canceled)

44. An electrochemical cell as in claim 1, wherein the solid electrolyte interphase layer comprises LiF and Li₂O in a weight ratio of greater than or equal to 1:5 and less than or equal to 2:1.

45. An electrochemical cell as in claim 1, wherein the solid electrolyte interphase layer has a thickness of less than or equal to 75 um.

46-47. (canceled)
